(19) United States
(12) Patent Application Publication
(10) Pub. No.: US 2016/0218390 A1
(43) Pub. Date: Jul. 28, 2016

(54) NONAQUEOUS SECONDARY BATTERY

(71) Applicant: THE UNIVERSITY OF TOKYO, Tokyo (JP)

(72) Inventors: Atsuo YAMADA, Tokyo (JP); Yuki YAMADA, Tokyo (JP); Tomoyuki KAWAI, Kariya-shi (JP); Yoshihiro NAKAGAKI, Kariya-shi (JP); Kohei MASE, Kariya-shi (JP); Yuki HASEGAWA, Kariya-shi (JP); Nobuhiro GODA, Kariya-shi (JP)

(73) Assignee: THE UNIVERSITY OF TOKYO, Tokyo (JP)

(21) Appl. No.: 15/024,380

(22) PCT Filed: Sep. 25, 2014
(86) PCT No.: PCT/JP2014/004910

§ 371 Date: Mar. 24, 2016

(30) Foreign Application Priority Data
Sep. 25, 2013 (JP) 2013-198287
Sep. 25, 2013 (JP) 2013-198288
Sep. 25, 2013 (JP) 2013-198289
Sep. 25, 2013 (JP) 2013-198290
Dec. 10, 2013 (JP) 2013-255092
Mar. 27, 2014 (JP) 2014-065808
Sep. 12, 2014 (JP) 2014-186369
Sep. 12, 2014 (JP) 2014-186370
Sep. 12, 2014 (JP) 2014-186371
Sep. 12, 2014 (JP) 2014-186372
Sep. 24, 2014 (JP) 2014-194342
Sep. 24, 2014 (JP) 2014-194343
Sep. 24, 2014 (JP) 2014-194344
Sep. 24, 2014 (JP) 2014-194345

(51) Int. Cl. H01M 10/0525; H01M 4/58; H01M 10/0569; H01M 4/485; H01M 10/0568

(52) U.S. Cl. CPC H01M 10/0525; H01M 4/485; H01M 10/0568; H01M 10/0569; H01M 4/5825; H01M 2004/028

(57) ABSTRACT

A positive electrode of a nonaqueous secondary battery has a positive electrode active material including at least one selected from lithium metal complex oxides having a layered rock salt structure, lithium metal complex oxides having a spinel structure, and polyanion based materials. The electrolytic solution contains a metal salt whose cation is an alkali metal, an alkaline earth metal, or aluminum, and an organic solvent having a heteroelement. Regarding an intensity of a peak derived from the organic solvent in a vibrational spectroscopy spectrum of the electrolytic solution, when an intensity of an original peak of the organic solvent is represented as Io and an intensity of a peak resulting from shifting of the original peak is represented as Is; Is>Io is satisfied. The nonaqueous secondary battery may have a usage maximum potential of the positive electrode of not lower than 4.5 V when Li/Li⁺ is used for reference potential.

### TECHNICAL FIELD

The present invention relates to a nonaqueous secondary battery such as a lithium ion secondary battery.

### BACKGROUND ART

Nonaqueous secondary batteries such as lithium ion secondary batteries have a small size and high energy density, and are widely used as power supplies for portable electronic devices. As positive electrode active materials of lithium ion secondary batteries, lithium metal complex oxides having a layered rock salt structure such as LiCoO₂, LiNiO₂, and Li(NiₓCo_{y}Mn_{z})O₂ (x+y+z=1) are mainly used (Patent Literature 1). An electrolytic solution is produced by dissolving a lithium salt in an organic solvent containing ethylene carbonate.

Generally, in a charged state, a lithium metal complex oxide described above becomes structurally unstable when compared to that in a discharged state. Applying energy such as heat is thought to break down a crystal structure, release oxygen (O), and cause combustion and generation of heat when the released oxygen reacts with the electrolytic solution.

Among the lithium metal complex oxides having a layered rock salt structure, LiNiO₂ and Li (NiₓCo_{y}Mn_{z})O₂ having a high Ni ratio are particularly advantageous in terms of having lower material cost and larger capacity of extractable current when compared to LiCoO₂ and the like. On the other hand, increase in Ni amount has been reported to lead to an increase in reactivity with an electrolytic solution in a charged state, and a decrease in the temperature at which generation of heat starts due to a reaction between a positive electrode and the electrolytic solution when overheating occurs (Non-Patent Literature 1). When these lithium metal complex oxides are used together with a volatile electrolytic solution, an overheated electrolytic solution may be released outside the system instantaneously when a battery sustains damage.

For example, although a mixed organic solvent that contains ethylene carbonate and that is used widely in electrolytic solutions can provide an electrolytic solution having low viscosity, low melting point, and a high ionic conductivity; the mixed organic solvent is volatile. When any opening is formed on the battery or when the battery sustains damage by any chance, the electrolytic solution may be instantaneously released outside a battery system in the form of a gas.

Using a low volatility liquid such as an ionic liquid as the electrolytic solution can conceivably suppress volatilization of the electrolytic solution when the battery sustains damage. However, an ionic liquid has a high viscosity and a lower ionic conductivity when compared to an ordinary electrolytic solution. As a result, input-output characteristics of the battery deteriorate.

The inventors of the present application have conducted thorough investigation into electrolytic solutions, and developed a new low volatile electrolytic solution. In addition, the inventors of the present application have discovered that a nonaqueous secondary battery having excellent input-output characteristics can be obtained when the new electrolytic solution is combined with a positive electrode whose active material is a lithium metal complex oxide.

As a positive electrode active material of a lithium ion secondary battery, a lithium metal complex oxide mainly having a spinel structure such as LiMn₂O₄ is sometimes used. An electrolytic solution is obtained by dissolving a lithium salt in a solvent containing ethylene carbonate (Patent Literature 1 and 2).

In such a secondary battery, charging/discharging reactions have to be performed reversibly in both the negative electrode and the positive electrode.

Furthermore, as a positive electrode active material of a lithium ion secondary battery, a polyanion based material having an olivine structure such as LiFePO₄ is sometimes used. A battery in which an olivine based active material is used has a characteristic of being superior in safety and cyclability and being low cost. An electrolytic solution is obtained by dissolving a metal salt in a solvent containing ethylene carbonate (Patent Literature 3 and 4).

In such a secondary battery, charging/discharging reactions have to be performed reversibly in both the negative electrode and the positive electrode. Furthermore, having high rate capacity characteristic is desired.

Further, as a positive electrode active material of a lithium ion secondary battery, a lithium metal complex oxide mainly having a layered rock salt structure such as LiCoO₂, and Li(NiₓCo_{y}Mn_{z})O₂(x+y+z=1), a spinel type oxide such as LiMn₂O₄, and a polyanion compound such as LiFePO₄ and Li₂MnSiO₄ are sometimes used. An electrolytic solution is obtained by dissolving a lithium salt in a solvent containing ethylene carbonate (Patent Literature 1 and 2).

Generally, a lithium ion secondary battery conducts charging/discharging reactions reversibly. For this purpose, an electrolytic solution is required to be highly reduction resistant and oxidation resistant. Particularly when a high capacity is to be obtained in a nonaqueous secondary battery or when an active material that causes reversible charging/discharging reactions at the positive electrode at around 5 V (vs Li⁺/Li) is used; a usable upper limit potential of a battery main body has to be increased. In this case, an electrolytic solution is desired to have an oxidative degradation potential that is higher than a usage maximum potential of the positive electrode.

Accordingly, Patent Literature 5 proposes adding, to an electrolytic solution, a compound having a high reaction potential.

Asa result of thorough investigation, the present inventors developed, through a technique different from prior art, an electrolytic solution that is highly oxidation resistant.

### CITATION LIST

### Patent Literature

Patent Literature 1: WO 2011111364 (A1)

Patent Literature 2: JP2013082581 (A)

Patent Literature 3: JP2013065575 (A)

Patent Literature 4: JP2009123474 (A)

Patent Literature 5: JP2008501220 (A)

### Non-Patent Literature

Non-Patent Literature 1: Netsu Sokutei 30(1)3-8

### SUMMARY OF INVENTION

### Technical Problem

The present invention has been made in view of the above described circumstances, and a first object of the present invention is to provide a nonaqueous secondary battery having excellent input-output characteristics.

A second object of the present invention is to provide a nonaqueous secondary battery that achieves both improvement in safety and an ability to perform reversible charging/discharging reactions.

A third object of the present invention is to provide a nonaqueous secondary battery having a combination of a positive electrode and a new electrolytic solution enabling reversible charging/discharging reactions and improvement in rate capacity characteristics.

A fourth object of the present invention is to provide a nonaqueous secondary battery that can be used at a high potential.

### Solution to Problem

A nonaqueous secondary battery according to a first mode of the present invention is a nonaqueous secondary battery including a positive electrode, a negative electrode, and an electrolytic solution, wherein:

the positive electrode has a positive electrode active material including a lithium metal complex oxide with a layered rock salt structure;

the electrolytic solution contains a metal salt whose cation is an alkali metal, an alkaline earth metal, or aluminum, and an organic solvent having a heteroelement; and

regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is.

The first mode of the present invention is obtained because, as a result of thorough investigation, the present inventors have developed a new electrolytic solution that can perform reversible charging/discharging reactions and has excellent input-output characteristics in a nonaqueous secondary battery that includes a positive electrode including a lithium metal complex oxide with a layered rock salt structure.

A nonaqueous secondary battery according to a second mode of the present invention is a nonaqueous secondary battery including a positive electrode, a negative electrode, and an electrolytic solution, wherein: the positive electrode has a positive electrode active material including a lithium metal complex oxide with a spinel structure; the electrolytic solution contains a metal salt whose cation is an alkali metal, an alkaline earth metal, or aluminum, and an organic solvent having a heteroelement; and regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is.

The second mode of the present invention is obtained because, as a result of thorough investigation, the present inventors have developed a new electrolytic solution that can perform reversible charging/discharging reactions in a nonaqueous secondary battery that includes a positive electrode including a lithium metal complex oxide with a spinel structure.

A nonaqueous secondary battery according to a third mode of the present invention is a nonaqueous secondary battery including a positive electrode, a negative electrode, and an electrolytic solution, wherein: the positive electrode has a positive electrode active material including a polyanion based material; the electrolytic solution contains a metal salt whose cation is an alkali metal, an alkaline earth metal, or aluminum, and an organic solvent having a heteroelement; and regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is.

The third mode of the present invention is obtained because, as a result of thorough investigation, the present inventors have developed a combination of a positive electrode and a new electrolytic solution enabling reversible charging/discharging reactions and improvement in rate capacity characteristics in a nonaqueous secondary battery including a positive electrode with a polyanion based material.

A nonaqueous secondary battery according to a fourth mode of the present invention is a nonaqueous secondary battery including a positive electrode having a positive electrode active material, a negative electrode having a negative electrode active material, and an electrolytic solution, wherein:

the electrolytic solution contains a metal salt whose cation is an alkali metal, an alkaline earth metal, or aluminum, and an organic solvent having a heteroelement;

regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is; and

a usage maximum potential of the positive electrode in the nonaqueous secondary battery is not lower than 4.5 V when Li/Li⁺ is used for reference potential.

### Advantageous Effects of Invention

In the first mode of the present invention, since the electrolytic solution described above is used, a nonaqueous secondary battery having excellent input-output characteristics is provided.

In the second mode of the present invention, since the new electrolytic solution described above is used, a nonaqueous secondary battery that achieves both improvement in safety and an ability to perform reversible charging/discharging reactions is provided.

In the third mode of the present invention, since the new electrolytic solution described above is used, a nonaqueous secondary battery having a combination of a positive electrode and the new electrolytic solution enabling reversible charging/discharging reactions and improvement in rate capacity characteristics is provided.

In the nonaqueous secondary battery according to the fourth mode of the present invention, since the electrolytic solution described above is contained, usage at a high potential becomes possible, and an average voltage and a battery capacity increase.

### BRIEF DESCRIPTION OF DRAWINGS

FIG. 1 is an IR spectrum of electrolytic solution E3;

FIG. 2 is an IR spectrum of electrolytic solution E4;

FIG. 3 is an IR spectrum of electrolytic solution E7;

FIG. 4 is an IR spectrum of electrolytic solution E8;

FIG. 5 is an IR spectrum of electrolytic solution E10;

FIG. 6 is an IR spectrum of electrolytic solution C2;

FIG. 7 is an IR spectrum of electrolytic solution C4;

FIG. 8 is an IR spectrum of acetonitrile;

FIG. 9 is an IR spectrum of (CF₃SO₂)₂NLi;

FIG. 10 is an IR spectrum of (FSO₂)₂NLi (2100 to 2400 cm⁻¹);

FIG. 11 is an IR spectrum of electrolytic solution E11;

FIG. 12 is an IR spectrum of electrolytic solution E12;

FIG. 13 is an IR spectrum of electrolytic solution E13;

FIG. 14 is an IR spectrum of electrolytic solution E14;

FIG. 15 is an IR spectrum of electrolytic solution E15;

FIG. 16 is an IR spectrum of electrolytic solution C6;

FIG. 17 is an IR spectrum of dimethyl carbonate;

FIG. 18 is an IR spectrum of electrolytic solution E16;

FIG. 19 is an IR spectrum of electrolytic solution E17;

FIG. 20 is an IR spectrum of electrolytic solution E18;

FIG. 21 is an IR spectrum of electrolytic solution C7;

FIG. 22 is an IR spectrum of ethyl methyl carbonate;

FIG. 23 is an IR spectrum of electrolytic solution E19;

FIG. 24 is an IR spectrum of electrolytic solution E20;

FIG. 25 is an IR spectrum of electrolytic solution E21;

FIG. 26 is an IR spectrum of electrolytic solution C8;

FIG. 27 is an IR spectrum of diethyl carbonate;

FIG. 28 is an IR spectrum of (FSO₂)₂NLi (1900 to 1600 cm⁻¹);

FIG. 29 is a Raman spectrum of electrolytic solution E8;

FIG. 30 is a Raman spectrum of electrolytic solution E9;

FIG. 31 is a Raman spectrum of electrolytic solution C4;

FIG. 32 is a Raman spectrum of electrolytic solution E11;

FIG. 33 is a Raman spectrum of electrolytic solution E13;

FIG. 34 is a Raman spectrum of electrolytic solution E15;

FIG. 35 is a Raman spectrum of electrolytic solution C6;

FIG. 36 shows DSC curves of Example A-1 and Comparative Example A-1;

FIG. 37 shows DSC curves of Example A-2 and Comparative Example A-1;

FIG. 38 is a graph showing the relationship between the square root of cycle number and discharge capacity retention rate when a cycle test was performed on lithium ion secondary batteries of Example A-5 and Comparative Example A-3;

FIG. 39 is a planar plot of complex impedance of a battery in Evaluation Example A-15;

FIG. 40 shows the results of XPS analysis of carbon element in negative-electrode S,O-containing coatings of batteries A-8, A-9, and A-C3 in Evaluation Example A-16;

FIG. 41 shows the results of XPS analysis of fluorine element in the negative-electrode S,O-containing coatings of batteries A-8, A-9, and A-C3 in Evaluation Example A-16;

FIG. 42 shows the results of XPS analysis of nitrogen element in the negative-electrode S,O-containing coatings of batteries A-8, A-9, and A-C3 in Evaluation Example A-16;

FIG. 43 shows the results of XPS analysis of oxygen element in the negative-electrode S,O-containing coatings of batteries A-8, A-9, and A-C3 in Evaluation Example A-16;

FIG. 44 shows the results of XPS analysis of sulfur element in the negative-electrode S,O-containing coatings of batteries A-8, A-9, and A-C3 in Evaluation Example A-16;

FIG. 45 shows the result of XPS analysis on the negative-electrode S,O-containing coating of battery A-8 in Evaluation Example A-16;

FIG. 46 shows the result of XPS analysis on the negative-electrode S,O-containing coating of battery A-9 in Evaluation Example A-19;

FIG. 47 is a BF-STEM image of the negative-electrode S,O-containing coating of battery A-8 in Evaluation Example A-19;

FIG. 48 shows the result of STEM analysis of C in the negative-electrode S,O-containing coating of battery A-8 in Evaluation Example A-19;

FIG. 49 shows the result of STEM analysis of O in the negative-electrode S,O-containing coating of battery A-8 in Evaluation Example A-19;

FIG. 50 shows the result of STEM analysis of S in the negative-electrode S,O-containing coating of battery A-8 in Evaluation Example A-19;

FIG. 51 shows the result of XPS analysis of O in a positive-electrode S,O-containing coating of battery A-8 in Evaluation Example A-19;

FIG. 52 shows the result of XPS analysis of S in a positive-electrode S,O-containing coating of battery A-8 in Evaluation Example A-19;

FIG. 53 shows the result of XPS analysis of S in a positive-electrode S,O-containing coating of battery A-11 in Evaluation Example A-19;

FIG. 54 shows the result of XPS analysis of 0 in the positive-electrode S,O-containing coating of battery A-11 in Evaluation Example A-19;

FIG. 55 shows the results of XPS analysis of S in positive-electrode S,O-containing coatings of batteries A-11, A-12, and A-C4 in Evaluation Example A-19;

FIG. 56 shows the results of XPS analysis of S in positive-electrode S,O-containing coatings of batteries A-13, A-14, and A-C5 in Evaluation Example A-19;

FIG. 57 shows the results of XPS analysis of O in the positive-electrode S,O-containing coatings of batteries A-11, A-12, and A-C4 in Evaluation Example A-19;

FIG. 58 shows the results of analysis of O in the positive-electrode S,O-containing coatings of batteries A-13, A-14, and A-C5 in Evaluation Example A-19;

FIG. 59 shows the results of analysis of Sin negative-electrode S,O-containing coatings of batteries A-11, A-12, and A-C4 in Evaluation Example A-19;

FIG. 60 shows the results of analysis of Sin negative-electrode S,O-containing coatings of batteries A-13, A-14, and A-C5 in Evaluation Example A-19;

FIG. 61 shows the results of analysis of O in the negative-electrode S,O-containing coatings of batteries A-11, A-12, and A-C4 in Evaluation Example A-19;

FIG. 62 shows the results of analysis of O in the negative-electrode S,O-containing coatings of batteries A-13, A-14, and A-C5 in Evaluation Example A-19;

FIG. 63 shows the result of surface analysis of an aluminum foil after charging and discharging a lithium ion secondary battery of battery A-8 in Evaluation Example A-21;

FIG. 64 shows the result of surface analysis of an aluminum foil after charging and discharging a lithium ion secondary battery of battery A-9 in Evaluation Example A-21;

FIG. 65 is a graph showing the relationship between potential (3.1 to 4.6V) and response current in a half-cell of battery A1;

FIG. 66 is a graph showing the relationship between potential (3.1 to 5.1V) and response current in the half-cell of battery A1;

FIG. 67 is a graph showing the relationship between potential (3.1 to 4.6V) and response current in a half-cell of battery A2;

FIG. 68 is a graph showing the relationship between potential (3.1 to 5.1V) and response current in the half-cell of battery A2;

FIG. 69 is a graph showing the relationship between potential (3.1 to 4.6V) and response current in a half-cell of battery A3;

FIG. 70 is a graph showing the relationship between potential (3.1 to 5.1V) and response current in the half-cell of battery A3;

FIG. 71 is a graph showing the relationship between potential (3.1 to 4.6V) and response current in a half-cell of battery A4;

FIG. 72 is a graph showing the relationship between potential (3.1 to 5.1V) and response current in the half-cell of battery A4;

FIG. 73 is a graph showing the relationship between potential (3.1 to 4.6V) and response current in a half-cell of battery AC1;

FIG. 74 is a graph showing the relationship between potential (3.0 to 4.5 V) and response current in a half-cell of battery A2;

FIG. 75 is a graph showing the relationship between potential (3.0 to 5.0V) and response current in the half-cell of battery A2;

FIG. 76 is a graph showing the relationship between potential (3.0 to 4.5 V) and response current in a half-cell of battery A5;

FIG. 77 is a graph showing the relationship between potential (3.0 to 5.0V) and response current in the half-cell of battery A5;

FIG. 78 is a graph showing the relationship between potential (3.0 to 4.5 V) and response current in a half-cell of battery AC2;

FIG. 79 is a graph showing the relationship between potential (3.0 to 5.0V) and response current in the half-cell of battery AC2;

FIG. 80 shows the result of CV measurement of half-cells;

FIG. 81 shows charging/discharging curves of half-cells;

FIG. 82 shows discharging curves of a half-cell of Example C-1;

FIG. 83 shows discharging curves of a half-cell of Comparative Example C-1;

FIG. 84 shows charging/discharging curves of a half-cell of Example C-2;

FIG. 85 shows the change in discharge rate capacity associated with charging/discharging cycles in half-cells of Examples C-2 and C-3 and Comparative Examples C-1 and C-2;

FIG. 86 shows charging/discharging curves of the half-cell of Example C-1 at respective rates;

FIG. 87 shows charging/discharging curves of the half-cell of Comparative Example C-1 at respective rates;

FIG. 88 shows potential-current curves obtained from LSV measurement performed on batteries D-1, D-C1, and D-C2;

FIG. 89 shows a potential-current curve obtained from LSV measurement performed on battery D-2;

FIG. 90 shows a charging/discharging curve of a half-cell of battery D-3;

FIG. 91 shows a charging/discharging curve of a half-cell of battery D-4;

FIG. 92 shows a model illustration of charging curves of a lithium metal complex oxide;

FIG. 93 shows charging/discharging curves of a half-cell of battery D-5;

FIG. 94 shows charging/discharging curves of a half-cell of battery D-6;

FIG. 95 shows charging/discharging curves of a half-cell of battery D-7;

FIG. 96 shows charging/discharging curves of a half-cell of battery D-8; and

FIG. 97 shows charging/discharging curves of a half-cell of battery D-C3.

### DESCRIPTION OF EMBODIMENTS

Details of the nonaqueous secondary batteries according to the first to fourth modes of the present invention are described. Unless mentioned otherwise in particular, a numerical value range of “a to b” described in the present application includes, in the range thereof, a lower limit “a” and an upper limit “b.” A numerical value range can be formed by arbitrarily combining such upper limit values, lower limit values, and numerical values described in Examples. In addition, numerical values arbitrarily selected within the numerical value range can be used as upper limit and lower limit numerical values.

(Electrolytic Solution)

An electrolytic solution is an electrolytic solution containing a salt (hereinafter, sometimes referred to as “metal salt” or simply “salt”) whose cation is an alkali metal, an alkaline earth metal, or aluminum, and an organic solvent having a heteroelement. With regard to an intensity of a peak derived from the organic solvent in a vibrational spectroscopy spectrum of the electrolytic solution, Is>Io is satisfied when an intensity of a peak at a wave number of an original peak of the organic solvent is represented as Io and an intensity of a peak resulting from wave-number shifting of the original peak of the organic solvent is represented as Is.

The relationship between Is and Io in a conventional electrolytic solution is Is<Io.

Hereinafter, in an electrolytic solution containing a salt whose cation is an alkali metal, an alkaline earth metal, or aluminum, and an organic solvent having a heteroelement, regarding an intensity of a peak derived from the organic solvent in a vibrational spectroscopy spectrum of the electrolytic solution, when an intensity of an original peak of the organic solvent is represented as Io and an intensity of a peak resulting from shifting of the original peak is represented as Is; an electrolytic solution satisfying Is>Io is sometimes referred to as “an electrolytic solution of the present invention.”

The metal salt may be a compound used as an electrolyte, such as LiClO₄, LiAsF₆, LiPF₆, LiBF₄, and LiAlCl₄ ordinarily contained in an electrolytic solution of a battery. Examples of a cation of the metal salt include alkali metals such as lithium, sodium, and potassium, alkaline earth metals such as beryllium, magnesium, calcium, strontium, and barium, and aluminum. The cation of the metal salt is preferably a metal ion identical to a charge carrier of the battery in which the electrolytic solution is used. For example, when the electrolytic solution of the present invention is to be used as an electrolytic solution for lithium ion secondary batteries, the cation of the metal salt is preferably lithium.

The chemical structure of an anion of the salt may include at least one element selected from a halogen, boron, nitrogen, oxygen, sulfur, or carbon. Specific examples of the chemical structure of the anion including a halogen or boron include: ClO₄, PF₆, AsF₆, SbF₆, TaF₆, BF₄, SiF₆, B (C₆H₅)₄, B (oxalate)₂, Cl, Br, and I.

The chemical structure of the anion including nitrogen, oxygen, sulfur, or carbon is described specifically in the following.

The chemical structure of the anion of the salt is preferably a chemical structure represented by the following general formula (1), general formula (2), or general formula (3).

(R¹X¹)(R²X²)N General Formula (1)

(R¹ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R² is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

Furthermore, R¹ and R² optionally bind with each other to form a ring.

X¹ is selected from SO₂, C═O, C═S, R^{a}P═O, R^{b}P═S, S═O, or Si═O.

X² is selected from SO₂, C═O, C═S, R^{c}P═O, R^{d}P═S, S═O, or Si═O.

R^{a}, R^{b}, R^{c}, and R⁻are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{a}, R^{b}, R^{c}, and R^{d} each optionally bind with R¹ or R² to form a ring.)

R³X³Y General Formula (2)

(R³ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

X³ is selected from SO₂, C═O, C═S, R^{e}P═O, R^{f}P═S, S═O, or Si═O.

R^{e} and R^{f} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{e} and R^{f} each optionally bind with R³ to form a ring.

Y is selected from O or S.)

(R⁴X⁴)(R⁵X⁵)(R⁶X⁶)C General Formula (3)

(R⁴ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R⁵ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R⁶ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

In addition, any two or three of R⁴, R⁵, and R⁶ optionally bind with each other to form a ring.

X⁴ is selected from SO₂, C═O, C═S, R^{g}P═O, R^{h}P═S, S═O, or Si═O.

X⁵ is selected from SO₂, C═O, C═S, RⁱP═O, RⁱP═S, S═O, or Si═O.

X⁶ is selected from SO₂, C═O, C═S, R^{k}P═O, R^{l}P═S, S═O, or Si═O.

R^{g}, R^{h}, Rⁱ, R^{j}, R^{k}, and R^{l} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{g}, R^{h}, Rⁱ, R^{j}, R^{k}, and R^{l} each optionally bind with R⁴, R⁵, or R⁶ to form a ring.)

The wording of “optionally substituted with a substituent group” in the chemical structures represented by the above described general formulae (1) to (3) is to be described. For example, “an alkyl group optionally substituted with a substituent group” refers to an alkyl group in which one or more hydrogen atoms of the alkyl group is substituted with a substituent group, or an alkyl group not including any particular substituent groups.

Examples of the substituent group in the wording of “optionally substituted with a substituent group” include alkyl groups, alkenyl groups, alkynyl groups, cycloalkyl groups, unsaturated cycloalkyl groups, aromatic groups, heterocyclic groups, halogens, OH, SH, CN, SCN, OCN, nitro group, alkoxy groups, unsaturated alkoxy groups, amino group, alkylamino groups, dialkylamino groups, aryloxy groups, acyl groups, alkoxycarbonyl groups, acyloxy groups, aryloxycarbonyl groups, acylamino groups, alkoxycarbonylamino groups, aryloxycarbonylamino groups, sulfonylamino groups, sulfamoyl groups, carbamoyl group, alkylthio groups, arylthio groups, sulfonyl group, sulfinyl group, ureido groups, phosphoric acid amide groups, sulfo group, carboxyl group, hydroxamic acid groups, sulfino group, hydrazino group, imino group, and silyl group, etc. These substituent groups may be further substituted. In addition, when two or more substituent groups exist, the substituent groups may be identical or different from each other.

The chemical structure of the anion of the salt is more preferably a chemical structure represented by the following general formula (4), general formula (5), or general formula (6).

(R⁷X⁷)(R⁸X⁸)N General Formula (4)

(R⁷ and R⁸ are each independently CₙHₐF_{b}Cl_{c}Br_{d}Iₑ(CN)_{f}(SCN)_{g}(OCN)ₕ.

“n,” “a,” “b,” “c,” “d,” “e,” “f,” “g,” and “h” are each independently an integer not smaller than 0, and satisfy 2n+1=a+b+c+d+e+f+g+h.

In addition, R⁷ and R⁸ optionally bind with each other to form a ring, and, in that case, satisfy 2n=a+b+c+d+e+f+g+h.

X⁷ is selected from SO₂, C═O, C═S, R^{m}P═O, RⁿP═S, S═O, or Si═O.

X⁸ is selected from SO₂, C═O, C═S, R^{o}P═O, R^{p}P═S, S═O, or Si═O.

R^{m}, Rⁿ, R^{o}, and R^{p} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{m}, Rⁿ, R^{o}, and RP each optionally bind with R⁷ or R⁸ to form a ring.)

R⁹X⁹Y General Formula (5)

(R⁹ is CₙHₐF_{b}Cl_{c}Br_{d}Iₑ(CN)_{f}(SCN)_{g}(OCN)ₕ. “n,” “a,” “b,” “c,” “d,” “e,” “f,” “g,” and “h” are each independently an integer not smaller than 0, and satisfy 2n+1=a+b+c+d+e+f+g+h.

X⁹ is selected from SO₂, C═O, C═S, R^{q}P═O, R^{r}P═S, S═O, or Si═O.

R^{g} and R^{r} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{g} and R^{r} each optionally bind with R⁹ to form a ring.

Y is selected from O or S.)

(R¹⁰X¹⁰)(R¹¹X¹¹)(R¹²X¹²)C General Formula (6)

(R¹⁰, R¹¹, and R¹² are each independently CₙHₐF_{b}Cl_{c}Br_{d}Iₑ(CN)_{f}(SCN)_{g}(OCN)ₕ.

“n,” “a,” “b,” “c,” “d,” “e,” “f,” “g,” and “h” are each independently an integer not smaller than 0, and satisfy 2n+1=a+b+c+d+e+f+g+h.

Any two of R¹⁰, R¹¹, and R¹² optionally bind with each other to form a ring, and, in that case, groups forming the ring satisfy 2n=a+b+c+d+e+f+g+h. In addition, the three of R¹⁰, R¹¹, and R¹² optionally bind with each other to form a ring, and, in that case, among the three, two groups satisfy 2n=a+b+c+d+e+f+g+h and one group satisfies 2n−1=a+b+c+d+e+f+g+h.

X¹⁰ is selected from SO₂, C═O, C═S, R^{s}P=O, R^{t}P═S, S═O, or Si═O.

X¹¹ is selected from SO₂, C═O, C═S, R^{u}P═O, R^{v}P═S, S═O, or Si═O.

X¹² is selected from SO₂, C═O, C═S, R^{w}P=O, R^{X}P═S, S═O, or Si═O.

R^{s}, R^{t}, R^{u}, R^{v}, R^{w}, and R^{x} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{s}, R^{t}, R^{u}, R^{v}, R^{w}, and R^{x} each optionally bind with R¹⁰, R¹¹, or R¹² to form a ring.)

In the chemical structures represented by the general formulae (4) to (6), the meaning of the wording of “optionally substituted with a substituent group” is synonymous with that described for the general formulae (1) to (3).

In the chemical structures represented by the general formulae (4) to (6), “n” is preferably an integer from 0 to 6, more preferably an integer from 0 to 4, and particularly preferably an integer from 0 to 2 . In the chemical structures represented by the general formulae (4) to (6), when R⁷ and R⁸ bind with each other or R¹⁰, R¹¹, and R¹² bind with each other to form a ring; “n” is preferably an integer from 1 to 8, more preferably an integer from 1 to 7, and particularly preferably an integer from 1 to 3.

The chemical structure of the anion of the salt is further preferably represented by the following general formula (7), general formula (8), or general formula (9).

(R¹³SO₂)(R¹⁴SO₂)N General Formula (7)

(R¹³ and R¹⁴ are each independently CₙHₐF_{b}Cl_{c}Br_{d}Iₑ.

“n,” “a,” “b,” “c,” “d,” and “e” are each independently an integer not smaller than 0, and satisfy 2n+1=a+b+c+d+e.

In addition, R¹³ and R¹⁴ optionally bind with each other to form a ring, and, in that case, satisfy 2n=a+b+c+d+e.)

R¹⁵SO₃ General Formula (8)

(R¹⁵ is CₙHₐF_{b}Cl_{c}Br_{d}Iₑ.

“n,” “a,” “b,” “c,” “d,” and “e” are each independently an integer not smaller than 0, and satisfy 2n+1=a+b+c+d+e.)

(R¹⁶SO₂)(R¹⁷SO₂)(R¹⁸SO₂)C General Formula (9)

(R¹⁶, R¹⁷, and R¹⁸ are each independently CₙHₐF_{b}Cl_{c}Br_{d}Iₑ.

“n,” “a,” “b,” “c,” “d,” and “e” are each independently an integer not smaller than 0, and satisfy 2n+1=a+b+c+d+e.

Any two of R¹⁶, R¹⁷, and R¹⁸ optionally bind with each other to form a ring, and, in that case, groups forming the ring satisfy 2n=a+b+c+d+e. In addition, the three of R¹⁶, R¹⁷, and R¹⁸ optionally bind with each other to form a ring, and, in that case, among the three, two groups satisfy 2n=a+b+c+d+e and one group satisfies 2n−1=a+b+c+d+e.)

In the chemical structures represented by the general formulae (7) to (9), “n” is preferably an integer from 0 to 6, more preferably an integer from 0 to 4, and particularly preferably an integer from 0 to 2 . In the chemical structures represented by the general formulae (7) to (9), when R¹³ and R¹⁴ bind with each other or R¹⁶, R¹⁷ and R¹⁸ bind with each other to form a ring; “n” is preferably an integer from 1 to 8, more preferably an integer from 1 to 7, and particularly preferably an integer from 1 to 3.

In addition, in the chemical structures represented by the general formulae (7) to (9), those in which “a,” “c,” “d,” and “e” are 0 are preferable.

The metal salt is particularly preferably (CF₃SO₂)₂NLi (hereinafter, sometimes referred to as “LiTFSA”), (FSO₂)₂NLi (hereinafter, sometimes referred to as “LiFSA”), (C₂F₅SO₂)₂NLi, FSO₂(CF₃SO₂)NLi, (SO₂CF₂CF₂SO₂) NLi, (SO₂CF₂CF₂CF₂SO₂) NLi, FSO₂(CH₃SO₂)NLi, FSO₂(C₂F₅SO₂)NLi, or FSO₂(C₂H₅SO₂)NLi.

As the metal salt of the present invention, one that is obtained by combining appropriate numbers of a cation and an anion described above may be used. Regarding the metal salt in the electrolytic solution of the present invention, a single type may be used, or a combination of two or more types may be used.

As the organic solvent having a heteroelement, an organic solvent whose heteroelement is at least one selected from nitrogen, oxygen, sulfur, or a halogen is preferable, and an organic solvent whose heteroelement is at least one selected from nitrogen or oxygen is more preferable. In addition, as the organic solvent having the heteroelement, an aprotic solvent not having a proton donor group such as NH group, NH₂ group, OH group, and SH group is preferable.

Specific examples of “the organic solvent having the heteroelement” (hereinafter, sometimes simply referred to as “organic solvent”) include nitriles such as acetonitrile, propionitrile, acrylonitrile, and malononitrile, ethers such as 1,2-dimethoxyethane, 1,2-diethoxyethane, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, and crown ethers, carbonates such as ethylene carbonate, propylene carbonate, dimethyl carbonate, diethyl carbonate, and ethyl methyl carbonate, amides such as formamide, N,N-dimethylformamide, N,N-dimethylacetamide, and N-methylpyrrolidone, isocyanates such as isopropyl isocyanate, n-propylisocyanate, and chloromethyl isocyanate, esters such as methyl acetate, ethyl acetate, propyl acetate, methyl propionate, methyl formate, ethyl formate, vinyl acetate, methyl acrylate, and methyl methacrylate, epoxies such as glycidyl methyl ether, epoxy butane, and 2-ethyloxirane, oxazoles such as oxazole, 2-ethyloxazole, oxazoline, and 2-methyl-2-oxazoline, ketones such as acetone, methyl ethyl ketone, and methyl isobutyl ketone, acid anhydrides such as acetic anhydride and propionic anhydride, sulfones such as dimethyl sulfone and sulfolane, sulfoxides such as dimethyl sulfoxide, nitros such as 1-nitropropane and 2-nitropropane, furans such as furan and furfural, cyclic esters such as γ-butyrolactone, γ-valerolactone, and δ-valerolactone, aromatic heterocycles such as thiophene and pyridine, heterocycles such as tetrahydro-4-pyrone, 1-methylpyrrolidine, and N-methylmorpholine, and phosphoric acid esters such as trimethyl phosphate and triethyl phosphate.

Examples of the organic solvent include linear carbonates represented by the following general formula (10).

R¹⁹OCOOR²⁰ General Formula (10)

(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.)

In the linear carbonates represented by the general formula (10), “n” is preferably an integer from 1 to 6, more preferably an integer from 1 to 4, and particularly preferably an integer from 1 to 2. “m” is preferably an integer from 3 to 8, more preferably an integer from 4 to 7, and particularly preferably an integer from 5 to 6. In addition, among the linear carbonates represented by the general formula (10), dimethyl carbonate (hereinafter, sometimes referred to as “DMC”), diethyl carbonate (hereinafter, sometimes referred to as “DEC”), and ethyl methyl carbonate (hereinafter, sometimes referred to as “EMC”) are particularly preferable.

As the organic solvent, a solvent whose relative permittivity is not smaller than 20 or that has ether oxygen having donor property is preferable, and examples of such an organic solvent include nitriles such as acetonitrile, propionitrile, acrylonitrile, and malononitrile, ethers such as 1,2-dimethoxyethane, 1,2-diethoxyethane, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, and crown ethers, N,N-dimethylformamide, acetone, dimethyl sulfoxide, and sulfolane. Among those, acetonitrile (hereinafter, sometimes referred to as “AN”) and 1,2-dimethoxyethane (hereinafter, sometimes referred to as “DME”) are particularly preferable.

Regarding these organic solvents, a single type may be used by itself in the electrolytic solution, or a combination of two or more types may be used.

A feature of the electrolytic solution of the present invention is, in its vibrational spectroscopy spectrum and regarding an intensity of a peak derived from the organic solvent contained in the electrolytic solution, satisfying Is>Io when an intensity of an original peak of the organic solvent is represented as Io and an intensity of “a peak resulting from shifting of the original peak of the organic solvent” (hereinafter, sometimes referred to as “shift peak”) is represented as Is. More specifically, in a vibrational spectroscopy spectrum chart obtained by subjecting the electrolytic solution of the present invention to vibrational spectroscopy measurement, the relationship between the two peak intensities is Is>Io.

Here, “an original peak of the organic solvent” refers to a peak observed at a peak position (wave number) when the vibrational spectroscopy measurement is performed only on the organic solvent. The value of the intensity Io of the original peak of the organic solvent and the value of the intensity Is of the shift peak are the heights or area sizes from a baseline of respective peaks in the vibrational spectroscopy spectrum.

In the vibrational spectroscopy spectrum of the electrolytic solution of the present invention, when multiple peaks resulting from shifting of the original peak of the organic solvent exist, the relationship may be determined based on a peak enabling determination of the relationship between Is and Io most easily. In addition, when multiple types of the organic solvent having the heteroelement are used in the electrolytic solution of the present invention, an organic solvent enabling determination of the relationship between Is and Io most easily (resulting in the largest difference between Is and Io) is selected, and the relationship between Is and Io may be determined based on the obtained peak intensity. In addition, when the peak shift amount is small and peaks before and after shifting overlap with each other to give an appearance like a smooth mountain, the relationship between Is and Io may be determined by performing peak resolution with known means.

In the vibrational spectroscopy spectrum of the electrolytic solution using multiple types of the organic solvent having the heteroelement, a peak of an organic solvent most easily coordinated with a cation (hereinafter, sometimes referred to as “preferential coordination solvent”) shifts preferentially from others. In the electrolytic solution using multiple types of the organic solvent having the heteroelement, the mass % of the preferential coordination solvent with respect to the whole organic solvent having the heteroelement is preferably 40% or higher, more preferably 50% or higher, further preferably 60% or higher, andparticularlypreferably 80% or higher. In addition, in the electrolytic solution using multiple types of the organic solvent having the heteroelement, the vol % of the preferential coordination solvent with respect to the whole organic solvent having the heteroelement is preferably 40% or higher, more preferably 50% or higher, further preferably 60% or higher, and particularly preferably 80% or higher.

The relationship between the two peak intensities in the vibrational spectroscopy spectrum of the electrolytic solution of the present invention preferably satisfies a condition of Is>2×Io, more preferably satisfies a condition of Is>3×Io, further preferably satisfies a condition of Is>5×Io, and particularly preferably satisfies a condition of Is>7×Io. A most preferable electrolytic solution is one in which the intensity Io of the original peak of the organic solvent is not observed and the intensity Is of the shift peak is observed in the vibrational spectroscopy spectrum of the electrolytic solution of the present invention. This means that, in the electrolytic solution, all molecules of the organic solvent contained in the electrolytic solution are completely solvated with the metal salt. The electrolytic solution of the present invention is most preferably in a state in which all molecules of the organic solvent contained in the electrolytic solution are completely solvated with the metal salt (a state of Io=0).

In the electrolytic solution of the present invention, the metal salt and the organic solvent having the heteroelement (or the preferential coordination solvent) are estimated to interact with each other. Specifically, the metal salt and the heteroelement in the organic solvent having the heteroelement (or the preferential coordination solvent) are estimated to form a coordinate bond and form a stable cluster formed of the metal salt and the organic solvent having the heteroelement (or the preferential coordination solvent). Based on results from later described Evaluation Examples, the cluster is estimated to be formed mostly from coordination of 2 molecules of the organic solvent having the heteroelement (or the preferential coordination solvent) with respect to 1 molecule of the metal salt. When this point is taken into consideration, in the electrolytic solution of the present invention, the mol range of the organic solvent having the heteroelement (or the preferential coordination solvent) with respect to 1 mol of the metal salt is preferably not lower than 1.4 mol but lower than 3.5 mol, more preferably not lower than 1.5 mol but not higher than 3.1 mol, and further preferably not lower than 1.6 mol but not higher than 3 mol.

In the electrolytic solution of the present invention, since a cluster is estimated to be formed mostly from coordination of 2 molecules of the organic solvent having the heteroelement (or the preferential coordination solvent)with respect to 1 molecule of the metal salt, the concentration (mol/L) of the electrolytic solution of the present invention depends on respective molecular weights of the metal salt and the organic solvent, and the density in the solution. Thus, unconditionally defining the concentration of the electrolytic solution of the present invention is not appropriate.

Concentration c (mol/L) of each of the electrolytic solutions of the present invention is shown in Table 1.

TABLE 1

| Metal salt | Organic solvent | Concentration (mol/L) |
|---|---|---|
| LiTFSA | DME | 2.2 to 3.4 |
| LiTFSA | AN | 3.2 to 4.9 |
| LiFSA | DME | 2.6 to 4.1 |
| LiFSA | AN | 3.9 to 6.0 |
| LiFSA | DMC | 2.3 to 4.5 |
| LiFSA | EMC | 2.0 to 3.8 |
| LiFSA | DEC | 1.8 to 3.6 |

An organic solvent forming the cluster and an organic solvent not involved in the formation of the cluster are different in terms of the environment in which the respective organic solvents exist. Thus, in the vibrational spectroscopy measurement, a peak derived from the organic solvent forming the cluster is observed to be shifted toward the high wave number side or the low wave number side with respect to the wave number observed at a peak (original peak of the organic solvent) derived from the organic solvent not involved in the formation of the cluster. Thus, the shift peak represents a peak of the organic solvent forming the cluster.

Examples of the vibrational spectroscopy spectrum include an IR spectrum or a Raman spectrum. Examples of measuring methods of IR measurement include transmission measuring methods such as Nujol mull method and liquid film method, and reflection measuring methods such as ATR method. Regarding which of the IR spectrum and the Raman spectrum is to be selected, a spectrum enabling easy determination of the relationship between Is and Io may be selected as the vibrational spectroscopy spectrum of the electrolytic solution of the present invention. The vibrational spectroscopy measurement is preferably performed at a condition where the effect of moisture in the atmosphere can be lessened or ignored. For example, performing the IR measurement under a low humidity or zero humidity condition such as in a dry room or a glovebox is preferable, or performing the Raman measurement in a state where the electrolytic solution is kept inside a sealed container is preferable.

Here, specific description is provided regarding a peak of the electrolytic solution of the present invention containing LiTFSA as the metal salt and acetonitrile as the organic solvent.

When the IR measurement is performed on acetonitrile alone, a peak derived from stretching vibration of a triple bond between C and N is ordinarily observed at around 2100 to 2400 cm⁻¹.

Here, based on conventional technical common knowledge, a case is envisioned in which an electrolytic solution is obtained by dissolving LiTFSA in an acetonitrile solvent at a concentration of 1 mol/L. Since 1 L of acetonitrile corresponds to approximately 19 mol, 1 mol of LiTFSA and 19 mol of acetonitrile exist in 1 L of a conventional electrolytic solution. Then, in the conventional electrolytic solution, at the same time when acetonitrile solvated with LiTFSA (coordinated with Li) exists, a large amount of acetonitrile not solvated with LiTFSA (not coordinated with Li) exists. Since an acetonitrile molecule solvated with LiTFSA and an acetonitrile molecule not solvated with LiTFSA are different regarding the environments in which the respective acetonitrile molecules are placed, the acetonitrile peaks of both molecules are distinctively observed in the IR spectrum. More specifically, although a peak of acetonitrile not solvated with LiTFSA is observed at the same position (wavenumber) as in the case with the IRmeasurement on acetonitrile alone, a peak of acetonitrile solvated with LiTFSA is observed such that its peak position (wave number) is shifted toward the high wave number side.

Since a large amount of acetonitrile not solvated with LiTFSA exists at the concentration of the conventional electrolytic solution, the relationship between the intensity Io of the original peak of acetonitrile and the intensity Is of the peak resulting from shift of the original peak of acetonitrile becomes Is<Io in the vibrational spectroscopy spectrum of the conventional electrolytic solution.

On the other hand, when compared to the conventional electrolytic solution, the electrolytic solution of the present invention has a high concentration of LiTFSA, and the number of acetonitrile molecules solvated (forming a cluster) with LiTFSA in the electrolytic solution is larger than the number of acetonitrile molecules not solvated with LiTFSA. As a result, the relationship between the intensity Io of the original peak of acetonitrile and the intensity Is of the peak resulting from shifting of the original peak of acetonitrile becomes Is>Io in the vibrational spectroscopy spectrum of the electrolytic solution of the present invention.

In Table 2, wave numbers and attributions thereof are exemplified for organic solvents considered to be useful when calculating Io and Is in the vibrational spectroscopy spectrum of the electrolytic solution of the present invention. Depending on measuring devices, measuring environments, and measuring conditions used for obtaining the vibrational spectroscopy spectrum, the wave number of the observed peak may be different from the following wave numbers.

TABLE 2

| | Wave | |
|---|---|---|
| | number | |
| Organic solvent | (cm⁻¹) | Attribution |
| Ethylene carbonate | 1769 | Double bond between C and O |
| Propylene carbonate | 1829 | Double bond between C and O |
| Acetic anhydride | 1785, 1826 | Double bond between C and O |
| Acetone | 1727 | Double bond between C and O |
| Acetonitrile | 2250 | Triple bond between C and N |
| Acetonitrile | 899 | C—C single bond |
| DME | 1099 | C—O single bond |
| DME | 1124 | C—O single bond |
| N,N-dimethylformamide | 1708 | Double bond between C and O |
| γ-Butyrolactone | 1800 | Double bond between C and O |
| Nitropropane | 1563 | Double bond between N and O |
| Pyridine | 977 | Unknown |
| Dimethyl sulfoxide | 1017 | Double bond between S and O |

Regarding a wave number of an organic solvent and an attribution thereof, well-known data may be referenced. Examples of the reference include “Raman spectrometry” Spectroscopical Society of Japan measurement method series 17, Hiroo Hamaguchi and Akiko Hirakawa, Japan Scientific Societies Press, pages 231 to 249. In addition, a wave number of an organic solvent considered to be useful for calculating Io and Is, and a shift in the wave number when the organic solvent and the metal salt coordinate with each other are predicted from a calculation using a computer. For example, the calculation may be performed by using Gaussian09 (Registered trademark, Gaussian, Inc.), and setting the density function to B3LYP and the basis function to 6-311G++ (d, p). A person skilled in the art can calculate Io and Is by referring to the description in Table 2, well-known data, and a calculation result from a computer to select a peak of an organic solvent.

Since the electrolytic solution of the present invention has the metal salt and the organic solvent exist in a different environment and has a high metal salt concentration when compared to the conventional electrolytic solution; improvement in a metal ion transportation rate in the electrolytic solution (particularly improvement of lithium transference number when the metal is lithium), improvement in reaction rate between an electrode and an electrolytic solution interface, mitigation of uneven distribution of salt concentration in the electrolytic solution caused when a battery undergoes high-rate charging and discharging, and increase in the capacity of an electrical double layer are expected. In the electrolytic solution of the present invention, since most of the organic solvent having the heteroelement is forming a cluster with the metal salt, the vapor pressure of the organic solvent contained in the electrolytic solution becomes lower. As a result, volatilization of the organic solvent from the electrolytic solution of the present invention is reduced.

When compared to the electrolytic solution of a conventional battery, the electrolytic solution of the present invention has a high viscosity. Thus, with a battery using the electrolytic solution of the present invention, even if the battery is damaged, leakage of the electrolytic solution is suppressed. Furthermore, a lithium ion secondary battery using the conventional electrolytic solution has displayed a significant decrease in capacity when subjected to high-rate charging and discharging cycles. One conceivable reason thereof is the inability of the electrolytic solution to supply sufficient amount of Li to a reaction interface with an electrode because of Li concentration unevenness generated in the electrolytic solution when charging and discharging are repeated rapidly, i.e., uneven distribution of Li concentration in the electrolytic solution. However, in a secondary battery using the electrolytic solution of the present invention, the capacity was shown to be suitably maintained when undergoing high-rate charging and discharging. A conceivable reason for that is the ability to suppress uneven distribution of the Li concentration in the electrolytic solution due to a physical property regarding having a high viscosity in the electrolytic solution of the present invention. In addition, another conceivable reason for the suppression of decrease in capacity when undergoing high-rate charging and discharging cycles is, due to the physical property regarding having a high viscosity in the electrolytic solution of the present invention, improvement in liquid retaining property of the electrolytic solution at an electrode interface, resulting in suppression of a state of lacking the electrolytic solution at the electrode interface (i.e., liquid run-out state).

Regarding a viscosity η (mPa·s) of the electrolytic solution of the present invention, a range of 10<η<500 is preferable, a range of 12<η<400 is more preferable, a range of 15<η<300 is further preferable, a range of 18<η<150 is particularly preferable, and a range of 20<η<140 is most preferable.

Ions move within an electrolytic solution easier when an ionic conductivity σ (mS/cm) of the electrolytic solution is higher. Thus, such an electrolytic solution is an excellent electrolytic solution for batteries. The ionic conductivity σ (mS/cm) of the electrolytic solution of the present invention preferably satisfies 1≦σ. Regarding the ionic conductivity σ (mS/cm) of the electrolytic solution of the present invention, if a suitable range including an upper limit is to be shown, a range of 2<σ<200 is preferable, a range of 3<σ<100 is more preferable, a range of 4<σ<50 is further preferable, and a range of 5<σ<35 is particularly preferable.

The electrolytic solution of the present invention contains a cation of the metal salt at a high concentration. Thus, the distance between adjacent cations is extremely small within the electrolytic solution of the present invention. When a cation such as a lithium ion moves between a positive electrode and a negative electrode during charging and discharging of the secondary battery, a cation located most closely to an electrode that is a movement destination is firstly supplied to the electrode. Then, to the place where the supplied cation had been located, another cation adjacent to the cation moves. Thus, in the electrolytic solution of the present invention, a domino toppling-like phenomenon is predicted to be occurring in which adjacent cations sequentially change their positions one by one toward an electrode that is a supply target. Because of that, the distance for which a cation moves during charging and discharging is thought to be short, and movement speed of the cation is thought to be high, accordingly. Because of this reason, the secondary battery having the electrolytic solution of the present invention is thought to have a high reaction rate.

Adensityd (g/cm³) of the electrolytic solution of the present invention preferably satisfies d≧1.2 or d≦2.2, and is more preferably within a range of 1.2≦d≦2.2, even more preferably within a range of 1.24≦d≦2.0, further preferably within a range of 1.2≦d≦1.8, and particularly preferably within a range of 1.27≦d≦1.6. The density d (g/cm³) of the electrolytic solution of the present invention refers to the density at 20° C.

In the electrolytic solution of the present invention, “d/c” obtained by dividing the density d (g/cm³) of the electrolytic solution by the concentration c (mol/L) of the electrolytic solution is preferably within a range of ≦0.15d/c≦0.71, more preferably within a range of 0.15≦d/c≦0.56, even more preferably within a range of 0.25≦d/c≦0.56, further preferably within a range of 0.2≦d/c≦0.50, and particularly preferably within a range of 0.27≦d/c≦0.47.

“d/c” of the electrolytic solution of the present invention is defined also when the metal salt and the organic solvent are specified. For example, when LiTFSA and DME are respectively selected as the metal salt and the organic solvent, d/c is preferably within a range of 0.42≦d/c≦0.56 and more preferably within a range of 0.4≦d/c≦0.52. When LiTFSA and AN are respectively selected as the metal salt and the organic solvent, d/c is preferably within a range of 0.35≦d/c≦0.41 and more preferably within a range of 0.36≦d/c≦0.39. When LiFSA and DME are respectively selected as the metal salt and the organic solvent, d/c is preferably within a range of 0.32≦d/c≦0.46 and more preferably within a range of 0.34≦d/c≦0.42. When LiFSA and AN are respectively selected as the metal salt and the organic solvent, d/c is preferably within a range of 0.25≦d/c≦0.31 and more preferably within a range of 0.26≦d/c≦0.29. When LiFSA and DMC are respectively selected as the metal salt and the organic solvent, d/c is preferably within a range of 0.32≦d/c≦0.48, more preferably within a range of 0.32≦d/c≦0.46, and further preferably within a range of 0.34≦d/c≦0.42. When LiFSA and EMC are respectively selected as the metal salt and the organic solvent, d/c is preferably within a range of 0.34≦d/c≦0.50 and more preferably within a range of 0.37≦d/c≦0.45. When LiFSA and DEC are respectively selected as the metal salt and the organic solvent, d/c is preferably within a range of 0.36≦d/c≦0.54 and more preferably within a range of 0.39≦d/c≦0.48.

The method for producing the electrolytic solution of the present invention is described. Since the electrolytic solution of the present invention contains a large amount of the metal salt compared to the conventional electrolytic solution, a production method of adding the organic solvent to a solid (powder) metal salt results in an aggregate, and manufacturing an electrolytic solution in a solution state is difficult. Thus, in the method for producing the electrolytic solution of the present invention, the metal salt is preferably gradually added to the organic solvent while a solution state of the electrolytic solution is maintained during production.

Depending on the types of the metal salt and the organic solvent, the electrolytic solution of the present invention includes a liquid in which the metal salt is dissolved in the organic solvent in a manner exceeding a conventionally regarded saturation solubility. A method for producing the electrolytic solution of the present invention includes: a first dissolution step of preparing a first electrolytic solution by mixing the organic solvent having the heteroelement and the metal salt to dissolve the metal salt; a second dissolution step of preparing a second electrolytic solution in a supersaturation state by adding the metal salt to the first electrolytic solution under stirring and/or heating conditions to dissolve the metal salt; and a third dissolution step of preparing a third electrolytic solution by adding the metal salt to the second electrolytic solution under stirring and/or heating conditions to dissolve the metal salt.

Here, the “supersaturation state” described above refers to a state in which a metal salt crystal is deposited from the electrolytic solution when the stirring and/or heating conditions are discontinued or when crystal nucleation energy such as vibration is provided thereto. The second electrolytic solution is in the “supersaturation state,” whereas the first electrolytic solution and the third electrolytic solution are not in the “supersaturation state”.

In other words, with the method for producing the electrolytic solution of the present invention, via the first electrolytic solution encompassing a conventional metal salt concentration and being in a thermodynamically stable liquid state, and via the second electrolytic solution in a thermodynamically unstable liquid state, the third electrolytic solution, i.e., the electrolytic solution of the present invention, in a thermodynamically stable new liquid state is obtained.

Since the third electrolytic solution in the stable liquid state maintains its liquid state at an ordinary condition, in the third electrolytic solution, for example, a cluster, formed of 2 molecules of the organic solvent with respect to 1 molecule of a lithium salt and stabilized by a strong coordinate bond between these molecules, is estimated to be inhibiting crystallization of the lithium salt.

The first dissolution step is a step of preparing the first electrolytic solution by mixing the organic solvent having a heteroatom with the metal salt to dissolve the metal salt.

For the purpose of mixing the organic solvent having a heteroatom with the metal salt, the metal salt may be added with respect to the organic solvent having a heteroatom, or the organic solvent having a heteroatom may be added with respect to the metal salt.

The first dissolution step is preferably performed under stirring and/or heating conditions. The stirring speed may be set suitably. The heating condition is preferably controlled suitably using a temperature controlled bath such as a water bath or an oil bath. Since dissolution heat is generated when dissolving the metal salt, the temperature condition is preferably strictly controlled when a metal salt that is unstable against heat is to be used. In addition, the organic solvent may be cooled in advance, or the first dissolution step may be performed under a cooling condition.

The first dissolution step and the second dissolution step may be performed continuously, or the first electrolytic solution obtained from the first dissolution step may be temporarily kept (left still), and the second dissolution step may be performed after a certain period of time has elapsed.

The second dissolution step is a step of preparing the second electrolytic solution in the supersaturation state by adding the metal salt to the first electrolytic solution under stirring and/or heating conditions to dissolve the metal salt.

Performing the second dissolution step under the stirring and/or heating conditions is essential for preparing the second electrolytic solution in the thermodynamically unstable supersaturation state. The stirring condition may be obtained by performing the second dissolution step in a stirring device accompanied with a stirrer such as a mixer, or the stirring condition may be obtained by performing the second dissolution step using a stirring bar and a device (stirrer) for moving the stirring bar. The heating condition is preferably controlled suitably using a temperature controlled bath such as a water bath or an oil bath. Needless to say, performing the second dissolution step using an apparatus or a system having both a stirring function and a heating function is particularly preferable. “Heating” in the method for producing the electrolytic solution refers to warming an object to a temperature not lower than an ordinary temperature (25° C.). The heating temperature is more preferably not lower than 30° C. and further preferably not lower than 35° C. In addition, the heating temperature is preferably a temperature lower than the boiling point of the organic solvent.

In the second dissolution step, when the added metal salt does not dissolve sufficiently, increasing the stirring speed and/or further heating are performed. In this case, a small amount of the organic solvent having a heteroatom may be added to the electrolytic solution in the second dissolution step.

Since temporarily leaving still the second electrolytic solution obtained in the second dissolution step causes deposition of crystal of the metal salt, the second dissolution step and the third dissolution step are preferably performed continuously.

The third dissolution step is a step of preparing the third electrolytic solution by adding the metal salt to the second electrolytic solution under stirring and/or heating conditions to dissolve the metal salt. In the third dissolution step, since adding and dissolving the metal salt in the second electrolytic solution in the supersaturation state are necessary, performing the step under stirring and/or heating conditions similarly to the second dissolution step is essential. Specific stirring and/or heating conditions are similar to the conditions for the second dissolution step.

When the mole ratio of the organic solvent and the metal salt added throughout the first dissolution step, the second dissolution step, and the third dissolution step reaches roughly about 2:1, production of the third electrolytic solution (the electrolytic solution of the present invention) ends. A metal salt crystal is not deposited from the electrolytic solution of the present invention even when the stirring and/or heating conditions are discontinued. Based on these circumstances, in the electrolytic solution of the present invention, for example, a cluster, formed of 2 molecules of the organic solvent with respect to 1 molecule of a lithium salt and stabilized by a strong coordinate bond between these molecules, is estimated to be formed.

When producing the electrolytic solution of the present invention, even without via the supersaturation state at processing temperatures of each of the dissolution steps, the electrolytic solution of the present invention is suitably produced using the specific dissolution means described in the first to third dissolution steps depending on the types of the metal salt and the organic solvent .

In addition, the method for producing the electrolytic solution of the present invention preferably includes a vibrational spectroscopy measurement step of performing vibrational spectroscopy measurement on the electrolytic solution that is being produced. As a specific vibrational spectroscopy measurement step, for example, a method in which a portion of each of the electrolytic solutions being produced is sampled to be subjected to vibrational spectroscopy measurement may be performed, or a method in which vibrational spectroscopy measurement is conducted on each of the electrolytic solutions in situ may be performed. Examples of the method of conducting the vibrational spectroscopy measurement on the electrolytic solution in situ include a method of introducing the electrolytic solution that is being produced in a transparent flow cell and conducting the vibrational spectroscopy measurement, and a method of using a transparent production container and conducting Raman measurement from outside the container. Since the relationship between Is and Io in an electrolytic solution that is being produced is confirmed by including the vibrational spectroscopy measurement step in the method for producing the electrolytic solution of the present invention, whether or not an electrolytic solution that is being produced has reached the electrolytic solution of the present invention is determined, and, when an electrolytic solution that is being produced has not reached the electrolytic solution of the present invention, how much more of the metal salt is to be added for reaching the electrolytic solution of the present invention is understood.

To the electrolytic solution of the present invention, other than the organic solvent having the heteroelement, a solvent that has a low polarity (low permittivity) or a low donor number and that does not display particular interaction with the metal salt, i.e., a solvent that does not affect formation and maintenance of the cluster in the electrolytic solution of the present invention, may be added. Adding such a solvent to the electrolytic solution of the present invention is expected to provide an effect of lowering the viscosity of the electrolytic solution while maintaining the formation of the cluster in the electrolytic solution of the present invention.

Specific examples of the solvent that does not display particular interaction with the metal salt include benzene, toluene, ethylbenzene, o-xylene, m-xylene, p-xylene, 1-methylnaphthalene, hexane, heptane, and cyclohexane.

In addition, to the electrolytic solution of the present invention, a fire-resistant solvent other than the organic solvent having the heteroelement may be added. By adding the fire-resistant solvent to the electrolytic solution of the present invention, safety of the electrolytic solution of the present invention is further enhanced. Examples of the fire-resistant solvent include halogen based solvents such as carbon tetrachloride, tetrachloroethane, and hydrofluoroether, and phosphoric acid derivatives such as trimethyl phosphate and triethyl phosphate.

Furthermore, when the electrolytic solution of the present invention is mixed with a polymer or an inorganic filler to form a mixture, the mixture enables containment of the electrolytic solution to provide a pseudo solid electrolyte. By using the pseudo solid electrolyte as an electrolytic solution of a battery, leakage of the electrolytic solution is suppressed in the battery.

As the polymer, a polymer used in batteries such as lithium ion secondary batteries and a general chemically cross-linked polymer are used. In particular, a polymer capable of turning into a gel by absorbing an electrolytic solution, such as polyvinylidene fluoride and polyhexafluoropropylene, and one obtained by introducing an ion conductive group to a polymer such as polyethylene oxide are suitable.

Specific examples of the polymer include polymethyl acrylate, polymethyl methacrylate, polyethylene oxide, polypropylene oxide, polyacrylonitrile, polyvinylidene fluoride, polyethylene glycol dimethacrylate, polyethylene glycol acrylate, polyglycidol, polytetrafluoroethylene, polyhexafluoropropylene, polysiloxane, polyvinyl acetate, polyvinyl alcohol, polyacrylic acid, polymethacrylic acid, polyitaconic acid, polyfumaric acid, polycrotonic acid, polyangelic acid, polycarboxylic acid such as carboxymethyl cellulose, styrene-butadiene rubbers, nitrile-butadiene rubbers, polystyrene, polycarbonate, unsaturated polyester obtained through copolymerization of maleic anhydride and glycols, polyethylene oxide derivatives having a substituent group, and a copolymer of vinylidene fluoride and hexafluoropropylene. In addition, as the polymer, a copolymer obtained through copolymerization of two or more types of monomers forming the above described specific polymers may be selected.

Polysaccharides are also suitable as the polymer. Specific examples of the polysaccharides include glycogen, cellulose, chitin, agarose, carrageenan, heparin, hyaluronic acid, pectin, amylopectin, xyloglucan, and amylose. In addition, materials containing these polysaccharides may be used as the polymer, and examples of the materials include agar containing polysaccharides such as agarose.

As the inorganic filler, inorganic ceramics such as oxides and nitrides are preferable.

Inorganic ceramics have hydrophilic and hydrophobic functional groups on their surfaces. Thus, a conductive passage may form within the inorganic ceramics when the functional groups attract the electrolytic solution. Furthermore, the inorganic ceramics dispersed in the electrolytic solution form a network among the inorganic ceramics themselves due to the functional groups, and may serve as containment of the electrolytic solution. With such a function by the inorganic ceramics, leakage of the electrolytic solution in the battery is further suitably suppressed. In order to have the inorganic ceramics suitably exert the function described above, the inorganic ceramics having a particle shape are preferable, and those whose particle sizes are nano level are particularly preferable.

Examples of the types of the inorganic ceramics include common alumina, silica, titania, zirconia, and lithium phosphate. In addition, inorganic ceramics that have lithium conductivity themselves are preferable, and specific examples thereof include Li₃N, LiI, LiI—Li₃N—LiOH, LiI—Li₂S—P₂O₅, LiI—Li₂S—P₂S₅, LiI—Li₂S—B₂S₃, Li₂O—B₂S₃, Li₂O—V₂O₃—SaO₂, Li₂O—B₂O₃—P₂O₅, Li₂O⁻B₂O₃—ZnO, Li₂O—Al₂O₃—TiO₂—SiO₂—P₂O₅, LiTi₂(PO₄)₃, Li-βAl₂O₃, and LiTaO₃.

Glass ceramics may be used as the inorganic filler. Since glass ceramics enables containment of ionic liquids, the same effect is expected for the electrolytic solution of the present invention. Examples of the glass ceramics include compounds represented by xLi₂S-(1-x)P₂S₅, and those in which one portion of S in the compound is substituted with another element and those in which one portion of P in the compound is substituted with germanium.

Since the electrolytic solution of the present invention described above displays excellent ionic conductivity, the electrolytic solution is suitably used as an electrolytic solution of a power storage device such as a battery. In particular, the electrolytic solution is preferably used as electrolytic solutions of secondary batteries, and, among those, preferably used as electrolytic solutions of lithium ion secondary batteries.

An S,O-containing coating is formed on the surfaces of the negative electrode and/or the positive electrode of the nonaqueous electrolyte secondary battery of the present invention. As described later, the coating includes S and O, and at least has a S═O structure. Since having the S═O structure, the S,O-containing coating is thought to be derived from the electrolytic solution. In the electrolytic solution of the present invention, a Li cation and an anion are thought to exist closer when compared to an ordinary electrolytic solution. Thus, the anion is preferentially reduced and degraded because of being strongly subjected to the electrostatic influence of the Li cation. In a general nonaqueous electrolyte secondary battery using a general electrolytic solution, an organic solvent (e.g., EC: ethylene carbonate, etc.) contained in the electrolytic solution is reduced and degraded, and an SEI coating is formed from a degradation product of the organic solvent. However, in the nonaqueous electrolyte secondary battery of the present invention containing the electrolytic solution of the present invention, the anion is preferentially reduced and degraded. As a result, an SEI coating, i.e., S,O-containing coating, in the nonaqueous electrolyte secondary battery of the present invention is thought to contain a large degree of the S═O structure derived from the anion. In other words, in an ordinary nonaqueous electrolyte secondary battery using an ordinary electrolytic solution, an SEI coating derived from the degradation product of the organic solvent such as EC is fixed on the surface of the electrodes. On the other hand, in the nonaqueous electrolyte secondary battery of the present invention using the electrolytic solution of the present invention, an SEI coating derived mainly from the anion of the metal salt is fixed on the surface of the electrodes.

In addition, although the reason is not certain, the state of the S,O-containing coating in the nonaqueous electrolyte secondary battery of the present invention changes associated with charging and discharging. For example, as described later, the thickness of the S,O-containing coating and the proportion of elements such as S and O sometimes change depending on the state of charging and discharging. Thus, in the S,O-containing coating in the nonaqueous electrolyte secondary battery of the present invention, a portion (hereinafter, referred to as a fixed portion if necessary) that is derived from the degradation product of the anion described above and is fixed in the coating, and a portion (hereinafter, referred to as adsorption portion if necessary) that becomes larger or smaller reversibly associated with charging and discharging are thought to exist. Similarly to the fixed portion, the adsorption portion is speculated to have a structure such as S═O derived from the anion of the metal salt.

Since the S,O-containing coating is thought to be formed from the degradation product of the electrolytic solution and to include other absorbates, a large portion (or all) of the S,O-containing coating is thought to be produced during and after the first charging and discharging of the nonaqueous electrolyte secondary battery. Thus, the nonaqueous electrolyte secondary battery of the present invention has the S,O-containing coating on the surface of the negative electrode and/or the surface of the positive electrode when being used. Other components of the S,O-containing coating differ variously depending on such as the composition of the negative electrode and components other than sulfur and oxygen contained in the electrolytic solution. In addition, the content ratio of the S,O-containing coating is not particularly limited as long as the S,O-containing coating includes the S═O structure. Furthermore, components other than those of the S═O structure and the amount thereof included in the S,O-containing coating are not particularly limited. The S,O-containing coating may be formed only on the surface of the negative electrode or may be formed only on the surface of the positive electrode. However, since the S,O-containing coating is thought to be derived from the anion of the metal salt contained in the electrolytic solution of the present invention, components derived from the anion of the metal salt is preferably contained in an amount more than other components. In addition, the S,O-containing coating is preferably formed on both the surface of the negative electrode and the surface of the positive electrode. Hereinafter, if necessary, an S,O-containing coating formed on the surface of the negative electrode is referred to as a negative-electrode S,O-containing coating, and an S,O-containing coating formed on the surface of the positive electrode is referred to as a positive-electrode S,O-containing coating.

As described above, an imide salt is preferably used as the metal salt in the electrolytic solution of the present invention. A technology of adding an imide salt to an electrolytic solution has been known conventionally, and, in a nonaqueous electrolyte secondary battery using this type of electrolytic solution, a coating on the positive electrode and/or the negative electrode is known to include a compound derived from the imide salt, i.e., a compound including S, in addition to compounds derived from a degradation product of the organic solvent of the electrolytic solution. For example, in JP2013145732 (A), an imide salt derived component contained in one part of the coating is described as to be able to suppress an increase in internal resistance of the nonaqueous electrolyte secondary battery while improving durability of the nonaqueous electrolyte secondary battery.

However, in the conventional art described above, the imide salt derived component cannot be increased in concentration in the coating because of the following reasons. First, when graphite is used as the negative electrode active material, formation of the SEI coating on the surface of the negative electrode is thought to be necessary in order to enable graphite to reversibly react with a charge carrier for reversible charging and discharging of the nonaqueous electrolyte secondary battery. Conventionally, in order to form the SEI coating, a cyclic carbonate compound represented by EC has been used as an organic solvent for the electrolytic solution. The SEI coating was formed from a degradation product of the cyclic carbonate compound. In other words, a conventional electrolytic solution containing the imide salt contained the imide salt as an additive, in addition to containing a large amount of a cyclic carbonate such as EC as the organic solvent . However, in this case, the main component of the SEI coating is a component derived from the organic solvent, and increasing the contained amount of the imide salt in the SEI coating has been difficult. Furthermore, when the imide salt is to be used not as an additive but as a metal salt (i.e., electrolyte salt, supporting salt), consideration of the combination with a current collector for the positive electrode had been necessary. More specifically, the imide salt is known to corrode an aluminum current collector that is used commonly as a current collector for the positive electrode. Thus, particularly when a positive electrode that operates at a potential of about 4 V is used, an electrolytic solution using, as an electrolyte salt, LiPF₆ or the like that forms a passive state together with aluminum needs to coexist with the aluminum current collector. In addition, in a conventional electrolytic solution, the total concentration of electrolyte salts including LiPF₆ and the imide salt, etc., is considered to be optimum at about 1 mol/L to 2 mol/L from a standpoint of ionic conductivity and viscosity (JP2013145732 (A)). Accordingly, when LiPF₆ is added at a sufficient amount, the added amount of the imide salt is inevitably reduced. Thus, a problem has existed regarding the difficultly in using the imide salt in a large amount as the metal salt for the electrolytic solution. Hereinafter, the imide salt may be sometimes abbreviated simply as a metal salt if necessary.

On the other hand, the electrolytic solution of the present invention contains the metal salt at a high concentration. As described later, in the electrolytic solution of the present invention, the metal salt is thought to exist in a state completely different from that of a conventional one. Thus, in the electrolytic solution of the present invention, unlike a conventional electrolytic solution, the problem derived from containing the metal salt at a high concentration is not likely to occur. For example, with the electrolytic solution of the present invention, deterioration in input-output performance of the nonaqueous electrolyte secondary battery due to increase in viscosity of the electrolytic solution is suppressed, and corrosion of the aluminum current collector is also suppressed. In addition, the metal salt contained in the electrolytic solution at a high concentration is preferentially reduced and degraded on the negative electrode. As a result, even without using a cyclic carbonate compound such as EC as the organic solvent, a SEI coating having a special structure derived from the metal salt, i.e., the S,O-containing coating, is formed on the negative electrode. Thus, the nonaqueous electrolyte secondary battery of the present invention undergoes reversible charging and discharging even when graphite is used as the negative electrode active material, without using a cyclic carbonate compound as the organic solvent.

Thus, the nonaqueous electrolyte secondary battery of the present invention undergoes reversible charging and discharging even when graphite is used as the negative electrode active material and the aluminum current collector is used as the positive electrode current collector, without using a cyclic carbonate compound as an organic solvent or using LiPF₆ as the metal salt. In addition, a large portion of the SEI coating on the surface of the negative electrode and/or the positive electrode is formed from components derived from the anion. As described later, the S,O-containing coating containing the components derived from the anion improves battery characteristics of the nonaqueous electrolyte secondary battery.

In a nonaqueous electrolyte secondary battery using a general electrolytic solution containing an EC solvent, the coating of the negative electrode largely includes a polymer structure resulting from polymerization of carbon derived from the EC solvent. On the other hand, in the nonaqueous electrolyte secondary battery of the present invention, the negative-electrode S,O-containing coating almost (or completely) does not include the polymer structure resulting from polymerization of carbon, and largely includes a structure derived from the anion of the metal salt. The same also applies for the positive-electrode coating.

The electrolytic solution of the present invention contains a cation of the metal salt at a high concentration. Thus, the distance between adjacent cations is extremely small within the electrolytic solution of the present invention. When a cation such as a lithium ion moves between a positive electrode and a negative electrode during charging and discharging of the nonaqueous electrolyte secondary battery, a cation located most closely to an electrode that is a movement destination is firstly supplied to the electrode. Then, to the place where the supplied cation had been located, another cation adjacent to the cation moves. Thus, in the electrolytic solution of the present invention, a domino toppling-like phenomenon is predicted to be occurring in which adjacent cations sequentially change their positions one by one toward an electrode that is a supply target . Because of that, the distance for which a cation moves during charging and discharging is thought to be short, and movement speed of the cation is thought to be high, accordingly. Because of this reason, the nonaqueous electrolyte secondary battery of the present invention having the electrolytic solution of the present invention is thought to have a high reaction rate. In addition, the nonaqueous electrolyte secondary battery of the present invention includes an S,O-containing coating on the electrode (i.e., the negative electrode and/or the positive electrode), and the S,O-containing coating is thought to largely include a cation in addition to including the S═O structure. The cation included in the S,O-containing coating is thought to be preferentially supplied to the electrode. Thus, in the nonaqueous electrolyte secondary battery of the present invention, transportation rate of the cation is thought to be further improved because of having an abundant source of cation (i.e., the S,O-containing coating) in the vicinity of the electrode. As a result, in the nonaqueous electrolyte secondary battery of the present invention, excellent battery characteristics are thought to be exerted because of a cooperation between the electrolytic solution of the present invention and the S,O-containing coating.

For reference, the SEI coating of the negative electrode is thought to be formed from deposits of the electrolytic solution generated when the electrolytic solution is reduced and degraded at a predetermined voltage or lower. Thus, in order to efficiently generate the S,O-containing coating on the surface of the negative electrode, the minimum value of the potential of the negative electrode in the nonaqueous electrolyte secondary battery of the present invention is preferably equal to or lower than the predetermined voltage. Specifically, when lithium is used as the counter electrode, the nonaqueous electrolyte secondary battery of the present invention is suitable as a battery used at a condition that causes the minimum value of the potential of the negative electrode to be equal to or lower than 1.3 V.

A usage maximum potential of the nonaqueous secondary battery according to the fourth mode of the present invention is not lower than 4.5 V when Li/Li⁺ is used for reference potential. Here, “usage maximum potential” refers to a positive electrode potential (Li/Li⁺ reference potential) at the end of charging of a battery controlled in a range so as not to cause breakdown of the positive electrode active material. The electrolytic solution used in the present invention is unlikely to degrade even at a high potential.

The reason for that is thought to be as described next. Regarding an intensity of a peak derived from the organic solvent in a vibrational spectroscopy spectrum of the electrolytic solution, the above described electrolytic solution satisfies Is>Io when an intensity of an original peak of the organic solvent is represented as Iₒ and an intensity of a peak resulting from shifting of the original peak of the organic solvent is represented as Is. In this electrolytic solution, almost the total amount of the organic solvent, and Li ions and anions in the metal salt are pulling each other through electrostatic attraction, and an extremely small amount of the solvent exists in a free state. A large amount of the organic solvent is forming a cluster with the metal salt and is stable energy wise. Thus, improvement in oxidation resistance is expected over a conventional electrolytic solution. As a result, degradation is thought to be unlikely to occur even at a high potential of not lower than 4.5 V. Thus, the usage maximum potential of the positive electrode of the battery may be set as high as not lower than 4.5 V.

Hence, a lithium metal complex oxide or a polyanion based material that undergo a charging reaction at a high potential is used as the positive electrode active material. For example, a lithium metal complex oxide whose average reaction potential is not lower than 4.5 V may be used as the positive electrode active material.

Furthermore, even with a lithium metal complex oxide whose average reaction potential is lower than 4.5 V, charging may be performed up to a potential of not lower than 4.5 V for usage.

From the reasons described above, by using a nonaqueous secondary battery obtained by combining the above described electrolytic solution and a lithium metal complex oxide or a polyanion based material, the usage maximum potential of the positive electrode may be set to not lower than 4.5 V, which is higher than that of a conventional one. Examples of the upper limit of the usage maximum potential of the positive electrode include 6.0 V or 5.7 V.

An oxidative degradation potential of the electrolytic solution described above is preferably not lower than 4.5 V when a Li⁺/Li electrode is used as reference. In this case, oxidative degradation of the electrolytic solution is suppressed also when the battery is used at a positive electrode potential as high as not lower than 4.5 V. Examples of the upper limit of the oxidative degradation potential of the electrolytic solution include 6.0 V or 5.7 V.

A current-potential curve, obtained from a linear sweep voltammetry (LSV) measurement performed on a battery including the above described electrolytic solution, platinum as the working electrode, and lithium metal as the counter electrode, preferably displays a rising part at a potential not lower than 4.5 V and further at a potential not lower than 5.0 V when a Li⁺/Li electrode is used for reference potential. An electrolytic solution having such a property is thought to not undergo oxidative degradation at least up to a potential of 4.5 V. LSV is an evaluation method of measuring current that flows when the potential of the electrode is changed continuously. By measuring LSV in the nonaqueous secondary battery, a potential-current curve of the nonaqueous secondary battery is obtained. Ina potential-current curve, a ratio of an increase level of current with respect to an increase level of potential is defined as a current increase rate. This increase rate is low immediately after voltage is applied. When a voltage up to a predetermined level of high potential is applied, oxidative degradation of the electrolytic solution occurs, causing the current increase rate to increase rapidly and the current to start flowing.

Thus, in a current-potential curve obtained by performing an LSV evaluation, a flat part is displayed from immediately after voltage application to a predetermined high potential of not lower than 4.5 V (vs Li⁺/Li). The electrolytic solution is stable when the potential is at the flat part.

In the current-potential curve, when the potential becomes larger than the predetermined level, a rising part in which the current increase rate rapidly increases is displayed. Here, a “rising part” refers to a part where the current increase rate is larger than the flat part in the current-potential curve. In the rising part, oxidative degradation of the electrolytic solution occurs, and current flows.

In the following, a nonaqueous secondary battery using the electrolytic solution according to the first to fourth modes of the present invention is described.

The nonaqueous secondary battery of the present invention includes a positive electrode including a positive electrode active material capable of occluding and releasing metal ions such as lithium ions, a negative electrode including a negative electrode active material capable of occluding and releasing metal ions such as lithium ions, and an electrolytic solution including a metal salt.

The positive electrode used in the nonaqueous secondary battery has a positive electrode active material capable of occluding and releasing metal ions. The positive electrode has a current collector and a positive electrode active material layer bound to the surface of the current collector.

In the first mode of the present invention, the positive electrode active material includes a lithium metal complex oxide with a layered rock salt structure. The lithium metal complex oxide with a layered rock salt structure is also referred to as a layer compound. Examples of the lithium metal complex oxide with a layered rock salt structure include those having general formula: LiₐNi_{b}Co_{c}Mn_{d}DₑO_{f} (0.2≦a≦1.2; b+c+d+e=1; 0≦e<1; D is at least one element selected from Li, Fe, Cr, Cu, Zn, Ca, Mg, S, Si, Na, K, Al, Zr, Ti, P, Ga, Ge, V, Mo, Nb, W, La, Ni, or Co;, 1.7≦f≦2.1) and Li₂MnO₃.

A ratio of b:c:d in the general formula may be at least one selected from 0.5:0.2:0.3, 1/3:1/3:1/3, 0.75:0.10:0.15, 0:0:1, 1:0:0, and 0:1:0.

More specifically, as a specific example, the lithium metal complex oxide with a layered rock salt structure is preferably at least one selected from LiNi_{0.5}Co_{0.2}Mn_{0.3}O₂, LiNi_{1/3}Co_{1/3}Mn_{1/3}O₂, LiNi_{0.5}Mn_{0.5}O₂, LiNi_{0.75}Co_{0.1}Mn_{0.15}O₂, LiMnO₂, LiNiO₂, and LiCoO₂.

In addition, the positive electrode active material may include a solid solution formed from a mixture of the lithium metal complex oxide with a layered rock salt structure and a spinel such as LiMn₂O₄ and Li₂Mn₂O₄, and is, for example, Li₂MnO₃—LiCoO₂.

Any metal oxide used as the positive electrode active material may have a basic composition of the composition formulae described above. Those in which a metal element included in the basic composition is substituted with another metal element may also be used. A metal oxide may also be obtained by adding another metal element such as Mg to the basic composition.

In the second mode of the present invention, the positive electrode active material has a lithium metal complex oxide having a spinel structure. The lithium metal complex oxide having the spinel structure may be represented by general formula: Liₓ(A_{y}Mn_{2-y})O₄ (“A” is at least one metal element selected from transition metal elements and at least one element selected from Ca, Mg, S, Si, Na, K, Al, P, Ga, and Ge, 0<x≦2.2, 0<y≦1). Transition metal elements included in “A” of the general formula are preferably, for example, at least one element selected from Fe, Cr, Cu, Zn, Zr, Ti, V, Mo, Nb, W, La, Ni, and Co.

As specific examples, the lithium metal complex oxide is preferably at least one selected from LiMn₂O₄ and LiNi_{0.5}Mn_{1.5}O₄.

The lithiummetal complex oxide used as the positive electrode active material may have a basic composition of the composition formulae described above. Those in which a metal element included in the basic composition is substituted with another metal element may also be used. A metal oxide may also be obtained by adding another metal element such as Mg to the basic composition.

In the third mode of the present invention, the positive electrode active material has a polyanion based material. The polyanion based material is preferably, for example, a polyanion based material including lithium. Examples of the polyanion based material including lithium include a polyanion based compound represented by LiMPO₄, LiMVO₄, or Li₂MSiO₄ (“M” inside of the formula is at least one selected from Co, Ni, Mn, and Fe).

As specific examples, the polyanion based material is preferably at least one selected from Li₂MnSiO₄, Li₂MnPO₄, Li₂CoPO₄, LiCoPO₄, Li₂FeSiO₄, and LiFePO₄ having an olivine structure.

The polyanion based material used for the positive electrode active material may have a basic composition of the composition formulae described above. Those in which a metal element included in the basic composition is substituted with another metal element may also be used. A metal oxide may also be obtained by adding another metal element such as Mg to the basic composition.

In the fourth mode of the present invention, the positive electrode active material preferably includes a lithium metal complex oxide and/or a polyanion based material.

The lithium metal complex oxide preferably has a spinel structure. The lithium metal complex oxide having the spinel structure may be represented by general formula: Liₓ(A_{y}Mn_{2-y}) O₄ (“A” is at least one element selected from transition metal elements, Ca, Mg, S, Si, Na, K, Al, P, Ga, and Ge, 0<x≦2.2, 0<y≦1). Transition metal elements included in “A” of the general formula are preferably, for example, at least one element selected from Fe, Cr, Cu, Zn, Zr, Ti, V, Mo, Nb, W, La, Ni, and Co. As specific examples, the lithium metal complex oxide is preferably at least one selected from a group consisting of LiMn₂O₄ and LiNi_{0.5}Mn_{1.5}O₄.

The lithium metal complex oxide may be one having the spinel structure, or, instead of the spinel structure, one having a layered rock salt structure. The lithium metal complex oxide with a layered rock salt structure is also referred to as a layer compound. Examples of the lithium metal complex oxide with a layered rock salt structure include those having general formula: LiₐNi_{b}Co_{c}Mn_{d}DₑO_{f} (0.2≦a≦1.2, b+c+d+e=1, 0≦e<1, “D” is at least one element selected from Li, Fe, Cr, Cu, Zn, Ca, Mg, S, Si, Na, K, Al, Zr, Ti, P, Ga, Ge, V, Mo, Nb, W, La, Ni, and Co, 1.7≦f≦2.1) and Li₂MnO₃.

In addition, the lithium metal complex oxide may include a solid solution formed from a mixture of one with a layered rock salt structure and a spinel such as LiMn₂O₄ and LiNi_{0.5}Mn_{1.5}O₄.

The polyanion based material is preferably, for example, a polyanion based material including lithium. Examples of the polyanion based material including lithium include a polyanion based compound represented by LiMPO₄, LiMVO₄, or Li₂MSiO₄ (“M” inside of the formula is at least one selected from Co, Ni, Mn, and Fe).

Among the positive electrode active materials described above, the lithium metal complex oxide and/or the polyanion based material preferably has a reaction potential of not lower than 4.5 V when a Li⁺/Li electrode is used as a reference. Here, “reaction potential of the positive electrode active material” refers to a potential that causes reductive reaction of the positive electrode active material through charging. The reaction potential is based on a Li⁺/Li electrode. The reaction potential varies within some range. “Reaction potential” in the present application refers to an average value of reaction potentials in the range, and, when multiple levels of the reaction potentials exist, refers to an average value of the multiple levels of the reaction potentials. Examples of the lithium metal complex oxide and the polyanion based material whose reaction potentials are not lower than 4.5 V when a Li⁺/Li electrode is used as reference include, but not limited to, LiNi_{0.5}Mn_{1.5}O₄ (spinel), LiCoPO₄ (polyanion), Li₂CoPO₄F (polyanion), Li₂MnO₃—LiMO₂ (“M” inside of the formula is selected from at least one of Co, Ni, Mn, and Fe) (solid solution-based with a layered rock salt structure), and Li₂MnSiO₄ (polyanion).

The lithium metal complex oxide and the polyanion based material may have a reaction potential lower than 4.5 V when a Li⁺/Li electrode is used as reference . Examples of the lithium metal complex oxide include, for those having a layered rock salt structure, at least one selected from LiNi_{0.5}Co_{0.2}Mn_{0.3}O₂, LiNi_{1/3}Co_{1/3}Mn_{1/3}O₂, LiNi_{0.5}Mn_{0.5}O₂, LiNi_{0.75}C_{0.1}Mn_{0.15}O₂, LiMnO₂, LiNiO₂, and LiCoO₂. Examples of the polyanion based material include, but not limited to, at least one selected from Li₂FeSiO₄ and LiFePO₄ having an olivine structure.

The characteristics of the positive electrode active materials described above, and batteries using those classified into the types shown in Table 3 are described.

FIG. 92 shows a model illustration of charging curves of the lithium metal complex oxide and the polyanion based material. As shown in FIG. 92, with respect to the lithium metal complex oxide, a solid solution type and a two-phase coexistence type exist. The solid solution type refers to those in which reaction of an active material goes through a solid solution state, and in which the positive electrode potential gradually decreases as discharging progresses and the potential gradually increases as charging progresses. The two-phase coexistence type refers to those in which a second phase appears when the active material is discharged to cause coexistence of two phases, and which display a range where the positive electrode potential does not decrease even when discharging progresses and a range where the potential does not increase even when charging progresses.

In a battery using a solid solution type 4 V-class active material (LiCoO₂, etc.), when the maximum usage potential is set at 5 V, an average cell voltage and a capacity slightly improve. However, generally, an active material itself sometimes deteriorates due to high potential.

In a battery using a two-phase coexistence type 4 V-class active material (LMn₂O₄, etc.), when the maximum usage potential is set at 5 V, an average cell voltage and a capacity hardly change. However, generally, since the high potential resistance of the active material itself is high, the maximum usage potential may be increased up to 5 V.

In a battery using a two-phase coexistence type 5 V-class active material (LiNi_{0.5}Mn_{1.5}O₄, etc.), although capacity cannot be obtained when the maximum usage potential is set at 4 V, capacity is obtained at 5 V.

The positive electrodes and the electrolytic solution of the present invention may be combined freely by taking these properties into account.

TABLE 3

| Classification | | | |
|---|---|---|---|
| by Average | | | |
| reaction | | | |
| potential | Reaction | Crystal | Representative |
| (Li reference) | type | type | examples |
| 3.5 V-class | Two-phase | Polyanion | LiFePO₄ |
| | coexistence | | |
| | type | | |
| 4 V-class | Two-phase | Spinel | LiMn₂O₄ |
| | coexistence | | |
| | type | | |
| | Two-phase | Polyanion | LiMnPO₄ |
| | coexistence | | |
| | type | | |
| | Solid | Layered | LiCoO₂, LiNiO₂, |
| | solution | rock salt | Li (Ni_{1/3}Mn_{1/3}CO_{1/3})O₂ |
| | type | | |
| 5 V-class | Two-phase | Polyanion | LiCoPO₄ |
| | coexistence | | |
| | type | | |
| | Two-phase | Spinel | LiNi_{0.5}Mn_{1.5}O₄ |
| | coexistence | | |
| | type | | |

The lithium metal complex oxide used for the positive electrode active material may have a basic composition of the composition formulae described above. Those in which a metal element included in the basic composition is substituted with another metal element may also be used. A metal oxide may also be obtained by adding another metal element such as Mg to the basic composition.

Base on above, the nonaqueous secondary battery of the present invention is understood as a nonaqueous secondary battery including a positive electrode having the lithium metal complex oxide or the polyanion based material as the positive electrode active material, a negative electrode having the negative electrode active material, and an electrolytic solution, wherein: the electrolytic solution contains a metal salt whose cation is an alkali metal, an alkaline earth metal, or aluminum, and an organic solvent having a heteroelement; and regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is.

In the first to fourth modes of the present invention, the current collector of the positive electrode is not particularly limited as long as the current collector is a metal capable of withstanding a voltage suited for the active material that is used. The current collector refers to a fine electron conductor that is chemically inert for continuously sending a flow of current to the electrode during discharging or charging of the nonaqueous secondary battery. Examples of the current collector include at least one selected from silver, copper, gold, aluminum, tungsten, cobalt, zinc, nickel, iron, platinum, tin, indium, titanium, ruthenium, tantalum, chromium, or molybdenum, and metal materials such as stainless steel.

Specifically, one formed from aluminum or an aluminum alloy is preferably used as the positive electrode current collector. Here, aluminum refers to pure aluminum, and an aluminum whose purity is equal to or higher than 99.0% is referred to as pure aluminum. An alloy obtained by adding various elements to pure aluminum is referred as an aluminum alloy . Examples of the aluminum alloy include those that are Al—Cu based, Al—Mn based, Al—Fe based, Al—Si based, Al—Mg based, AL-Mg—Si based, and Al—Zn—Mg based.

In addition, specific examples of aluminum or the aluminum alloy include A1000 series alloys (pure aluminum based) such as JIS A1085, A1N30, etc., A3000 series alloys (Al-Mn based) such as JIS A3003, A3004, etc., and A8000 series alloys (Al-Fe based) such as JIS A8079, A8021, etc.

When the potential of the positive electrode is set to not lower than 4 V using lithium as reference, aluminum is preferably used as the current collector. The current collector may be coated with a protective layer known in the art. One obtained by treating the surface of the current collector with a method known in the art may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, its thickness is preferably within a range of 1 pm to 100 μm.

The positive electrode active material layer includes a positive electrode active material, and, if necessary, a binding agent and/or a conductive additive.

The binding agent serves a role of fastening the active material and the conductive additive to the surface of the current collector.

Examples of the binding agent include fluorine-containing resins such as polyvinylidene fluoride, polytetrafluoroethylene, and fluororubbers, thermoplastic resins such as polypropylene and polyethylene, imide based resins such as polyimide and polyamide-imide, and alkoxysilyl group-containing resins.

In addition, a polymer having a hydrophilic group may be used as the binding agent. Examples of the hydrophilic group of the polymer having the hydrophilic group include carboxyl group, sulfo group, silanol group, amino group, hydroxyl group, and phosphoric acid based group such as phosphoric acid group. Among those described above, a polymer including a carboxyl group in its molecule, such as polyacrylic acid (PAA), carboxymethyl cellulose (CMC), and polymethacrylic acid, and a polymer including a sulfo group such as poly(p-styrenesulfonic acid) are preferable.

A polymer including a large number of carboxyl groups and/or sulfo groups, such as polyacrylic acid or a copolymer of acrylic acid and vinylsulfonic acid, is water soluble. Thus, the polymer including the hydrophilic group is preferably a water-soluble polymer, and is preferably a polymer including multiple carboxyl groups and/or sulfo groups in its one molecule.

A polymer including a carboxyl group in its molecule is produced through a method of such as, for example, polymerizing an acid monomer, or imparting a carboxyl group to a polymer. Examples of the acid monomer include acid monomers having one carboxyl group in respective molecules such as acrylic acid, methacrylic acid, vinylbenzoic acid, crotonic acid, pentenoic acid, angelic acid, and tiglic acid, and acid monomers having two or more carboxyl groups in respective molecules such as itaconic acid, mesaconic acid, citraconic acid, fumaric acid, maleic acid, 2-pentenedioic acid, methylenesuccinic acid, allylmalonic acid, isopropylidene succinic acid, 2,4-hexadienedioic acid, and acetylene dicarboxylic acid. A copolymer obtained through polymerization of two or more types of monomers selected from those described above may be used.

For example, as disclosed in JP2013065493 (A), a polymer that is formed of a copolymer of acrylic acid and itaconic acid and that includes, in its molecule, an acid anhydride group formed through condensation of carboxyl groups is preferably used as the binding agent. By having a structure derived from a monomer with high acidity by having two or more carboxyl groups in a single molecule, metal ions such as lithium ions are thought to be easily trapped before degradative reaction of the electrolytic solution occurs during charging. Furthermore, the acidity does not rise excessively since, as the acidity rises when more carboxyl groups exist compared to polyacrylic acid and polymethacrylic acid, a certain amount of the carboxyl groups change into acid anhydride groups. Thus, a secondary battery having a negative electrode formed using the binding agent has improved initial efficiency and input-output characteristics.

The blending ratio of the binding agent in the positive electrode active material layer in mass ratio is preferably positive electrode active material:binding agent=1:0.005 to 1:0.5, and further preferably positive electrode active material:binding agent=1:0.005 to 1:0.3. The reason is that when too little of the binding agent is contained, moldability of the electrode deteriorates, whereas when too much of the binding agent is contained, energy density of the electrode becomes low.

The conductive additive is added for increasing conductivity of the electrode. Thus, the conductive additive is preferably added optionally when conductivity of an electrode is insufficient, and does not have to be added when conductivity of an electrode is sufficiently superior. As the conductive additive, a fine electron conductor that is chemically inert may be used, and examples thereof include carbonaceous fine particles such as carbon black, graphite, acetylene black, Ketchen black (Registered Trademark), and vapor grown carbon fiber (VGCF), and various metal particles. With regard to the conductive additive described above, a single type by itself, or a combination of two or more types may be added to the active material layer.

The blending ratio of the binding agent in the positive electrode active material layer is preferably, inmass ratio, positive electrode active material : binding agent=1:0.05 to 1:0.5. The reason is that when too little of the binding agent is contained, moldability of the electrode deteriorates, whereas when too much of the binding agent is contained, energy density of the electrode becomes low.

The negative electrode used in the nonaqueous secondary battery of the present invention includes a current collector, and a negative electrode active material layer bound to the surface of the current collector. The negative electrode active material layer includes a negative electrode active material, and, if necessary, a binding agent and/or a conductive additive. The binding agent and the conductive additive that are sometimes included in the negative electrode active material layer may include similar components and have a similar composition ratio as the binding agent and the conductive additive that are sometimes included in the positive electrode active material layer.

As the negative electrode active material, materials capable of occluding and releasing metal ions such as lithium ions are used. No particular limitation exists as long as the negative electrode active material is an elemental substance, an alloy, or a compound capable of occluding and releasing metal ions such as lithium ions. For example, respective elemental substances of Li, group 14 elements such as carbon, silicon, germanium, and tin, group 13 elements such as aluminum and indium, group 12 elements such as zinc and cadmium, group 15 elements such as antimony and bismuth, alkaline earth metals such as magnesium and calcium, and group 11 elements such as silver and gold may be used as the negative electrode active material. When silicon or the like is used as the negative electrode active material, a high capacity active material is obtained since a single silicon atom reacts with multiple lithium atoms. However, a fear of occurrence of a problem exists regarding a significant expansion and contraction of volume associated with occlusion and release of lithium. Thus, in order to mitigate the fear, an alloy or a compound obtained by combining an elemental substance of silicon or the like with another element such as a transition metal is suitably used as the negative electrode active material. Specific examples of the alloy or the compound include tin based materials such as Ag—Sn alloys, Cu—Sn alloys, and Co—Sn alloys, carbon based materials such as various graphites, silicon basedmaterials such as SiOₓ (0.3≦x≦1.6) that undergoes disproportionation into the elemental substance silicon and silicon dioxide, and a complex obtained by combining a carbon based material with elemental substance silicon or a silicon based material. In addition, as the negative electrode active material, an oxide such as Nb₂O₅, TiO₂, Li₄Ti₅O₁₂, WO₂, MoO₂, and Fe₂O₃, or a nitride represented by Li₃₋ₓMₓN(M=Co, Ni, Cu) may be used. With regard to the negative electrode active material, one or more types described above may be used. In the present application, a nonaqueous secondary battery using a material capable of occluding and releasing lithium ions as the negative electrode active material and the positive electrode active material is referred to as a lithium ion secondary battery.

The current collector of the negative electrode is not particularly limited as long as the current collector is a metal capable of withstanding a voltage suited for the active material that is used, and, for example, one described as the current collector of the positive electrode may be used. Regarding the binding agent and the conductive additive of the negative electrode, those described in relation to the positive electrode may be used.

Regarding a method for forming the active material layer on the surface of the current collector, the active material may be applied on the surface of the current collector using a conventional method known in the art such as roll coating method, die coating method, dip coating method, doctor blade method, spray coating method, and curtain coating method. Specifically, an active material layer forming composition including the active material and, if necessary, the binding agent and the conductive additive are prepared, and, after adding a suitable solvent to this composition to obtain a paste, the paste is applied on the surface of the current collector and then dried. Examples of the solvent include N-methyl-2-pyrrolidone, methanol, methyl isobutyl ketone, and water. In order to increase electrode density, compression may be performed after drying.

A separator is used in the nonaqueous secondary battery, if necessary. The separator is for separating the positive electrode and the negative electrode to allow passage of metal ions such as lithium ions while preventing short circuiting of current due to a contact of both electrodes. Examples of the separator include porous materials, nonwoven fabrics, and woven fabrics using one or more types of materials having electrical insulation property such as: synthetic resins such as polytetrafluoroethylene, polypropylene, polyethylene, polyimide, polyamide, polyaramide (aromatic polyamide), polyester, and polyacrylonitrile; polysaccharides such as cellulose and amylose; natural polymers such as fibroin, keratin, lignin, and suberin; and ceramics. In addition, the separator may have a multilayer structure. Since the electrolytic solution has a high polarity and a slightly high viscosity, a film easily impregnated with a polar solvent such as water is preferable. Specifically, a film in which 90% or more of gaps existing therein are impregnated with a polar solvent such as water is preferable.

An electrode assembly is formed from the positive electrode, the negative electrode, and, if necessary, the separator interposed therebetween. The electrode assembly may be a laminated type obtained by stacking the positive electrode, the separator, and the negative electrode, or a wound type obtained by winding the positive electrode, the separator, and the negative electrode. The nonaqueous secondary battery is preferably formed by connecting, using current collecting leads or the like, the current collectors of the positive electrode and the negative electrode with a positive electrode terminal and a negative electrode terminal located externally, and adding the electrolytic solution to the electrode assembly. In addition, the nonaqueous secondary battery of the present invention preferably executes charging and discharging at a voltage range suitable for the types of active materials included in the electrodes.

The form of the nonaqueous secondary battery of the present invention is not particularly limited, and various forms such as a cylindrical type, square type, a coin type, and a laminated type, etc., are used.

The nonaqueous secondary battery of the present invention may be mounted on a vehicle. The vehicle may be a vehicle that uses, as all or one portion of the source of power, electrical energy obtained from the nonaqueous secondary battery, and examples thereof include electric vehicles and hybrid vehicles. When the nonaqueous secondary battery is to be mounted on the vehicle, a plurality of the nonaqueous secondary batteries may be connected in series to form an assembled battery. Other than the vehicles, examples of the nonaqueous secondary battery include various home appliances, office instruments, and industrial instruments driven by a battery such as personal computers and portable communication devices. In addition, the nonaqueous secondary battery of the present invention may be used as power storage devices and power smoothing devices for wind power generation, photovoltaic power generation, hydroelectric power generation, and other power systems, power supply sources for auxiliary machineries and/or power of ships, etc., power supply sources for auxiliary machineries and/or power of aircraft and spacecraft, etc., auxiliary power supply for vehicles that do not use electricity as a source of power, power supply for movable household robots, power supply for system backup, power supply for uninterruptible power supply devices, and power storage devices for temporarily storing power required for charging at charge stations for electric vehicles.

Although the embodiments of the electrolytic solution have been described above, the present invention is not limited to the embodiments. Without departing from the gist of the present invention, the present invention can be implemented in various modes with modifications and improvements, etc., that can be made by a person skilled in the art.

### EXAMPLES

In the following, the present invention is described specifically by presenting Examples and Comparative Examples. In the following, Examples, Comparative Examples, and batteries, and Evaluation Examples for evaluating those are represented as: “Example A-number,” “Comparative Example A-number,” “battery A-number,” and “Evaluation Example A-number” for those according to the first mode of the present invention; “Example B-number,” “Comparative Example B-number,” “battery B-number,” and “Evaluation Example B-number” for those according to the second mode of the present invention; “Example C-number,” “Comparative Example C-number,” “battery C-number,” and “Evaluation Example C-number” for those according to the third mode of the present invention; and “Example D-number,” “Comparative Example D-number,” “battery D-number,” and “Evaluation Example D-number” for those according to the fourth mode of the present invention. Electrolytic solutions, batteries, and Evaluation Examples not given “A-, ” “B-,” “C-,” or “D-” are common in the first to fourth modes.

The present invention is not limited to these Examples. Hereinafter, unless mentioned otherwise in particular, “part(s)” refers to part(s) by mass, and “%” refers to mass %.

(Electrolytic Solution E1)

An electrolytic solution used in the present invention was produced in the following manner.

Approximately 5 mL of 1,2-dimethoxyethane, which is an organic solvent, was placed in a flask including a stirring bar and a thermometer. Under a stirring condition, with respect to 1,2-dimethoxyethane in the flask, (CF₃SO₂)₂NLi, which is a lithium salt, was gradually added so as to maintain a solution temperature equal to or lower than 40° C. to be dissolved. Since dissolving of (CF₃SO₂)₂NLi momentarily stagnated at a time point when approximately 13 g of (CF₃SO₂)₂NLi was added, the flask was heated by placing the flask in a temperature controlled bath such that the solution temperature in the flask reaches 50° C. to dissolve (CF₃SO₂)₂NLi. Since dissolving of (CF₃SO₂)₂NLi stagnated again at a time point when approximately 15 g of (CF₃SO₂)₂NLi was added, a single drop of 1,2-dimethoxyethane was added thereto using a pipette to dissolve (CF₃SO₂)₂NLi. Furthermore, (CF₃SO₂)₂NLi was gradually added to accomplish adding an entire predetermined amount of (CF₃SO₂)₂NLi. The obtained electrolytic solution was transferred to a 20-mL measuring flask, and 1,2-dimethoxyethane was added thereto until a volume of 20 mL was obtained. This was used as electrolytic solution E1. The volume of the obtained electrolytic solution was 20 mL, and 18.38 g of (CF₃SO₂)₂NLi was contained in the electrolytic solution. The concentration of (CF₃SO₂)₂NLi in electrolytic solution E1 was 3.2 mol/L. In electrolytic solution E1, 1.6 molecules of 1,2-dimethoxyethane were contained with respect to 1 molecule of (CF₃SO₂)₂NLi. The production was performed within a glovebox under an inert gas atmosphere.

(Electrolytic Solution E2)

With a method similar to that of electrolytic solution E1, electrolytic solution E2 whose concentration of (CF₃SO₂)₂NLi was 2.8 mol/L was produced using 16.08 g of (CF₃SO₂)₂NLi. In electrolytic solution E2, 2.1 molecules of 1,2-dimethoxyethane were contained with respect to 1 molecule of (CF₃SO₂)₂NLi.

(Electrolytic Solution E3)

Approximately 5 mL of acetonitrile, which is an organic solvent, was placed in a flask including a stirring bar. Under a stirring condition, with respect to acetonitrile in the flask, (CF₃SO₂)₂NLi, which is a lithium salt, was gradually added to be dissolved. A total amount of 19.52 g of (CF₃SO₂)₂NLi was added to the flask, and stirring was performed overnight in the flask. The obtained electrolytic solution was transferred to a 20-mL measuring flask, and acetonitrile was added thereto until a volume of 20 mL was obtained. This was used as electrolytic solution E3. The production was performed within a glovebox under an inert gas atmosphere.

The concentration of (CF₃SO₂)₂NLi in electrolytic solution E3 was 3.4 mol/L. In electrolytic solution E3, 3 molecules of acetonitrile were contained with respect to 1 molecule of (CF₃SO₂)₂NLi.

(Electrolytic Solution E4)

With a method similar to that of electrolytic solution E3, electrolytic solution E4 whose concentration of (CF₃SO₂)₂NLi was 4.2 mol/L was produced using 24.11 g of (CF₃SO₂)₂NLi. In electrolytic solution E4, 1.9 molecules of acetonitrile were contained with respect to 1 molecule of (CF₃SO₂)₂NLi.

(Electrolytic Solution E5)

Electrolytic solution E5 whose concentration of (FSO₂)₂NLi was 3.6 mol/L was produced with a method similar to that of electrolytic solution E3 except for using 13.47 g of (FSO₂)₂NLi as the lithium salt and 1,2-dimethoxyethane as the organic solvent. In electrolytic solution E5, 1.9 molecules of 1,2-dimethoxyethane were contained with respect to 1 molecule of (FSO₂)₂NLi.

(Electrolytic Solution E6)

With a method similar to that of electrolytic solution E5, electrolytic solution E6 whose concentration of (FSO₂)₂NLi was 4.0 mol/L was produced using 14.97 g of (FSO₂)₂NLi. In electrolytic solution E6, 1.5 molecules of 1,2-dimethoxyethane were contained with respect to 1 molecule of (FSO₂)₂NLi.

(Electrolytic Solution E7)

Electrolytic solution E7 whose concentration of (FSO₂)₂NLi was 4.2 mol/L was produced with a method similar to that of electrolytic solution E3 except for using 15.72 g of (FSO₂)₂NLi as the lithium salt. In electrolytic solution E7, 3 molecules of acetonitrile were contained with respect to 1 molecule of (FSO₂)₂NLi.

(Electrolytic Solution E8)

With a method similar to that of electrolytic solution E7, electrolytic solution E8 whose concentration of (FSO₂)₂NLi was 4.5 mol/L was produced using 16.83 g of (FSO₂)₂NLi. In electrolytic solution E8, 2.4 molecules of acetonitrile were contained with respect to 1 molecule of (FSO₂)₂NLi.

(Electrolytic Solution E9)

With a method similar to that of electrolytic solution E7, electrolytic solution E9 whose concentration of (FSO₂)₂NLi was 5.0 mol/L was produced using 18.71 g of (FSO₂)₂NLi. In electrolytic solution E9, 2.1 molecules of acetonitrile were contained with respect to 1 molecule of (FSO₂)₂NLi.

(Electrolytic Solution E10)

With a method similar to that of electrolytic solution E7, electrolytic solution E10 whose concentration of (FSO₂)₂NLi was 5.4 mol/L was produced using 20.21 g of (FSO₂)₂NLi. In electrolytic solution E10, 2 molecules of acetonitrile were contained with respect to 1 molecule of (FSO₂)₂NLi.

(Electrolytic Solution E11)

Approximately 5 mL of dimethyl carbonate, which is an organic solvent, was placed in a flask including a stirring bar. Under a stirring condition, with respect to dimethyl carbonate in the flask, (FSO₂)₂NLi, which is a lithium salt, was gradually added to be dissolved. A total amount of 14.64 g of (FSO₂)₂NLi was added to the flask, and stirring was performed overnight in the flask. The obtained electrolytic solution was transferred to a 20-mL measuring flask, and dimethyl carbonate was added thereto until a volume of 20 mL was obtained. This was used as electrolytic solution E11. The production was performed within a glovebox under an inert gas atmosphere.

The concentration of (FSO₂)₂NLi in electrolytic solution E11 was 3.9 mol/L. In electrolytic solution E11, 2 molecules of dimethyl carbonate were contained with respect to 1 molecule of (FSO₂)₂NLi.

(Electrolytic Solution E12)

Electrolytic solution E12 whose concentration of (FSO₂)₂NLi was 3.4 mol/L was obtained by adding dimethyl carbonate to, and thereby diluting, electrolytic solution E11. In electrolytic solution E12, 2.5 molecules of dimethyl carbonate were contained with respect to 1 molecule of (FSO₂)₂NLi.

(Electrolytic Solution E13)

Electrolytic solution E13 whose concentration of (FSO₂)₂NLi was 2.9 mol/L was obtained by adding dimethyl carbonate to, and thereby diluting, electrolytic solution Eli. In electrolytic solution E13, 3 molecules of dimethyl carbonate were contained with respect to 1 molecule of (FSO₂)₂NLi.

(Electrolytic Solution E14)

Electrolytic solution E14 whose concentration of (FSO₂)₂NLi was 2.6 mol/L was obtained by adding dimethyl carbonate to, and thereby diluting, electrolytic solution E11. In electrolytic solution E14, 3.5 molecules of dimethyl carbonate were contained with respect to 1 molecule of (FSO₂)₂NLi.

(Electrolytic Solution E15)

Electrolytic solution E15 whose concentration of (FSO₂)₂NLi was 2.0 mol/L was obtained by adding dimethyl carbonate to, and thereby diluting, electrolytic solution E11. In electrolytic solution E15, 5 molecules of dimethyl carbonate were contained with respect to 1 molecule of (FSO₂)₂NLi.

(Electrolytic Solution E16)

Approximately 5 mL of ethyl methyl carbonate, which is an organic solvent, was placed in a flask including a stirring bar. Under a stirring condition, with respect to ethyl methyl carbonate in the flask, (FSO₂)₂NLi, which is a lithium salt, was gradually added to be dissolved. A total amount of 12.81 g of (FSO₂)₂NLi was added to the flask, and stirring was performed overnight in the flask. The obtained electrolytic solution was transferred to a 20-mL measuring flask, and ethyl methyl carbonate was added thereto until a volume of 20 mL was obtained. This was used as electrolytic solution E16. The production was performed within a glovebox under an inert gas atmosphere.

The concentration of (FSO₂)₂NLi in electrolytic solution E16 was 3.4 mol/L. In electrolytic solution E16, 2 molecules of ethyl methyl carbonate were contained with respect to 1 molecule of (FSO₂)₂NLi.

(Electrolytic Solution E17)

Electrolytic solution E17 whose concentration of (FSO₂)₂NLi was 2.9 mol/L was obtained by adding ethyl methyl carbonate to, and thereby diluting, electrolytic solution E16. In electrolytic solution E17, 2.5 molecules of ethyl methyl carbonate were contained with respect to 1 molecule of (FSO₂)₂NLi.

(Electrolytic Solution E18)

Electrolytic solution E18 whose concentration of (FSO₂)₂NLi was 2.2 mol/L was obtained by adding ethyl methyl carbonate to, and thereby diluting, electrolytic solution E16. In electrolytic solution E18, 3.5 molecules of ethyl methyl carbonate were contained with respect to 1 molecule of (FSO₂)₂NLi.

(Electrolytic Solution E19)

Approximately 5 mL of diethyl carbonate, which is an organic solvent, was placed in a flask including a stirring bar. Under a stirring condition, with respect to diethyl carbonate in the flask, (FSO₂)₂NLi, which is a lithium salt, was gradually added to be dissolved. A total amount of 11.37 g of (FSO₂)₂NLi was added to the flask, and stirring was performed overnight in the flask. The obtained electrolytic solution was transferred to a 20-mL measuring flask, and diethyl carbonate was added thereto until a volume of 20 mL was obtained. This was used as electrolytic solution E19. The production was performed within a glovebox under an inert gas atmosphere.

The concentration of (FSO₂)₂NLi in electrolytic solution E19 was 3.0 mol/L. In electrolytic solution E19, 2 molecules of diethyl carbonate were contained with respect to 1 molecule of (FSO₂)₂NLi.

(Electrolytic Solution E20)

Electrolytic solution E20 whose concentration of (FSO₂)₂NLi was 2.6 mol/L was obtained by adding diethyl carbonate to, and thereby diluting, electrolytic solution E19. In electrolytic solution E20, 2.5 molecules of diethyl carbonate were contained with respect to 1 molecule of (FSO₂)₂NLi.

(Electrolytic Solution E21)

Electrolytic solution E21 whose concentration of (FSO₂)₂NLi was 2.0 mol/L was obtained by adding diethyl carbonate to, and thereby diluting, electrolytic solution E19. In electrolytic solution E21, 3.5 molecules of diethyl carbonate were contained with respect to 1 molecule of (FSO₂)₂NLi.

(Electrolytic Solution C1)

Electrolytic solution Cl whose concentration of (CF₃SO₂)₂NLi was 1.0 mol/L was produced with a method similar to that of electrolytic solution E3, except for using 5.74 g of (CF₃SO₂)₂NLi and 1,2-dimethoxyethane as the organic solvent. In electrolytic solution C1, 8.3 molecules of 1,2-dimethoxyethane were contained with respect to 1 molecule of (CF₃SO₂)₂NLi.

(Electrolytic Solution C2)

With a method similar to that of electrolytic solution E3, electrolytic solution C2 whose concentration of (CF₃SO₂)₂NLi was 1.0 mol/L was produced using 5.74 g of (CF₃SO₂)₂NLi. In electrolytic solution C2, 16 molecules of acetonitrile were contained with respect to 1 molecule of (CF₃SO₂)₂NLi.

(Electrolytic Solution C3)

With a method similar to that of electrolytic solution E5, electrolytic solution C3 whose concentration of (FSO₂)₂NLi was 1.0 mol/L was produced using 3.74 g of (FSO₂)₂NLi. In electrolytic solution C3, 8.8 molecules of 1,2-dimethoxyethane were contained with respect to 1 molecule of (FSO₂)₂NLi.

(Electrolytic Solution C4)

With a method similar to that of electrolytic solution E7, electrolytic solution C4 whose concentration of (FSO₂)₂NLi was 1.0 mol/L was produced using 3.74 g of (FSO₂)₂NLi. In electrolytic solution C4, 17 molecules of acetonitrile were contained with respect to 1 molecule of (FSO₂)₂NLi.

(Electrolytic Solution C5)

Electrolytic solution C5 whose concentration of LiPF₆ was 1.0 mol/L was produced with a method similar to that of electrolytic solution E3 except for using a mixed solvent of ethylene carbonate and diethyl carbonate (volume ratio of 3:7; hereinafter, sometimes referred to as “EC/DEC”) as the organic solvent, and 3.04 g of LiPF₆ as the lithium salt.

(Electrolytic Solution C6)

Electrolytic solution C6 whose concentration of (FSO₂)₂NLi was 1.1 mol/L was obtained by adding dimethyl carbonate to, and thereby diluting, electrolytic solution E11. In electrolytic solution C6, 10 molecules of dimethyl carbonate were contained with respect to 1 molecule of (FSO₂)₂NLi.

(Electrolytic Solution C7)

Electrolytic solution C7 whose concentration of (FSO₂)₂NLi was 1.1 mol/L was obtained by adding ethyl methyl carbonate to, and thereby diluting, electrolytic solution E16. In electrolytic solution C7, 8 molecules of ethyl methyl carbonate were contained with respect to 1 molecule of (FSO₂)₂NLi.

(Electrolytic Solution C8)

Electrolytic solution C8 whose concentration of (FSO₂)₂NLi was 1.1 mol/L was obtained by adding diethyl carbonate to, and thereby diluting, electrolytic solution E19. In electrolytic solution C8, 7 molecules of diethyl carbonate were contained with respect to 1 molecule of (FSO₂)₂NLi.

Table 4 shows a list of electrolytic solutions E1 to E21 and C1 to C8.

TABLE 4

| | | | Lithium salt | Organic |
|---|---|---|---|---|
| | | Organic | concentration | solvent/Lithium |
| | Lithium salt | solvent | (mol/L) | salt (mol ratio) |
| Electrolytic | LiTFSA | DME | 3.2 | 1.6 |
| solution E1 | | | | |
| Electrolytic | LiTFSA | DME | 2.8 | 2.1 |
| solution E2 | | | | |
| Electrolytic | LiTFSA | AN | 3.4 | 3 |
| solution E3 | | | | |
| Electrolytic | LiTFSA | AN | 4.2 | 1.9 |
| solution E4 | | | | |
| Electrolytic | LiFSA | DME | 3.6 | 1.9 |
| solution E5 | | | | |
| Electrolytic | LiFSA | DME | 4.0 | 1.5 |
| solution E6 | | | | |
| Electrolytic | LiFSA | AN | 4.2 | 3 |
| solution E7 | | | | |
| Electrolytic | LiFSA | AN | 4.5 | 2.4 |
| solution E8 | | | | |
| Electrolytic | LiFSA | AN | 5.0 | 2.1 |
| solution E9 | | | | |
| Electrolytic | LiFSA | AN | 5.4 | 2 |
| solution E10 | | | | |
| Electrolytic | LiFSA | DMC | 3.9 | 2 |
| solution E11 | | | | |
| Electrolytic | LiFSA | DMC | 3.4 | 2.5 |
| solution E12 | | | | |
| Electrolytic | LiFSA | DMC | 2.9 | 3 |
| solution E13 | | | | |
| Electrolytic | LiFSA | DMC | 2.6 | 3.5 |
| solution E14 | | | | |
| Electrolytic | LiFSA | DMC | 2.0 | 5 |
| solution E15 | | | | |
| Electrolytic | LiFSA | EMC | 3.4 | 2 |
| solution E16 | | | | |
| Electrolytic | LiFSA | EMC | 2.9 | 2.5 |
| solution E17 | | | | |
| Electrolytic | LiFSA | EMC | 2.2 | 3.5 |
| solution E18 | | | | |
| Electrolytic | LiFSA | DEC | 3.0 | 2 |
| solution E19 | | | | |
| Electrolytic | LiFSA | DEC | 2.6 | 2.5 |
| solution E20 | | | | |
| Electrolytic | LiFSA | DEC | 2.0 | 3.5 |
| solution E21 | | | | |
| Electrolytic | LiTFSA | DME | 1.0 | 8.3 |
| solution C1 | | | | |
| Electrolytic | LiTFSA | AN | 1.0 | 16 |
| solution C2 | | | | |
| Electrolytic | LiFSA | DME | 1.0 | 8.8 |
| solution C3 | | | | |
| Electrolytic | LiFSA | AN | 1.0 | 17 |
| solution C4 | | | | |
| Electrolytic | LiPF₆ | EC/DEC | 1.0 | |
| solution C5 | | | | |
| Electrolytic | LiFSA | DMC | 1.1 | 10 |
| solution C6 | | | | |
| Electrolytic | LiFSA | EMC | 1.1 | 8 |
| solution C7 | | | | |
| Electrolytic | LiFSA | DEC | 1.1 | 7 |
| solution C8 | | | | |

LiTFSA: (CF₃SO₂)₂NLi,
LiFSA: (FSO₂)₂NLi,
AN: acetonitrile,
DME: 1,2-dimethoxyethane,
DMC: dimethyl carbonate,
EMC: ethyl methyl carbonate,
DEC: diethyl carbonate,
EC/DEC: Mixed solvent of ethylene carbonate and diethyl carbonate (volume ratio 3:7)

### Evaluation Example 1

### IR Measurement)

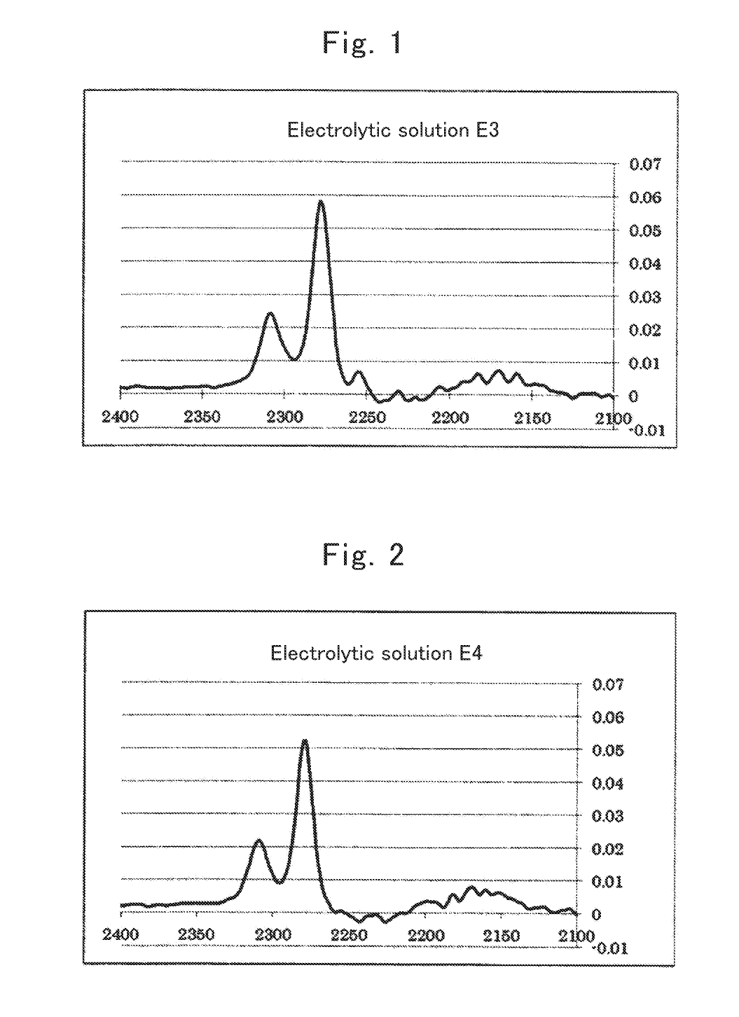

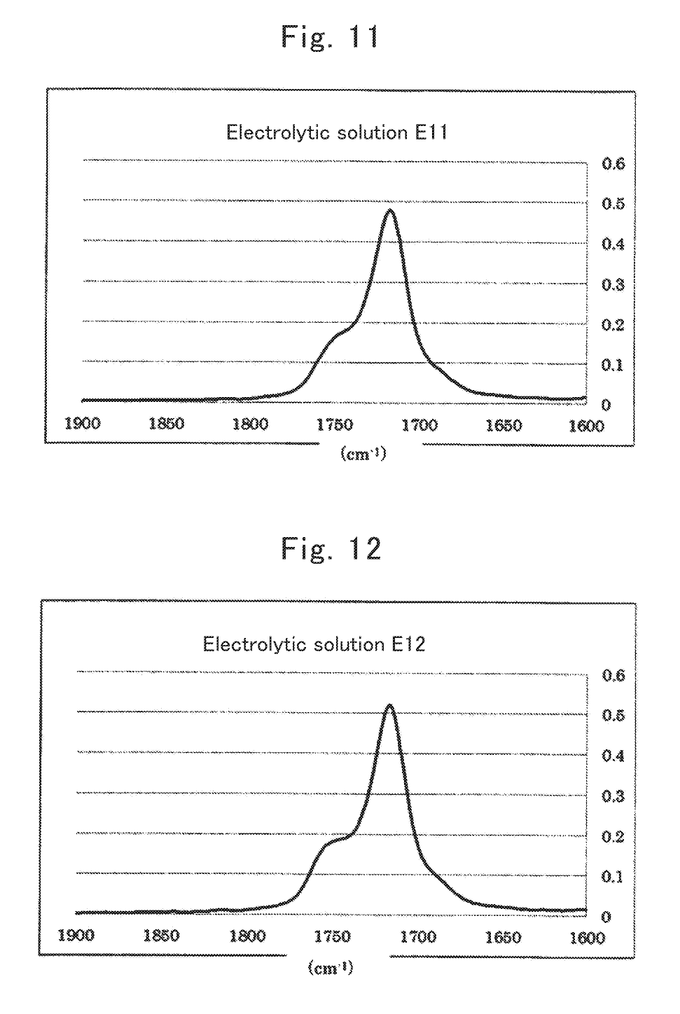

IR measurement was performed using the following conditions on electrolytic solutions E3, E4, E7, E8, E10, C2, and C4, acetonitrile, (CF₃SO₂)₂NLi, and (FSO₂)₂NLi. An IR spectrum in a range of 2100 cm⁻¹ to 2400 cm⁻¹ is shown in each of FIGS. 1 to 10. Furthermore, IR measurement was performed using the following conditions on electrolytic solutions E11 to E15 and C6, dimethyl carbonate, electrolytic solutions E16 to E18 and C7, ethyl methyl carbonate, electrolytic solutions E19 to E21 and C8, and diethyl carbonate. An IR spectrum in a range of 1900 to 1600 cm⁻¹ is shown in each of FIGS. 11 to 27. In addition, an IR spectrum of (FSO₂)₂NLi in a range of 1900 to 1600 cm⁻¹ is shown in FIG. 28. In each figure, the horizontal axis represents wave number (cm⁻¹) and the vertical axis represents absorbance (reflective absorbance).

IR Measuring Conditions

Device: FT-IR (manufactured by Bruker Optics K.K.)

Measuring condition: ATR method (diamond was used)

Measurement atmosphere: Inert gas atmosphere

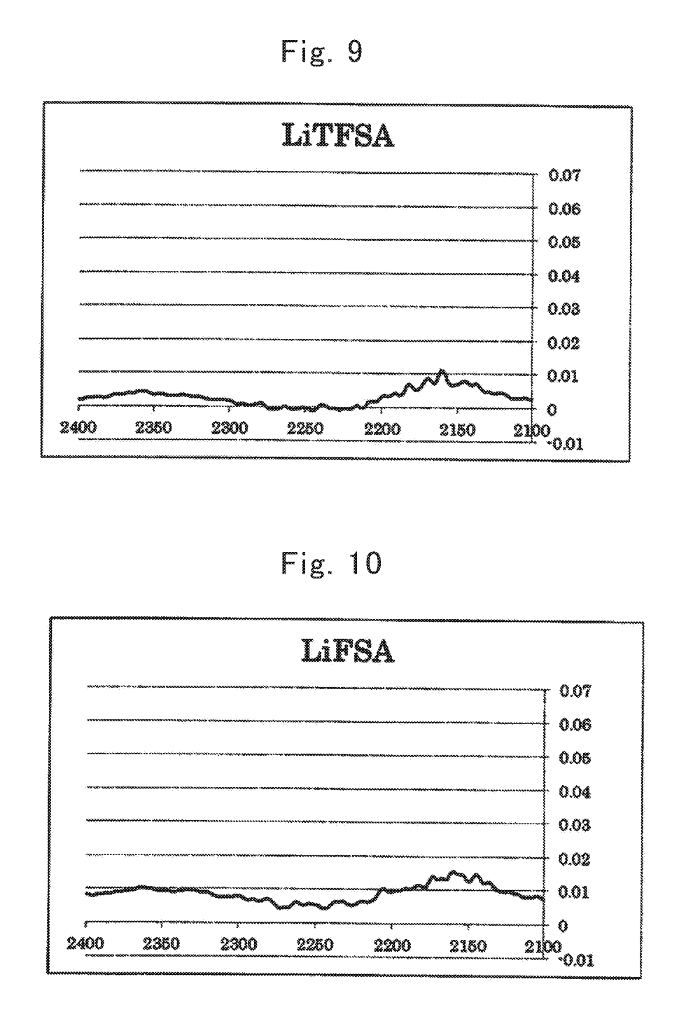

At around 2250 cm⁻¹ in the IR spectrum of acetonitrile shown in FIG. 8, a characteristic peak derived from stretching vibration of a triple bond between C and N of acetonitrile was observed. No particular peaks were observed at around 2250 cm⁻¹ in the IR spectrum of (CF₃SO₂)₂NLi shown in FIG. 9 and the IR spectrum of (FSO₂)₂NLi shown in FIG. 10.

In the IR spectrum of electrolytic solution E3 shown in FIG. 1, a characteristic peak derived from stretching vibration of a triple bond between C and N of acetonitrile was slightly (Io=0.00699) observed at around 2250 cm⁻¹. Additionally in the IR spectrum in FIG. 1, a characteristic peak derived from stretching vibration of a triple bond between C and N of acetonitrile was observed at a peak intensity of Is=0.05828 at around 2280 cm⁻¹ shifted toward the high wave number side from around 2250 cm⁻¹. The relationship between peak intensities of Is and Io was Is>Io and Is=8×Io.

In the IR spectrum of electrolytic solution E4 shown in FIG. 2, a peak derived from acetonitrile was not observed at around 2250 cm⁻¹, whereas a characteristic peak derived from stretching vibration of a triple bond between C and N of acetonitrile was observed at a peak intensity of Is=0.05234 at around 2280 cm⁻¹ shifted toward the high wave number side from around 2250 cm⁻¹. The relationship between peak intensities of Is and Io was Is>Io.

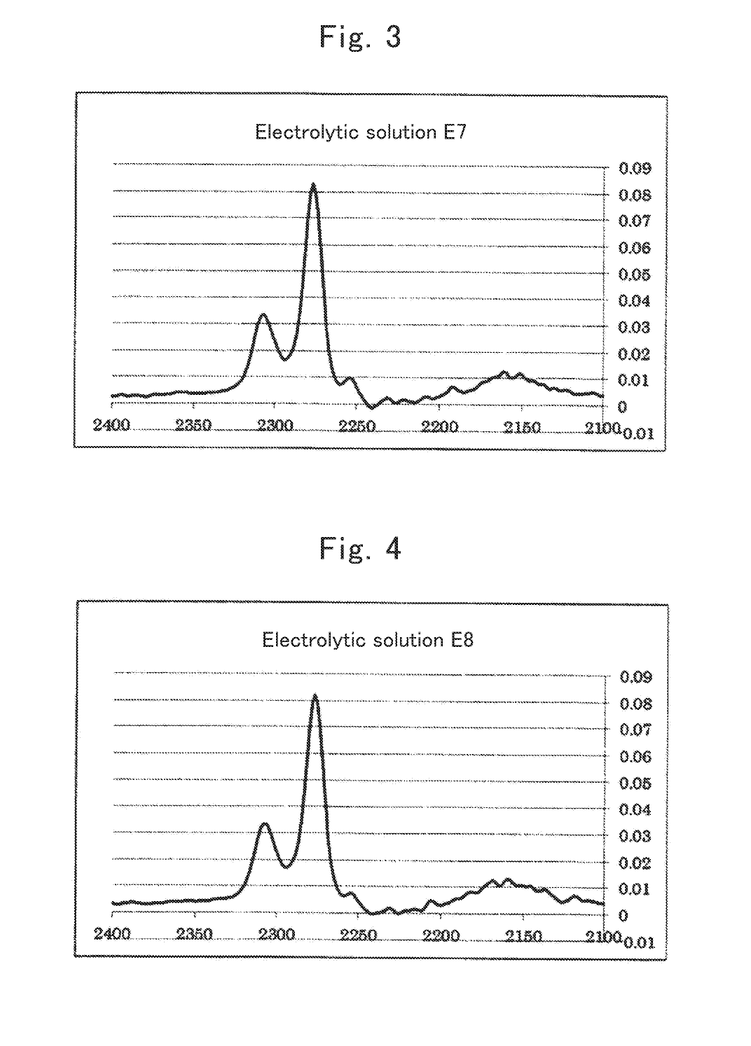

In the IR spectrum of electrolytic solution E7 shown in FIG. 3, a characteristic peak derived from stretching vibration of a triple bond between C and N of acetonitrile was slightly (Io=0.00997) observed at around 2250 cm⁻¹. Additionally in the IR spectrum in FIG. 3, a characteristic peak derived from stretching vibration of a triple bond between C and N of acetonitrile was observed at a peak intensity of Is=0.08288 at around 2280 cm⁻¹ shifted toward the high wave number side from around 2250 cm⁻¹. The relationship between peak intensities of Is and Io was Is>Io and Is=8×Io. A peak having a similar intensity and similar wave number to those in the IR chart of FIG. 3 was also observed in the IR spectrum of electrolytic solution E8 shown in FIG. 4. The relationship between peak intensities of Is and Io was Is>Io and Is=11×Io.

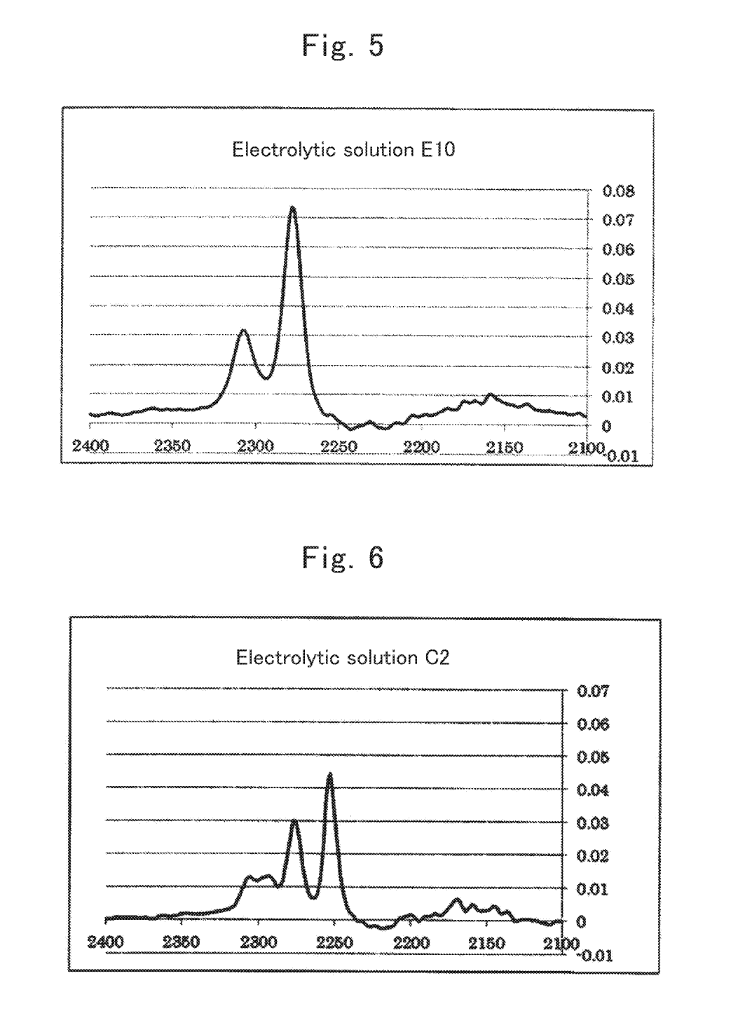

In the IR spectrum of electrolytic solution E10 shown in FIG. 5, a peak derived from acetonitrile was not observed at around 2250 cm⁻¹, whereas a characteristic peak derived from stretching vibration of a triple bond between C and N of acetonitrile was observed at a peak intensity of Is=0.07350 at around 2280 cm⁻¹ shifted toward the high wave number side from around 2250 cm⁻¹. The relationship between peak intensities of Is and Io was Is>Io.

In the IR spectrum of electrolytic solution C2 shown in FIG. 6, a characteristic peak derived from stretching vibration of a triple bond between C and N of acetonitrile was observed at a peak intensity of Io=0.04441 at around 2250 cm⁻¹ in a manner similar to FIG. 8. Additionally in the IR spectrum in FIG. 6, a characteristic peak derived from stretching vibration of a triple bond between C and N of acetonitrile was observed at a peak intensity of Is=0.03018 at around 2280 cm⁻¹ shifted toward the high wave number side from around 2250 cm⁻¹. The relationship between peak intensities of Is and Io was Is<Io.

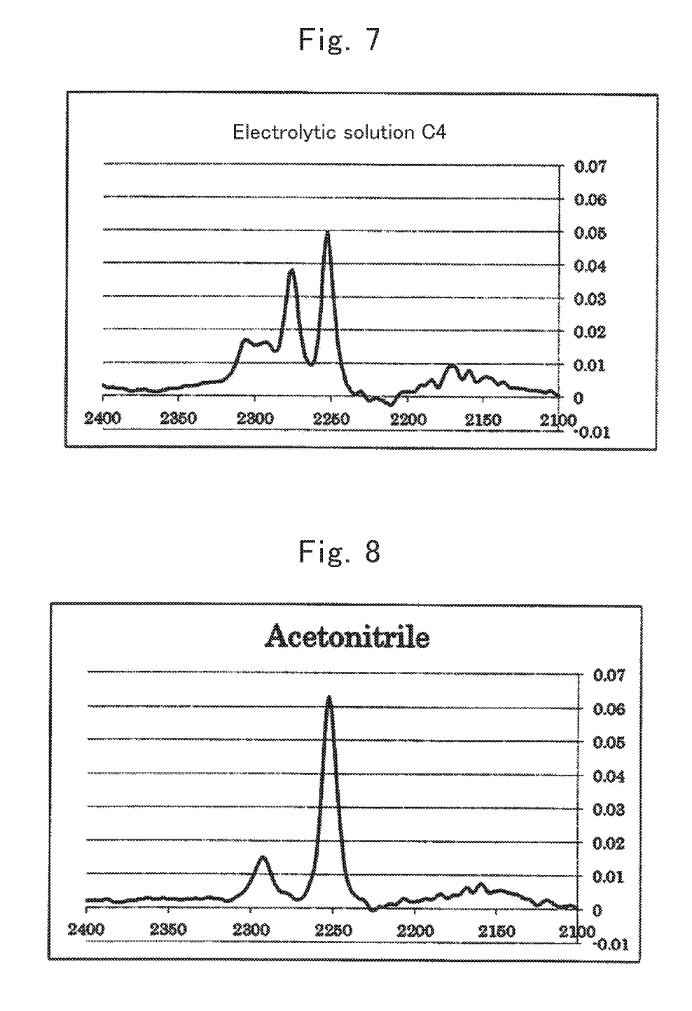

In the IR spectrum of electrolytic solution C4 shown in FIG. 7, a characteristic peak derived from stretching vibration of a triple bond between C and N of acetonitrile was observed at a peak intensity of Io=0.04975 at around 2250 cm⁻¹ in a manner similar to FIG. 8. Additionally in the IR spectrum in FIG. 7, a characteristic peak derived from stretching vibration of a triple bond between C and N of acetonitrile was observed at a peak intensity of Is=0.03804 at around 2280 cm⁻¹ shifted toward the high wave number side from around 2250 cm⁻¹. The relationship between peak intensities of Is and Io was Is<Io.

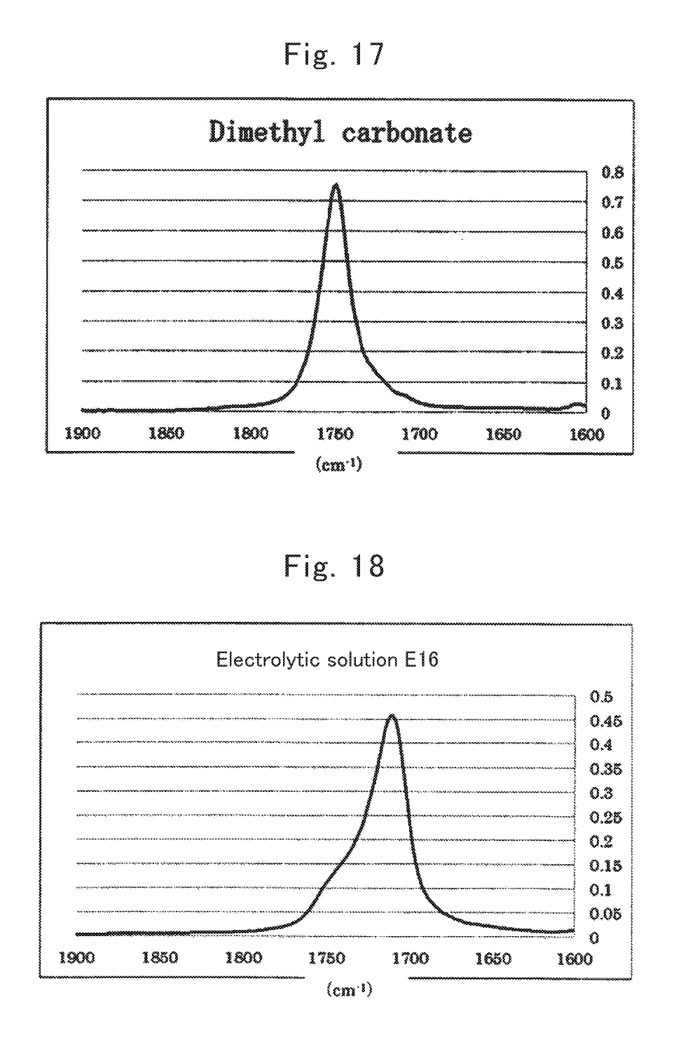

At around 1750 cm⁻¹ in the IR spectrum of dimethyl carbonate shown in FIG. 17, a characteristic peak derived from stretching vibration of a double bond between C and O of dimethyl carbonate was observed. No particular peaks were observed at around 1750 cm⁻¹ in the IR spectrum of (FSO₂)₂NLi shown in FIG. 28.

In the IR spectrum of electrolytic solution E11 shown in FIG. 11, a characteristic peak derived from stretching vibration of a double bond between C and O of dimethyl carbonate was slightly (Io=0.16628) observed at around 1750 cm⁻¹. Additionally in the IR spectrum in FIG. 11, a characteristic peak derived from stretching vibration of a double bond between C and O of dimethyl carbonate was observed at a peak intensity of Is=0.48032 at around 1717 cm⁻¹ shifted toward the low wave number side from around 1750 cm⁻¹. The relationship between peak intensities of Is and Io was Is>Io and Is=2.89×Io.

In the IR spectrum of electrolytic solution E12 shown in FIG. 12, a characteristic peak derived from stretching vibration of a double bond between C and O of dimethyl carbonate was slightly (Io=0.18129) observed at around 1750 cm⁻¹. Additionally in the IR spectrum in FIG. 12, a characteristic peak derived from stretching vibration of a double bond between C and O of dimethyl carbonate was observed at a peak intensity of Is=0.52005 at around 1717 cm⁻¹ shifted toward the low wave number side from around 1750 cm⁻¹. The relationship between peak intensities of Is and Io was Is>Io and Is=2.87×Io.

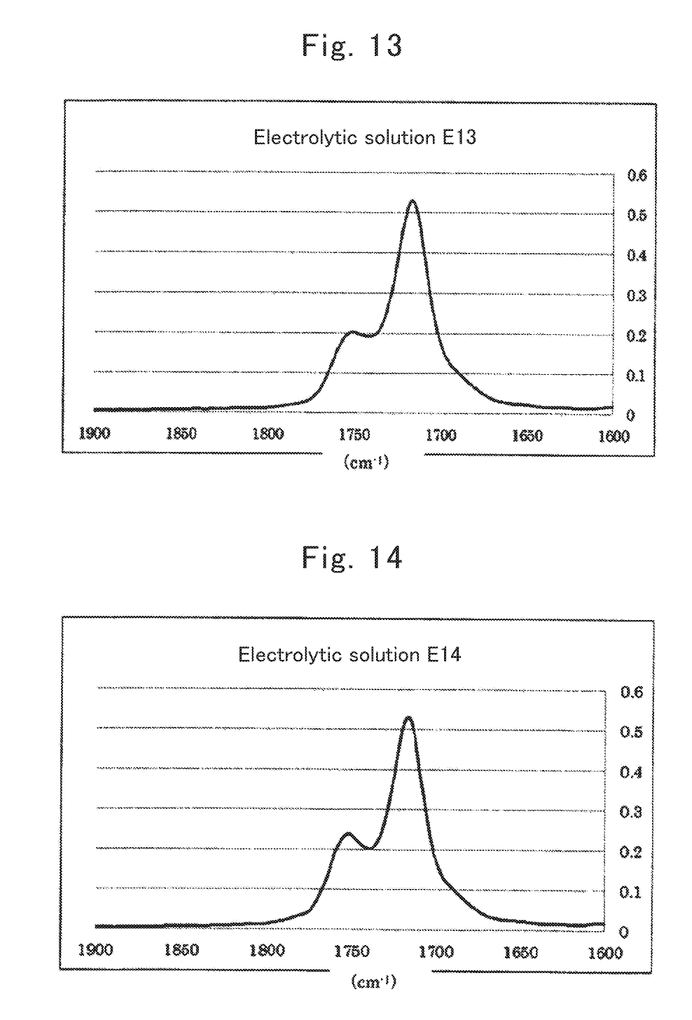

In the IR spectrum of electrolytic solution E13 shown in FIG. 13, a characteristic peak derived from stretching vibration of a double bond between C and O of dimethyl carbonate was slightly (Io=0.20293) observed at around 1750 cm⁻¹. Additionally in the IR spectrum in FIG. 13, a characteristic peak derived from stretching vibration of a double bond between C and O of dimethyl carbonate was observed at a peak intensity of Is=0.53091 at around 1717 cm⁻¹ shifted toward the low wave number side from around 1750 cm⁻¹. The relationship between peak intensities of Is and Io was Is>Io and Is=2.62×Io.

In the IR spectrum of electrolytic solution E14 shown in FIG. 14, a characteristic peak derived from stretching vibration of a double bond between C and O of dimethyl carbonate was slightly (Io=0.23891) observed at around 1750 cm⁻¹. Additionally in the IR spectrum in FIG. 14, a characteristic peak derived from stretching vibration of a double bond between C and O of dimethyl carbonate was observed at a peak intensity of Is=0.53098 at around 1717 cm⁻¹ shifted toward the low wave number side from around 1750 cm⁻¹. The relationship between peak intensities of Is and Io was Is>Io and Is=2.22×Io.

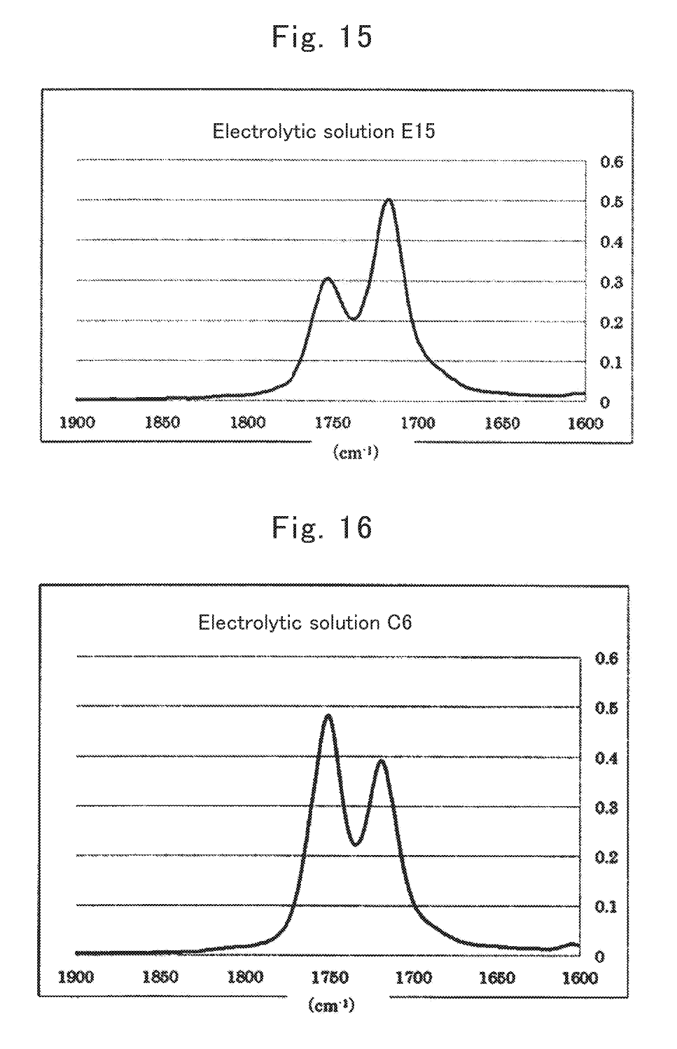

In the IR spectrum of electrolytic solution E15 shown in FIG. 15, a characteristic peak derived from stretching vibration of a double bond between C and O of dimethyl carbonate was slightly (Io=0.30514) observed at around 1750 cm⁻¹. Additionally in the IR spectrum in FIG. 15, a characteristic peak derived from stretching vibration of a double bond between C and O of dimethyl carbonate was observed at a peak intensity of Is=0.50223 at around 1717 cm⁻¹ shifted toward the low wave number side from around 1750 cm⁻¹. The relationship between peak intensities of Is and Io was Is>Io and Is=1.65×Io.

In the IR spectrum of electrolytic solution C6 shown in FIG. 16, a characteristic peak derived from stretching vibration of a double bond between C and O of dimethyl carbonate was observed (Io=0.48204) at around 1750 cm⁻¹. Additionally in the IR spectrum in FIG. 16, a characteristic peak derived from stretching vibration of a double bond between C and O of dimethyl carbonate was observed at a peak intensity of Is=0.39244 at around 1717 cm⁻¹ shifted toward the low wave number side from around 1750 cm⁻¹. The relationship between peak intensities of Is and Io was Is<Io.

At around 1745 cm⁻¹ in the IR spectrum of ethyl methyl carbonate shown in FIG. 22, a characteristic peak derived from stretching vibration of a double bond between C and O of ethyl methyl carbonate was observed.

In the IR spectrum of electrolytic solution E16 shown in FIG. 18, a characteristic peak derived from stretching vibration of a double bond between C and O of ethyl methyl carbonate was slightly (Io=0.13582) observed at around 1745 cm⁻¹. Additionally in the IR spectrum in FIG. 18, a characteristic peak derived from stretching vibration of a double bond between C and O of ethyl methyl carbonate was observed at a peak intensity of Is=0.45888 at around 1711 cm⁻¹ shifted toward the low wave number side from around 1745 cm⁻¹. The relationship between peak intensities of Is and Io was Is>Io and Is=3.38×Io.

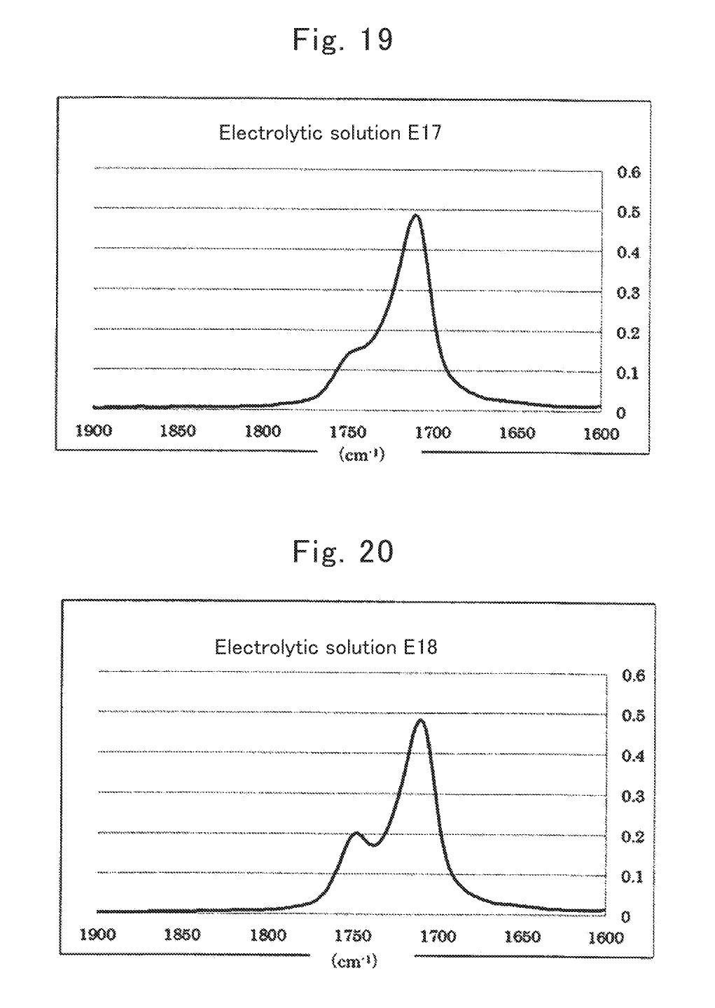

In the IR spectrum of electrolytic solution E17 shown in FIG. 19, a characteristic peak derived from stretching vibration of a double bond between C and O of ethyl methyl carbonate was slightly (Io=0.15151) observed at around 1745 cm⁻¹. Additionally in the IR spectrum in FIG. 19, a characteristic peak derived from stretching vibration of a double bond between C and O of ethyl methyl carbonate was observed at a peak intensity of Is=0.48779 at around 1711 cm⁻¹ shifted toward the low wave number side from around 1745 cm⁻¹. The relationship between peak intensities of Is and Io was Is>Io and Is=3.22×Io.

In the IR spectrum of electrolytic solution E18 shown in FIG. 20, a characteristic peak derived from stretching vibration of a double bond between C and O of ethyl methyl carbonate was slightly (Io=0.20191) observed at around 1745 cm⁻¹. Additionally in the IR spectrum in FIG. 20, a characteristic peak derived from stretching vibration of a double bond between C and O of ethyl methyl carbonate was observed at a peak intensity of Is=0.48407 at around 1711 cm⁻¹ shifted toward the low wave number side from around 1745 cm⁻¹. The relationship between peak intensities of Is and Io was Is>Io and Is=2.40×Io.

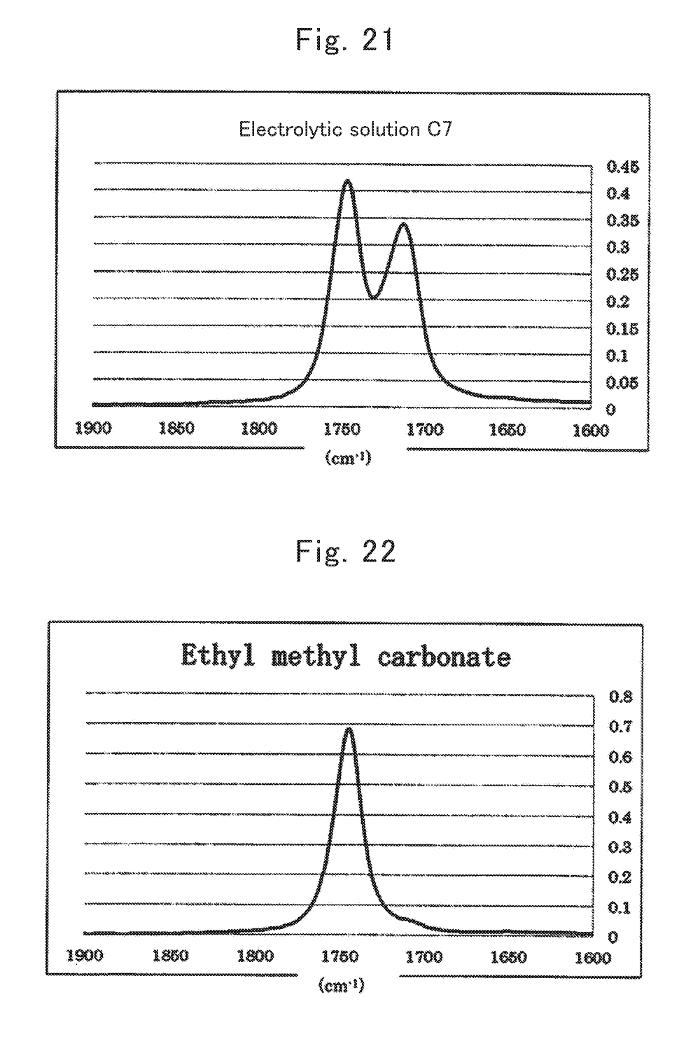

In the IR spectrum of electrolytic solution C7 shown in FIG. 21, a characteristic peak derived from stretching vibration of a double bond between C and O of ethyl methyl carbonate was observed (Io=0.41907) at around 1745 cm⁻¹. Additionally in the IR spectrum in FIG. 21, a characteristic peak derived from stretching vibration of a double bond between C and O of ethyl methyl carbonate was observed at a peak intensity of Is=0.33929 at around 1711 cm⁻¹ shifted toward the low wave number side from around 1745 cm⁻¹. The relationship between peak intensities of Is and Io was Is<Io.

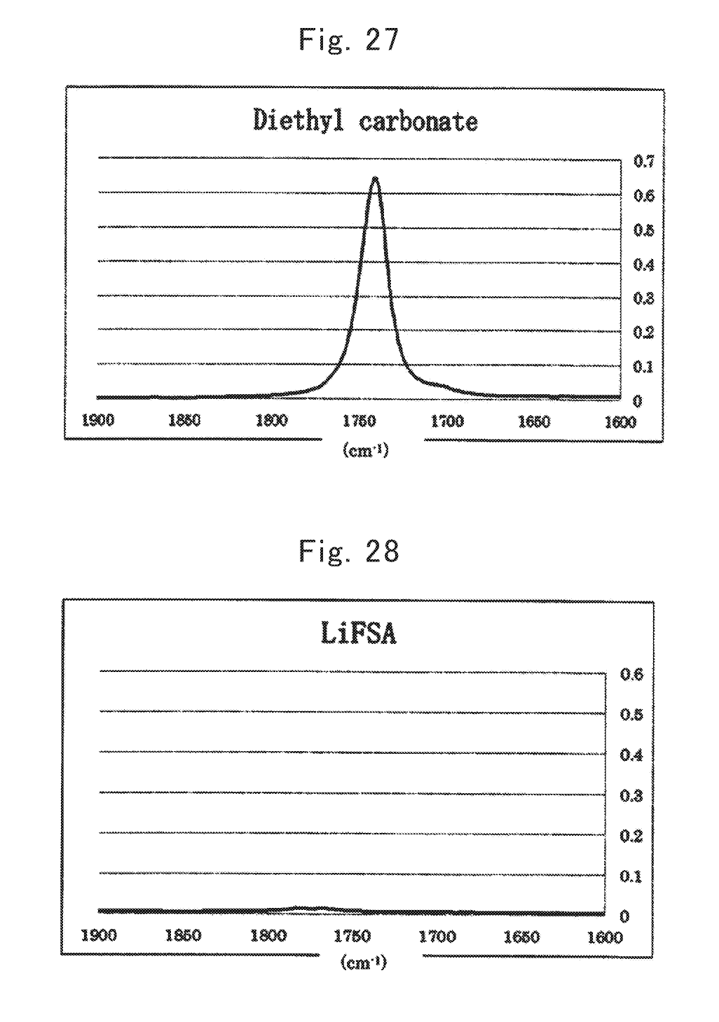

At around 1742 cm⁻¹ in the IR spectrum of diethyl carbonate shown in FIG. 27, a characteristic peak derived from stretching vibration of a double bond between C and O of diethyl carbonate was observed.

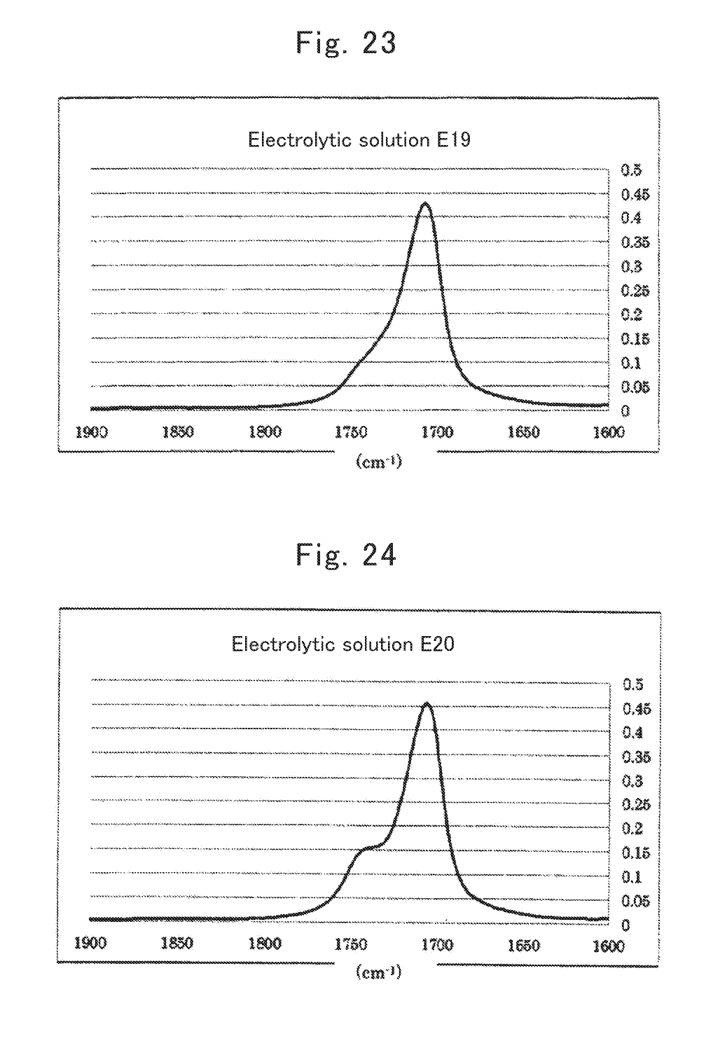

In the IR spectrum of electrolytic solution E19 shown in FIG. 23, a characteristic peak derived from stretching vibration of a double bond between C and O of diethyl carbonate was slightly (Io=0.11202) observed at around 1742 cm⁻¹. Additionally in the IR spectrum in FIG. 23, a characteristic peak derived from stretching vibration of a double bond between C and O of diethyl carbonate was observed at a peak intensity of Is=0.42925 at around 1706 cm⁻¹ shifted toward the low wave number side from around 1742 cm⁻¹. The relationship between peak intensities of Is and Io was Is>Io and Is=3.83×Io.

In the IR spectrum of electrolytic solution E20 shown in FIG. 24, a characteristic peak derived from stretching vibration of a double bond between C and O of diethyl carbonate was slightly (Io=0.15231) observed at around 1742 cm⁻¹. Additionally in the IR spectrum in FIG. 24, a characteristic peak derived from stretching vibration of a double bond between C and O of diethyl carbonate was observed at a peak intensity of Is=0 . 45679 at around 1706 cm⁻¹ shifted toward the low wave number side from around 1742 cm⁻¹. The relationship between peak intensities of Is and Io was Is>Io and Is=3.00×Io.

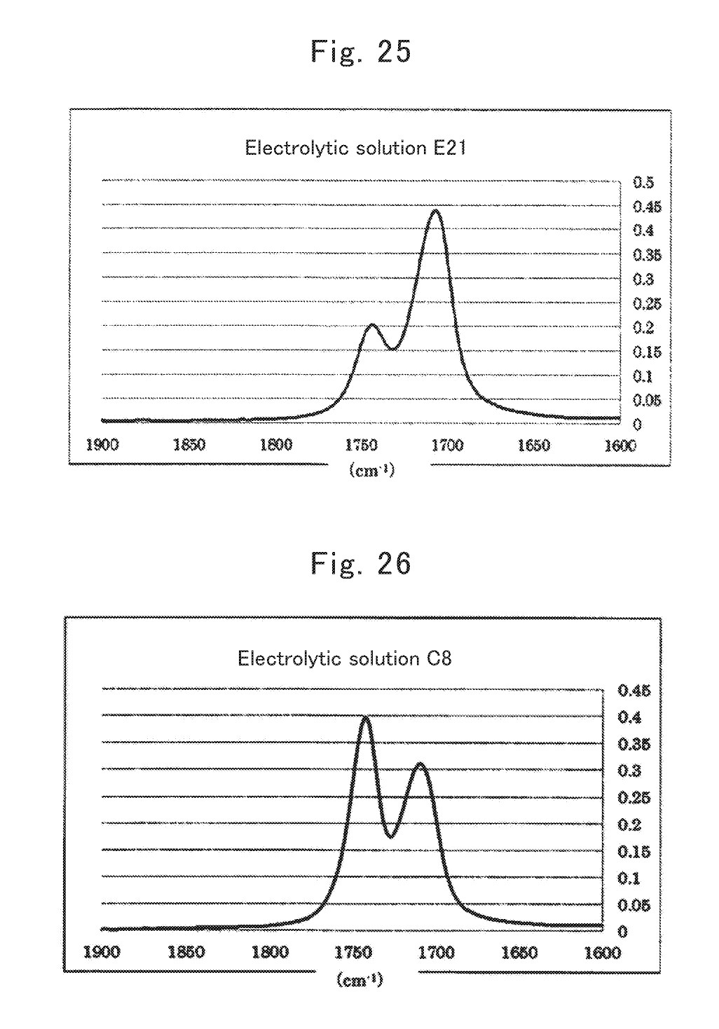

In the IR spectrum of electrolytic solution E21 shown in FIG. 25, a characteristic peak derived from stretching vibration of a double bond between C and O of diethyl carbonate was slightly (Io=0.20337) observed at around 1742 cm⁻¹. Additionally in the IR spectrum in FIG. 25, a characteristic peak derived from stretching vibration of a double bond between C and O of diethyl carbonate was observed at a peak intensity of Is=0.43841 at around 1706 cm⁻¹ shifted toward the low wave number side from around 1742 cm⁻¹. The relationship between peak intensities of Is and Io was Is>Io and Is=2.16×Io.

In the IR spectrum of electrolytic solution C8 shown in FIG. 26, a characteristic peak derived from stretching vibration of a double bond between C and O of diethyl carbonate was observed (Is=0.39636) at around 1742 cm⁻¹. Additionally in the IR spectrum in FIG. 26, a characteristic peak derived from stretching vibration of a double bond between C and O of diethyl carbonate was observed at a peak intensity of Is=0.31129 at around 1709 cm⁻¹ shifted toward the low wave number side from around 1742 cm⁻¹. The relationship between peak intensities of Is and Io was Is<Io.

### Evaluation Example 2

### Ionic Conductivity

Ionic conductivities of electrolytic solutions E1, E2, E4 to E6, E8, E9, E11, E13, E16, and E19 were measured using the following conditions. The results are shown in Table 5.

Ionic Conductivity Measuring Conditions

Under an Ar atmosphere, an electrolytic solution was sealed in a glass cell that has a platinum electrode and whose cell constant is known, and impedance thereof was measured at 30° C., 1 kHz. Ionic conductivity was calculated based on the result of measuring impedance. As a measurement instrument, Solartron 147055BEC (Solartron Analytical) was used.

TABLE 5

| | | | Lithium salt | Ionic |
|---|---|---|---|---|
| | Lithium | Organic | concentration | conductivity |
| | salt | solvent | (mol/L) | (mS/cm) |
| Electrolytic | LiTFSA | DME | 3.2 | 2.4 |
| solution E1 | | | | |
| Electrolytic | LiTFSA | DME | 2.8 | 4.4 |
| solution E2 | | | | |
| Electrolytic | LiTFSA | AN | 4.2 | 1.0 |
| solution E4 | | | | |
| Electrolytic | LiFSA | DME | 3.6 | 7.2 |
| solution E5 | | | | |
| Electrolytic | LiFSA | DME | 4.0 | 7.1 |
| solution E6 | | | | |
| Electrolytic | LiFSA | AN | 4.5 | 9.7 |
| solution E8 | | | | |
| Electrolytic | LiFSA | AN | 5.0 | 7.5 |
| solution E9 | | | | |
| Electrolytic | LiFSA | DMC | 3.9 | 2.3 |
| solution E11 | | | | |
| Electrolytic | LiFSA | DMC | 2.9 | 4.6 |
| solution E13 | | | | |
| Electrolytic | LiFSA | EMC | 3.4 | 1.8 |
| solution E16 | | | | |
| Electrolytic | LiFSA | DEC | 3.0 | 1.4 |
| solution E19 | | | | |

Electrolytic solutions E1, E2, E4 to E6, E8, E9, E11, E13, E16, and E19 all displayed ionic conductivity. Thus, the electrolytic solutions of the present invention are understood to be all capable of functioning as electrolytic solutions of various batteries.

### Evaluation Example 3

### Viscosity

Viscosities of electrolytic solutions E1, E2, E4 to E6, E8, E9, E11, E13, E16, E19, C1 to C4, and electrolytic solution C6 to C8 were measured using the following conditions. The results are shown in Table 6.

Viscosity Measuring Conditions

Under an Ar atmosphere, an electrolytic solution was sealed in a test cell, and viscosity thereof was measured under a condition of 30° C. by using a falling ball viscometer (Louis 2000 M manufactured by Anton Paar GmbH).

TABLE 6

| | Lithium | Organic | Lithium salt | Viscosity |
|---|---|---|---|---|
| | salt | solvent | concentration (mol/L) | (mPa · s) |
| Electrolytic | LiTFSA | DME | 3.2 | 36.6 |
| solution E1 | | | | |
| Electrolytic | LiTFSA | DME | 2.8 | 31.6 |
| solution E2 | | | | |
| Electrolytic | LiTFSA | AN | 4.2 | 138 |
| solution E4 | | | | |
| Electrolytic | LiFSA | DME | 3.6 | 25.1 |
| solution E5 | | | | |
| Electrolytic | LiFSA | DME | 4.0 | 30.3 |
| solution E6 | | | | |
| Electrolytic | LiFSA | AN | 4.5 | 23.8 |
| solution E8 | | | | |
| Electrolytic | LiFSA | AN | 5.0 | 31.5 |
| solution E9 | | | | |
| Electrolytic | LiFSA | DMC | 3.9 | 34.2 |
| solution E11 | | | | |
| Electrolytic | LiFSA | DMC | 2.9 | 17.6 |
| solution E13 | | | | |
| Electrolytic | LiFSA | EMC | 3.4 | 29.7 |
| solution E16 | | | | |
| Electrolytic | LiFSA | DEC | 3.0 | 23.2 |
| solution E19 | | | | |
| Electrolytic | LiTFSA | DME | 1.0 | 1.3 |
| solution C1 | | | | |
| Electrolytic | LiTFSA | AN | 1.0 | 0.75 |
| solution C2 | | | | |
| Electrolytic | LiFSA | DME | 1.0 | 1.2 |
| solution C3 | | | | |
| Electrolytic | LiFSA | AN | 1.0 | 0.74 |
| solution C4 | | | | |
| Electrolytic | LiFSA | DMC | 1.1 | 1.38 |
| solution C6 | | | | |
| Electrolytic | LiFSA | EMC | 1.1 | 1.67 |
| solution C7 | | | | |
| Electrolytic | LiFSA | DEC | 1.1 | 2.05 |
| solution C8 | | | | |

When compared to the viscosities of electrolytic solutions C1 to C4 and C6 to C8, the viscosities of electrolytic solutions E1, E2, E4 to E6, E8, E9, E11, E13, E16, and E19 were significantly higher. Thus, with a battery using the electrolytic solution of the present invention, even if the battery is damaged, leakage of the electrolytic solution is suppressed.

### Evaluation Example 4

### Volatility

Volatilities of electrolytic solutions E2, E4, E8, E11, E13, C1, C2, C4, and C6 were measured using the following method.

Approximately 10 mg of an electrolytic solution was placed in a pan made from aluminum, and the pan was disposed in a thermogravimetry measuring device (SDT600 manufactured by TA Instruments) to measure weight change of the electrolytic solution at room temperature. Volatilization rate was calculated through differentiation of weight change (mass o) by time . Among the obtained volatilization rates, largest values were selected and are shown in Table 7.

TABLE 7

| | | | Lithium salt | Maximum |
|---|---|---|---|---|
| | Lithium | Organic | concentration | volatilization rate |
| | salt | solvent | (mol/L) | (mass %/min.) |
| Electrolytic | LiTFSA | DME | 2.8 | 0.4 |
| solution E2 | | | | |
| Electrolytic | LiTFSA | AN | 4.2 | 2.1 |
| solution E4 | | | | |
| Electrolytic | LiFSA | AN | 4.5 | 0.6 |
| solution E8 | | | | |
| Electrolytic | LiFSA | DMC | 3.9 | 0.1 |
| solution E11 | | | | |
| Electrolytic | LiFSA | DMC | 2.9 | 1.3 |
| solution E13 | | | | |
| Electrolytic | LiTFSA | DME | 1.0 | 9.6 |
| solution C1 | | | | |
| Electrolytic | LiTFSA | AN | 1.0 | 13.8 |
| solution C2 | | | | |
| Electrolytic | LiFSA | AN | 1.0 | 16.3 |
| solution C4 | | | | |
| Electrolytic | LiFSA | DMC | 1.1 | 6.1 |
| solution C6 | | | | |

Maximum volatilization rates of electrolytic solutions E2, E4 E8, E11, and E13 were significantly smaller than maximum volatilization rates of electrolytic solutions C1, C2, C4, and C6. Thus, even if a battery using the electrolytic solution of the present invention is damaged, rapid volatilization of the organic solvent outside the battery is suppressed since the volatilization rate of the electrolytic solution is small.

### Evaluation Example 5

### Combustibility

Combustibility of electrolytic solutions E4 and C2 was tested using the following method.

Three drops of an electrolytic solution were dropped on a glass filter by using a pipette to have the electrolytic solution retained by the glass filter. The glass filter was held by a pair of tweezers, and the glass filter was brought in contact with a flame.

Electrolytic solution E4 did not ignite even when being brought in contact with a flame for 15 seconds. On the other hand, electrolytic solution C2 burned out in a little over 5 seconds.

Thus, the electrolytic solution of the present invention was confirmed to be unlikely to combust.

### Evaluation Example 6

### Li Transference Number

Li transference numbers of electrolytic solutions E2, E8, C4, and C5 were measured using the following conditions. The results are shown in Table 8.

<Li Transference Number Measuring Conditions>

An NMR tube including electrolytic solution E2, E8, C4, or C5 was placed in a PFG-NMR device (ECA-500, JEOL Ltd.), and diffusion coefficients of Li ions and anions in each of the electrolytic solutions were measured on ⁷Li and ¹⁹F as targets while altering a magnetic field pulse width, using spin echo method. The Li transference number was calculated from the following formula.

Li transference number=(Li ionic diffusion coefficient)/(Li ionic diffusion coefficient+anion diffusion coefficient)

TABLE 8

| | | | Lithium salt | Li |
|---|---|---|---|---|
| | Lithium | Organic | concentration | transference |
| | salt | solvent | (mol/L) | number |
| Electrolytic | LiTFSA | DME | 2.8 | 0.52 |
| solution E2 | | | | |
| Electrolytic | LiFSA | AN | 4.5 | 0.50 |
| solution E8 | | | | |
| Electrolytic | LiFSA | AN | 1.0 | 0.42 |
| solution C4 | | | | |
| Electrolytic | LiPF₆ | EC/DEC | 1.0 | 0.40 |
| solution C5 | | | | |

When compared to the Li transference numbers of electrolytic solutions C4 and C5, the Li transference numbers of electrolytic solutions E2 and E8 were significantly higher. Here, Li ionic conductivity of an electrolytic solution is calculatedbymultiplying ionic conductivity (total ion conductivity) of the electrolytic solution by the Li transference number. As a result, when compared to a conventional electrolytic solution having the same level of ionic conductivity, the electrolytic solution of the present invention shows a high transportation rate of lithium ion (cation).

In addition, the Li transference number when the temperature was altered was measured in the electrolytic solution of electrolytic solution E8 in accordance with the measuring conditions for the above described Li transference numbers. The results are shown in Table 9.

TABLE 9

| Temperature (° C.) | Li transference number |
|---|---|
| 30 | 0.50 |
| 10 | 0.50 |
| −10 | 0.50 |
| −30 | 0.52 |

Based on the results in Table 9, the electrolytic solution of the present invention is understood as to maintain a suitable Li transference number regardless of the temperature. The electrolytic solution of the present invention is regarded as to maintain a liquid state even at a low temperature.

### Evaluation Example 7

### Low Temperature Test

Electrolytic solutions E11, E13, E16, and E19 were each placed in a container, and the container was filled with inert gas and sealed. These solutions were stored in a −30° C. freezer for two days. Each of the electrolytic solutions after storage was observed. All of the electrolytic solutions maintained a liquid state without solidifying, and depositing of salts was also not observed.

### Evaluation Example 8

### Raman Spectrum Measurement

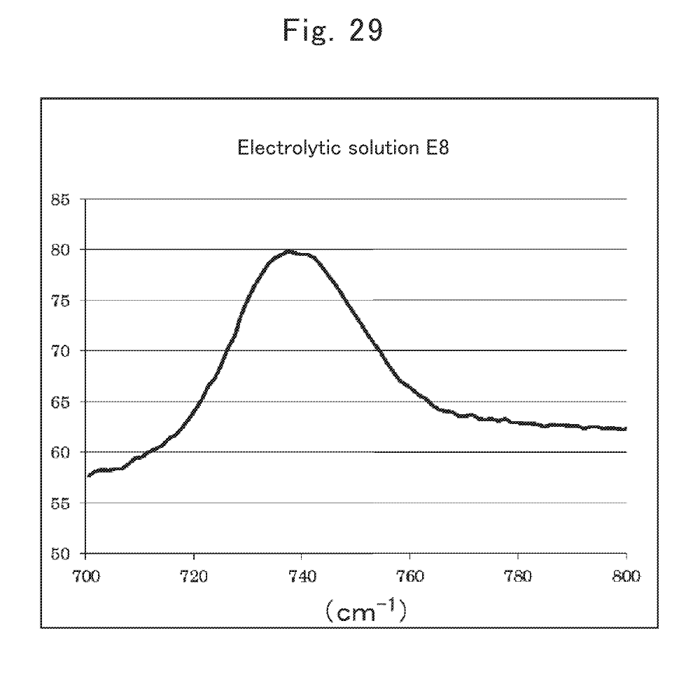

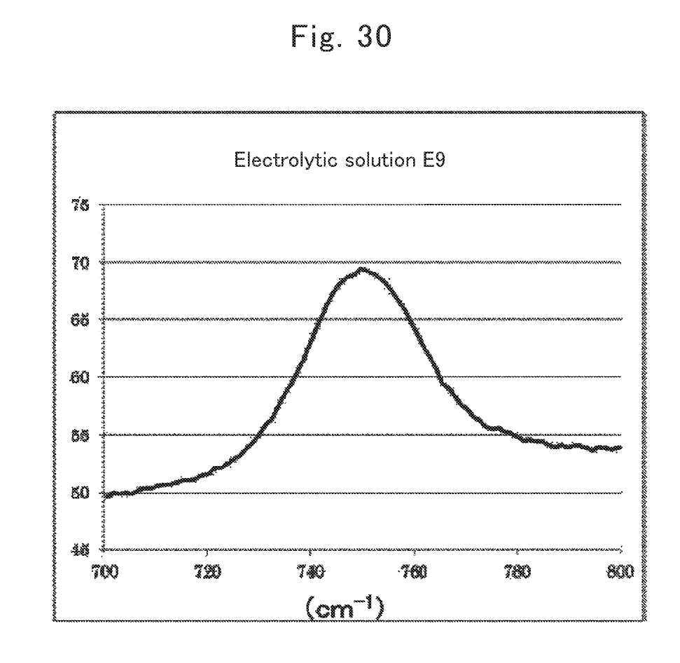

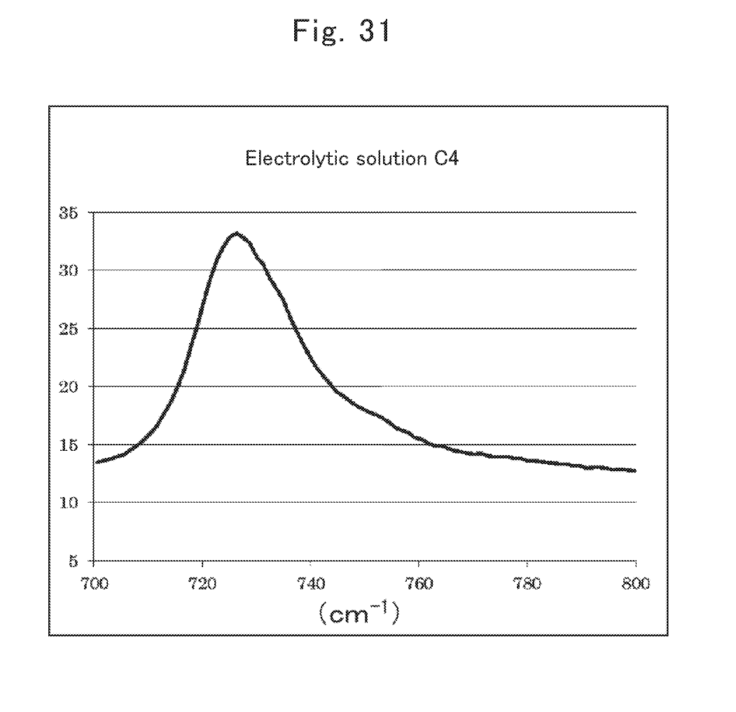

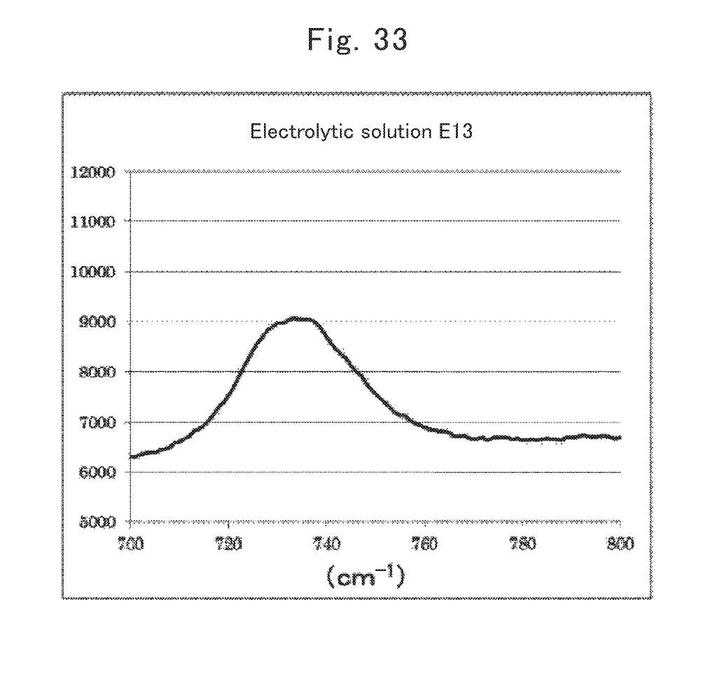

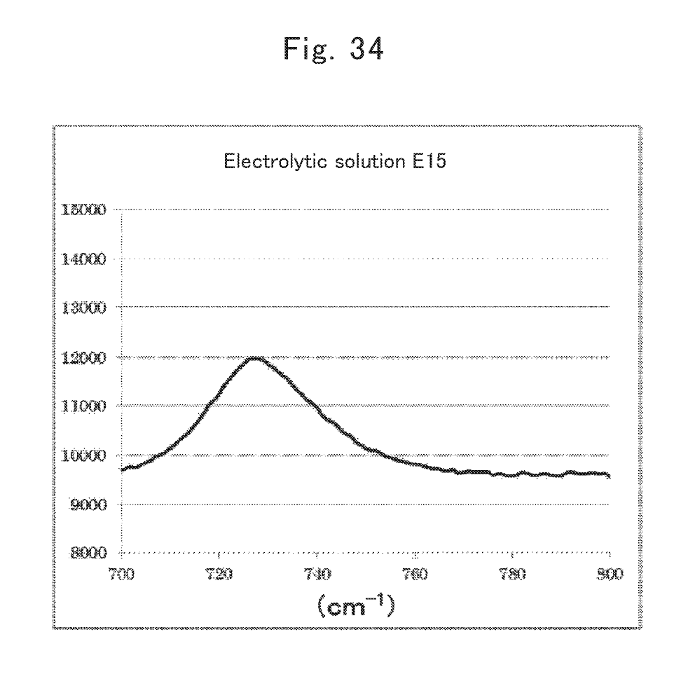

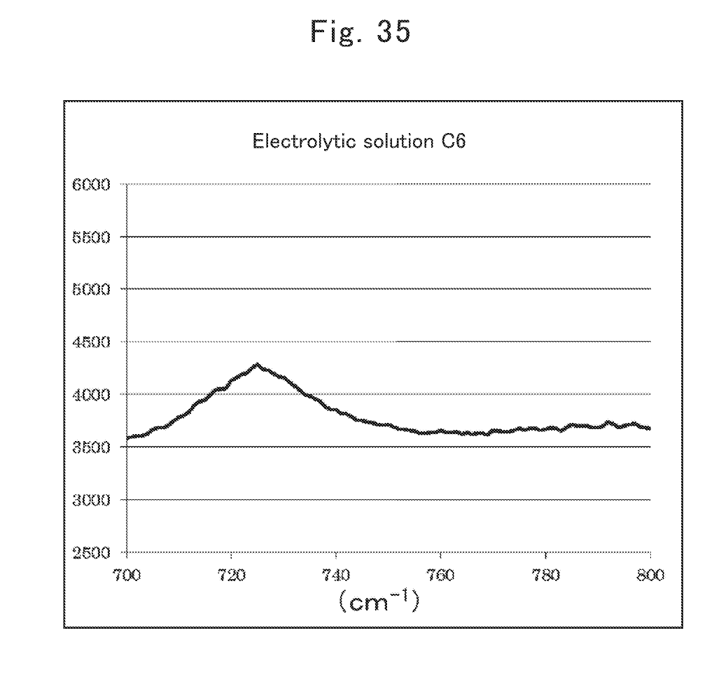

Raman spectrum measurement was performed on electrolytic solutions E8, E9, C4, E11, E13, E15, and C6 using the following conditions. FIGS. 29 to 35 each show a Raman spectrum in which a peak derived from an anion portion of a metal salt of an electrolytic solution was observed. In each of the figures, the horizontal axis represents wave number (cm⁻¹) and the vertical axis represents scattering intensity.

Raman Spectrum Measurement Conditions

Device: Laser Raman spectrometer (NRS series, JASCO Corp.)

Laser wavelength: 532 nm

The electrolytic solutions were each sealed in a quartz cell under an inert gas atmosphere and subjected to the measurement.

At 700 to 800 cm⁻¹ in Raman spectra of electrolytic solutions E8, E9, and C4 shown in FIGS. 29 to 31, characteristic peaks derived from (FSO₂)₂N of LiFSA dissolved in acetonitrile were observed. Here, based on FIGS. 29 to 35, the peak is understood as to shift toward the high wave number side associated with an increase in the concentration of LiFSA. As the concentration of the electrolytic solution becomes higher, (FSO₂)₂N corresponding to the anion of a salt is speculated to enter a state of interacting with more Li. Such a state is considered to be observed as a peak shift in the Raman spectrum.

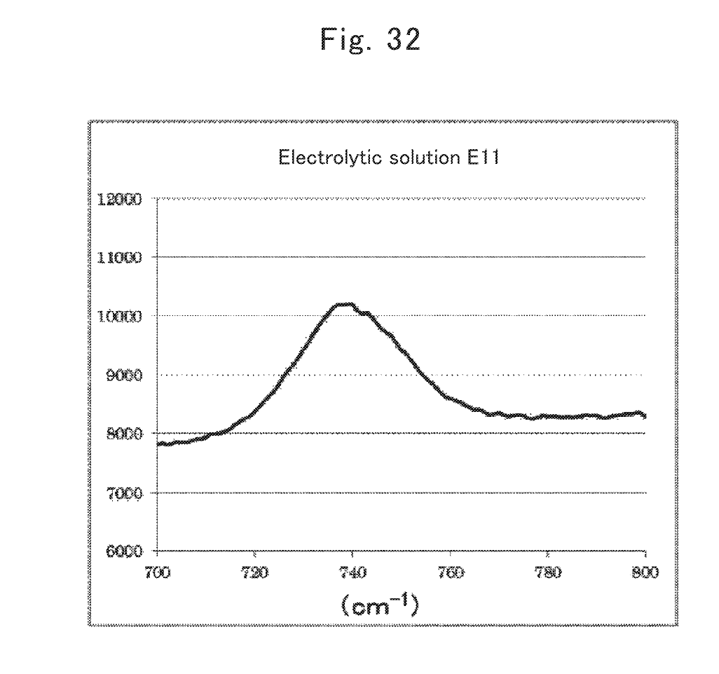

At 700 to 800 cm⁻¹ in Raman spectra of electrolytic solutions E11, E13, E15, and C6 shown in FIG. 32 to FIG. 35, characteristic peaks derived from (FSO₂)₂N of LiFSA dissolved in dimethyl carbonate were observed. Here, based on FIG. 32 to FIG. 35, the peak is understood as to shift toward the high wave number side associated with an increase in the concentration of LiFSA. As considered in the previous paragraph, this phenomenon is considered as a result of (FSO₂)₂N corresponding to the anion of a salt entering a state of interacting with multiple Li ions as the concentration of the electrolytic solution became higher, and the state being reflected in the spectrum. In other words, Li and an anion are speculated to mainly form an SSIP (Solvent-separated ion pairs) state at a low concentration, and mainly form a CIP (Contact ion pairs) state or an AGG (aggregate) state as the concentration becomes higher. A change in the state is thought to be observed as a peak shift in the Raman spectrum.

### Example A-1

A lithium ion secondary battery of Example A-1 includes a positive electrode, a negative electrode, an electrolytic solution, and a separator.

The positive electrode includes a positive electrode active material layer, and a current collector coated with the positive electrode active material layer. The positive electrode active material layer includes a positive electrode active material, a binding agent, and a conductive additive. The positive electrode active material is formed from a lithium-containing metal oxide with a layered rock salt structure represented by LiNi_{0.5}Co_{0.2}Mn_{0.3}O₂. The binding agent is formed from polyvinylidene fluoride (PVDF). The conductive additive is formed from acetylene black (AB). The current collector is formed from an aluminum foil having a thickness of 20 μm. The contained mass ratio of the positive electrode active material, the binding agent, and the conductive additive is 94:3:3 when mass of the positive electrode active material layer is defined as 100 parts by mass.

In order to produce the positive electrode, LiNi_{0.5}Co_{0.2}Mn_{0.3}O₂, PVDF, and AB were mixed in the above described mass ratio, and N-methyl-2-pyrrolidone (NMP) was added thereto as the solvent to obtain a positive electrode material in a paste form. The positive electrode material in the paste form was applied on the surface of the current collector using a doctor blade to form the positive electrode active material layer. The positive electrode active material layer was dried for 20 minutes at 80° C. to remove the NMP through volatilization. An aluminum foil having the positive electrode active material layer formed on the surface thereof was compressed using a roll press machine to firmly attach and join the aluminum foil and the positive electrode active material layer. The obtained joined object was heated in a vacuum dryer for 6 hours at 120° C. and cut in a predetermined shape to obtain the positive electrode. Hereinafter, if necessary, the lithium-containing metal oxide having the layered rock salt structure represented by LiNi_{5/10}CoO_{2/10}Mn_{3/10}O₂ is abbreviated as NCM523, acetylene black is abbreviated as AB, and polyvinylidene fluoride is abbreviated as PVdF.

The negative electrode includes a negative electrode active material layer, and a current collector coated with the negative electrode active material layer. The negative electrode active material layer includes a negative electrode active material and a binding agent. In order to produce the negative electrode, as the negative electrode active material, 98 parts by mass of graphite and, as the binding agent, 1 part by mass of styrene-butadiene rubber (SBR) and 1 part by mass of carboxymethyl cellulose (CMC) were mixed. The obtained mixture was dispersed in a proper amount of ion exchanged water to produce a negative electrode material in a slurry form. The negative electrode material in the slurry form was applied in a film form on a copper foil, which is the negative electrode current collector and has a thickness of 20 μm, using a doctor blade to form the negative electrode active material layer. The current collector having the negative electrode active material layer formed thereon was dried and then pressed. The obtained joined object was heated in a vacuum dryer for 6 hours at 100° C., and cut in a predetermined shape to obtain the negative electrode.

The above described electrolytic solution E8 was used as the electrolytic solution in Example A-1.

By using the positive electrode, the negative electrode, and the electrolytic solution described above, a laminated type lithium ion secondary battery was produced. In detail, an electrode assembly was formed by interposing, as a separator, a cellulose nonwoven fabric (filter paper (cellulose, thickness of 260 μm) manufactured by Toyo Roshi Kaisha, Ltd.) between the positive electrode and the negative electrode. The electrode assembly was covered with a set of two sheets of a laminate film. The laminate film was formed into a bag-like shape by having three sides thereof sealed, and the electrolytic solution was poured into the laminate film. Four sides were sealed airtight by sealing the remaining one side to obtain a laminated type lithium ion secondary battery in which the electrode assembly and the electrolytic solution were sealed. The positive electrode and the negative electrode each include a tab enabling electrical connection to the outside, and one part of the tab extends outside the laminated type lithium ion secondary battery.

### Example A-2

A lithium ion secondary battery of Example A-2 is similar to that of Example A-1 except for using electrolytic solution E4 as the electrolytic solution.

### Example A-3

A lithium ion secondary battery of Example A-3 is similar to that of Example A-1 except for using electrolytic solution El as the electrolytic solution.

### Example A-4

A lithium ion secondary battery of Example A-4 was produced in the following manner.

A positive electrode was produced in a similar manner to the positive electrode of the lithium ion secondary battery of Example A-1.

90 parts by mass of natural graphite, which is a negative electrode active material, and 10 parts by mass of polyvinylidene fluoride, which is a binding agent, were mixed. The mixture was dispersed in a proper amount of ion exchanged water to create a slurry. As the negative electrode current collector, a copper foil having a thickness of 20 μm was prepared. The slurry was applied in a film form on the surface of the copper foil by using a doctor blade. The copper foil on which the slurry was applied was dried to remove water, and then the copper foil was pressed to obtain a joined object. The obtained joined object was heated and dried in a vacuum dryer for 6 hours at 120° C. to obtain a copper foil having the negative electrode active material layer formed thereon. This was used as the negative electrode.

As the separator, a nonwoven fabric made from cellulose and having a thickness of 20 μm was prepared.

An electrode assembly was formed by sandwiching the separator between the positive electrode and the negative electrode. The electrode assembly was covered with a set of two sheets of a laminate film. The laminate film was formed into a bag-like shape by having three sides thereof sealed, and electrolytic solution E8 used in Example A-1 was poured into the laminate film. Four sides were sealed airtight by sealing the remaining one side to obtain a lithium ion secondary battery in which the electrode assembly and the electrolytic solution were sealed. This battery was used as the lithium ion secondary battery of Example A-4.

### Comparative Example A-1

A lithium ion secondary battery of Comparative Example A-1 is similar to that of Example A-1 except for using electrolytic solution C5 as the electrolytic solution.

### Comparative Example A-2

A lithium ion secondary battery of Comparative Example A-2 is similar to that of Example A-4 except for using electrolytic solution C5 used in Comparative Example A-1.

Table 10 showsalistoftheelectrolyticsolutionsofExamples A-1, A-2, A-3, and A-4 and Comparative Example A-1 and A-2.

TABLE 10

| | | | Lithium salt | organic |
|---|---|---|---|---|
| | | | concen- | solvent/ |
| | Lithium | Organic | tration | lithium salt |
| | salt | solvent | (mol/L) | (mol ratio) |
| Examples A-1, A-4 | LiFSA | AN | 4.5 | 2.4 |
| Example A-2 | LiTFSA | AN | 4.2 | 1.9 |
| Example A-3 | LiTFSA | DME | 3.2 | 1.6 |
| Comparative | LiPF₆ | EC/DEC | 1.0 | |
| Examples A-1, A-2 | | | | |

LiTFSA: (CF₃SO₂)₂NLi,
LiFSA: (FSO₂)₂NLi,
AN: acetonitrile,
DME: 1,2-dimethoxyethane,
EC/DEC: Mixed solvent of ethylene carbonate and diethyl carbonate (volume ratio 3:7)

### Evaluation Example A-9

### Input-Output Characteristics

(1) Output Characteristics Evaluation at 0° C., SOC 20%

Output characteristics of the lithium ion secondary batteries of Example A-1 and Comparative Example A-1 were evaluated. In each of the lithium ion secondary batteries of Example A-1 and Comparative Example A-1 on which the evaluation was performed, the weight per area of the positive electrode was 11 mg/cm² and the weight per area of the negative electrode was 8 mg/cm². The evaluation conditions were: state of charge (SOC) 20%, 0° C., usage voltage range of 3 V to 4.2 V, and capacity of 13.5 mAh. SOC 20% at 0° C. is in a range in which output characteristics are unlikely to be exerted such as, for example, when used in a cold room. Evaluation of output characteristics in Example A-1 and Comparative Example A-1 was performed three times each for 2-second output and 5-second output. Evaluation results of output characteristics are shown in Table 11. In Table 11, “2-second output” refers to an output outputted at 2 seconds after the start of discharging, and “5-second output” refers to an output outputted at 5 seconds after the start of discharging.

As shown in Table 11, the output of the battery of Example A-1 at 0° C., SOC 20% was 1.2 to 1.3 times higher than the output of the battery of Comparative Example A-1.

(2) Output Characteristics Evaluation at 25° C., SOC 20%

Output characteristics of the batteries of Example A-1 and Comparative Example A-1 were evaluated at conditions of: state of charge (SOC) of 20%, 25° C., usage voltage range of 3 V to 4.2 V, and capacity of 13.5 mAh. Evaluation of output characteristics in Example A-1 and Comparative Example A-1 was performed three times each for 2-second output and 5-second output. Evaluation results are shown in Table 11.

As shown in Table 11, the output of the battery of Example A-1 at 25° C., SOC 20% was 1.2 to 1.3 times higher than the output of the battery of Comparative Example A-1.

(3) Effect of Temperature on Output Characteristics

The effect of temperature during measurement on output characteristics of the lithium ion secondary batteries of Example A-1 and Comparative Example A-1 described above was investigated. Measurements were performed at 0° C. and 25° C., and the used evaluation conditions were: state of charge (SOC) of 20%, usage voltage range of 3 V to 4.2 V, and capacity of 13.5 mAh for the measurements at both temperatures. A ratio (0° C.-output/25° C.-output) of an output at 0° C. with respect to an output at 25° C. was calculated. The results are shown in Table 11.

As shown in Table 11, the electrolytic solution of Example A-1 was revealed to be capable of suppressing decrease of output at a low temperature at the same level as the electrolytic solution of Comparative Example A-1.

In the electrolytic solution of Example A-1, since most of acetonitrile, which is the organic solvent having a heteroelement, is forming a cluster with LIFSA, which is the lithium salt; the vapor pressure of the organic solvent contained in the electrolytic solution becomes low. As a result, volatilization of the organic solvent from the electrolytic solution is reduced.

On the other hand, an EC-based solvent is used in Comparative Example A-1. EC is mixed for lowering the viscosity and melting point of an electrolytic solution. DEC, which is a linear carbonate, is also included in the solvent of Comparative Example A-1. A linear carbonate is easily volatilized, and, when any opening is formed on the battery or when the battery sustains damage by any chance, large quantity of the organic solvent may be released outside the system instantaneously as a gas.

By using a low volatility liquid such as an ionic liquid as the solvent of the electrolytic solution, the problem of the electrolytic solution of Comparative Example A-1 is solved. However, the ionic liquid is predicted to have inferior input-output characteristics since the ionic liquid has high viscosity and low ionic conductivity when compared to an ordinary electrolytic solution. This trend is prominent at a low temperature such as 0° C., and 0° C.-output/25° C.-output is predicted to be not higher than 0.2.

TABLE 11

| | | | Comparative Example |
|---|---|---|---|
| | | Example A-1 | A-1 |
| 0° C. SOC20% | 2-second | 121.7 | 98.1 |
| | output (mW) | 123.9 | 98.5 |
| | | 119.8 | 99.2 |
| | 5-second | 98.4 | 75.1 |
| | output (mW) | 101.0 | 75.7 |
| | | 96.3 | 76.5 |
| 25° C., SOC20% | 2-second | 458.9 | 371.4 |
| | output (mW) | 471.3 | 372.4 |
| | | 466.8 | 370.8 |
| | 5-second | 374.1 | 290.4 |
| | output (mW) | 387.6 | 292.7 |
| | | 382.0 | 285.4 |
| 0° C. output/ | 2-second | 0.26 | 0.27 |
| 25° C. output | output (mW) | | |
| | 5-second | 0.26 | 0.26 |
| | output (mW) | | |

(4) Input Characteristics Evaluation at 0° C. or 25° C., SOC 80%

Input characteristics of the lithium ion secondary batteries were evaluated. The batteries used in the present evaluation were similar to the lithium ion secondary batteries of Examples A-1 and A-4 and Comparative Examples A-1 and A-2, except for using a cellulose nonwoven fabric having a thickness of 20 μm as the separator. The batteries corresponding to Examples A-1 and A-4 and Comparative Examples A-1 and A-2 were respectively referred to as embodiment batteries A-1 and A-4 and comparative batteries A-1 and A-2. The evaluation conditions were: state of charge (SOC) 80%, 0° C. or 25° C., usage voltage range of 3 V to 4.2 V, and capacity of 13.5 mAh. Evaluation of input characteristics of each of the batteries was performed three times each for 2-second input and 5-second input.

In addition, based on the volume of each of the batteries, battery output density (W/L) at 25° C. in 2-second input was calculated. The evaluation results of input characteristics are shown in Table 12.

As shown in Table 12, regardless of the difference in temperature, the input of the battery of embodiment battery A-1 was significantly higher than the input of the battery of comparative battery A-1. Similarly, the input of the battery of embodiment battery A-4 was significantly higher than the input of the battery of comparative battery A-2.

In addition, the battery input density of embodiment battery A-1 was significantly higher than the battery input density of comparative battery A-1. Similarly, the battery input density of embodiment battery A-4 was significantly higher than the battery input density of comparative battery A-2.

(5) Outₚut Characteristics Evaluation at 0° C. or 25° C., SOC 20%

Output characteristics of embodiment batteries A-1 and A-4 and comparative batteries A-1 and A-2 were evaluated using the following conditions. The evaluation conditions were: state of charge (SOC) of 20%, 0° C. or 25° C., usage voltage range of 3 V to 4.2 V, and capacity of 13.5 mAh. SOC 20% at 0° C. is in a range in which output characteristics are unlikely to be exerted such as, for example, when used in a cold room. Evaluation of output characteristics of each of the batteries was performed three times each for 2-second output and 5-second output.

In addition, based on the volume of each of the batteries, battery output density (W/L) at 25° C. in 2-second output was calculated. The evaluation results of output characteristics are shown in Table 12.

As shown in Table 12, regardless of the difference in temperature, the output of embodiment battery A-1 was significantly higher than the output of comparative battery A-1. Similarly, the output of embodiment battery A-4 was significantly higher than the output of comparative battery A-2.

In addition, the battery output density of embodiment battery A-1 was significantly higher than the battery output density of comparative battery A-1. Similarly, the battery output density of embodiment battery A-4 was significantly higher than the battery output density of comparative battery A-2.

TABLE 12

| | | Embodi- | Compar- | Embodi- | Compar- |
|---|---|---|---|---|---|
| | | ment | ative | ment | ative |
| | | battery | battery | battery | battery |
| Battery | | A-1 | A-1 | A-4 | A-2 |
| SOC80%, | 2-second | 1285.1 | 732.2 | 1113.6 | 756.9 |
| 25° C. | input (mW) | | | | |
| | 5-second | 1004.2 | 602.2 | 858.2 | 614.2 |
| | input (mW) | | | | |
| SOC80%, | 2-second | 498.5 | 232.3 | 423.2 | 218.3 |
| 0° C. | input (mW) | | | | |
| | 5-second | 408.4 | 206.8 | 348.6 | 191.2 |
| | input (mW) | | | | |
| SOC20%, | 2-second | 924.6 | 493.5 | 1079.3 | 696.0 |
| 25° C. | output (mW) | | | | |
| | 5-second | 899.6 | 425.9 | 1057.3 | 659.9 |
| | output (mW) | | | | |
| SOC20%, | 2-second | 305.2 | 175.3 | 354.8 | 207.5 |
| 0° C. | output (mW) | | | | |
| | 5-second | 291.7 | 165.6 | 347.1 | 202.1 |
| | output (mW) | | | | |

| | | | | |
|---|---|---|---|---|
| Battery input density | 6255.0 | 3563.9 | 3762.1 | 2558.4 |
| (W/L): SOC80%, 25° C. | | | | |
| Battery output density | 4497.4 | 2399.6 | 3647.1 | 2352.6 |
| (W/L): SOC20%, 25° C. | | | | |

### Evaluation Example A-10

### DSC Test

Thermophysical property test of the positive electrodes and the electrolytic solutions in the batteries of Example A-1, Example A-2, and Comparative Example A-1 was performed.

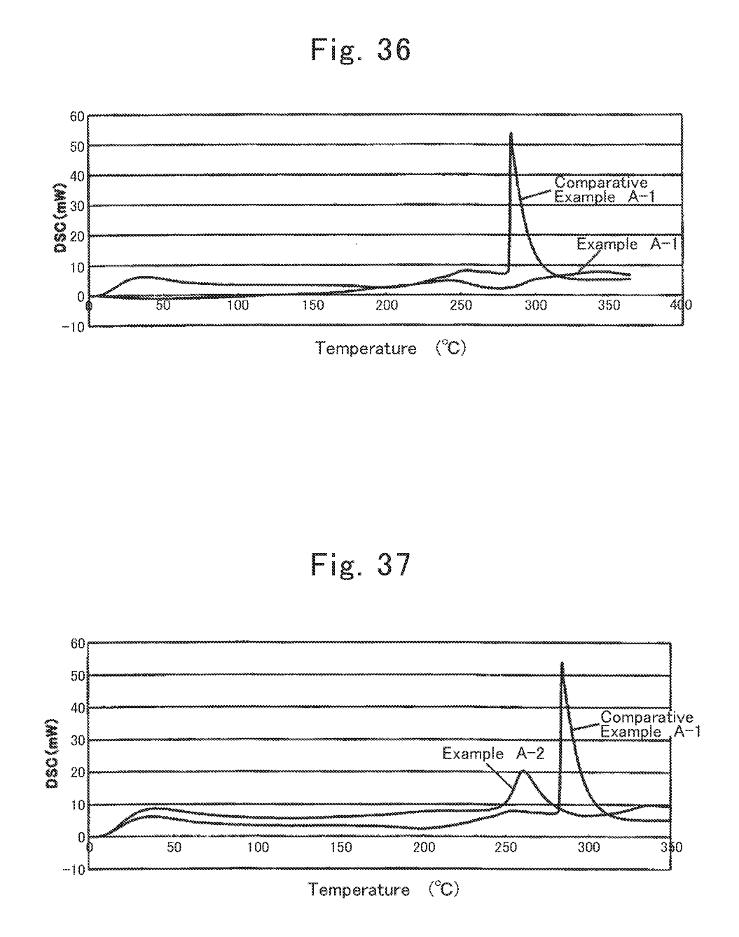

Each of the batteries was fully charged under constant current and constant voltage conditions with a charge cutoff voltage of 4.2 V. The lithium ion secondary battery was disassembled after being fully charged, and the positive electrode thereof was removed. 3 mg of the positive electrode and 1.8 μL of an electrolytic solution were placed in a stainless steel pan, and the pan was sealed. Differential scanning calorimetry analysis was performed using the sealed pan under a nitrogen atmosphere at a temperature increase rate of 20° C./min., and a DSC curve was observed. As a differential scanning calorimeter, Rigaku DSC8230 was used. FIG. 36 shows the results of measurements for Example A-1 and Comparative Example A-1, and FIG. 37 show the results of measurements for Example A-2 and Comparative Example A-1.

As shown in FIGS. 36 and 37, although generation of heat did not occur at around 300° C. in Example A-1, generation of heat occurred at around 300° C. in Comparative Example A-1. The battery of Example A-1 was revealed to have excellent thermophysical property since the reactivity between the electrolytic solution and the positive electrode active material during charging was low.

In the electrolytic solution of Example A-1, since most of acetonitrile, which is the organic solvent having a heteroelement, is forming a cluster with LIFSA, which is the lithium salt; the vapor pressure of the organic solvent contained in the electrolytic solution becomes low. As a result, volatilization of the organic solvent from the electrolytic solution is reduced. In addition, since the amount of solvent is less than ordinary, the potential amount of heat generated when combusted is small. Furthermore, thermophysical property of the electrolytic solution is thought to be excellent since the electrolytic solution itself has poor reactivity with oxygen released from the positive electrode.

The generation of heat at around 300° C. in Comparative Example A-1 is a reaction between the electrolytic solution and the positive electrode, and is thought to be particularly a reaction between the electrolytic solution and oxygen generated from the positive electrode.

As shown in FIG. 37, the electrolytic solution of Example A-2 generated an extremely small amount of heat when compared to the electrolytic solution of Comparative Example A-1. The electrolytic solution of Example A-2 is unlikely to volatize, since Li ions of LiTFSA and solvent molecules are pulling each other through electrostatic attraction, and solvent molecules that are free do not exist. In addition, reaction with the positive electrode active material is unlikely to occur during charging. Thus, the battery of Example A-2 is thought to be excellent in terms of thermophysical property.

### Evaluation Example A-11

### Evaluation of Rate Capacity Characteristic

Rate capacity characteristics were evaluated for Example A-1 and Comparative Example A-1. The capacity of each battery was adjusted to be 160 mAh/g. Regarding the evaluation conditions, at 0.1 C, 0.2 C, 0.5 C, 1 C, and 2 C rates, charging and then discharging were performed, and the capacity (discharge capacity) of the positive electrode was measured at each rate. 1 C refers to a current value required for fully charging or discharging a battery in 1 hour under a constant current. Discharge capacity after performing a 0.1 C-discharge and a 1 C-discharge is shown in Table 13. The discharge capacity shown in Table 13 is a calculated value of capacity per positive electrode weight.

As shown in Table 13, although 0.1 C-discharge capacity was not greatly different between Example A-1 and Comparative Example A-1, 1 C-discharge capacity was larger in Example A-1 than in Comparative Example A-1.

TABLE 13

| | Example A-1 | Comparative Example A-1 |
|---|---|---|
| 0.1 C-discharge capacity | 158.3 | 158.2 |
| 1 C-discharge capacity | 137.5 | 125.0 |

capacity per positive electrode weight was calculated (Unit: mAh/g)

### Example A-5

Electrolytic solution Eli was used as the electrolytic solution of the lithium ion secondary battery of Example A-5. As the positive electrode, the negative electrode, and the separator of the lithium ion secondary battery of Example A-5; similar ones used in embodiment battery A-1 (separator thickness of 20 μm) were used.

### Comparative Example A-3

The positive electrode, the negative electrode, the separator, and the electrolytic solution of the lithium ion secondary battery of Comparative Example A-3 were similar to those in comparative battery A-1.

### Evaluation Example A-12

### Capacity Retention Rate

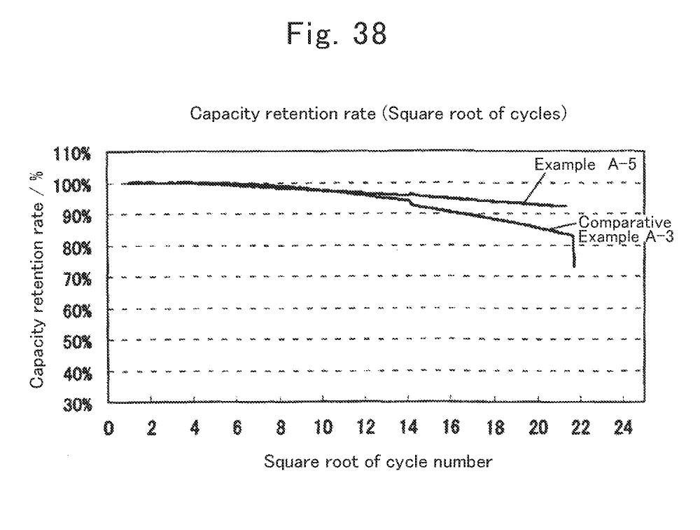

By using the lithium secondary batteries of Example A-5 and Comparative Example A-3, a cycle involving charging to 4.1 V under a condition of CC charging of 1 C at a temperature 25° C., pausing for 1 minute, discharging to 3.0 V with CC discharging of 1 C, and pausing for 1 minute, was repeated for 500 cycles as a cycle test. Discharge capacity retention rate was measured at each of the cycles, and the results are shown in FIG. 38. The discharge capacity retention rate at the 500-th cycle is shown in Table 14. The discharge capacity retention rate is a percentage value of a value obtained by dividing a discharge capacity at each cycle by the first discharge capacity ((Discharge capacity at each cycle)/(First discharge capacity)×100).

As shown in Table 14 and FIG. 38, cycle life improved when DMC was used as the solvent of the electrolytic solution as in the case in Example A-5.

TABLE 14

| | Electrolytic | 500-cycle capacity |
|---|---|---|
| | solution | retention rate |
| Example A-5 | LiFSA/DMC | 92% |
| Comparative Example A-3 | LiPF₆/EC + DEC | 82% |

At the beginning and the 200-th cycle, a direct current resistance (discharging) was measured based on Ohm's law from a current value and an amount of change in voltage (a difference between pre-discharge voltage and voltage obtained 10 seconds after discharging) when CC discharging was performed at 3 C of 10 seconds after adjusting the voltage to 3.5 V at a temperature of 25° C. with a CCCV of 0.5 C.

Furthermore at the beginning and the 200-th cycle, a direct current resistance (charging) was measured based on Ohm's law from a current value and an amount of change of voltage (a difference between pre-charge voltage and voltage obtained 10 seconds after charging) when CC-charging was performed at 3 C for 10 seconds after adjusting the voltage to 3.5 V at a temperature of 25° C. with a CCCV of 0.5 C. The respective results are shown in Table 15.

TABLE 15

| | | Capacity | Direct current resistance (Ω) | | | |
|---|---|---|---|---|---|---|
| | Electrolytic | retention rate | Discharging | | Charging | |
| | solution | (%) | Beginning | 200 cyc | Beginning | 200 cyc |
| Example A-5 | LiFSA/DMC | 92 | 5 | 3.4 | 3.9 | 3.3 |
| Comparative | LiPF₆/EC + DEC | 82 | 6.7 | 6 | 4.3 | 5.5 |
| Example A-3 | | | | | | |

The lithium secondary battery of Example A-5 is understood as to have a small resistance even after the cycles. In addition, the lithium secondary battery of Example A-5 is understood as to have a high capacity retention rate and is unlikely to degrade.

### Evaluation Example A-13

### Confirmation of Elution of Ni, Mn, and Co

By using the lithium ion secondary batteries of Example A-5 and Comparative Example A-3, charging and discharging were repeated for 500 times at a rate of 1 C within a usage voltage range of 3 V to 4.1 V. After charging anddischarging for 500 times, the respective batteries were disassembled, and respective negative electrodes were taken out. Respective amounts of Ni, Mn, and Co eluted to the electrolytic solutions from the positive electrodes, and deposited on the surfaces of the negative electrodes were measured using an ICP (high frequency inductively coupled plasma) emission spectrophotometer. The measurement results are shown in Table 16. The amounts of Ni, Mn, and Co (mass o) in Table 16 show, in %, respective masses of Ni, Mn, and Co per 1 g of the respective negative electrode active material layers. The amounts of Ni, Mn, and Co (pg/sheet) show respective masses (μg) of Ni, Mn, and Co per single sheet of the respective negative electrode active material layers, and were calculated from a calculation formula of: amount of Ni, Mn, and Co (mass %)/100×mass of single sheet of each negative electrode active material layer=amount of Ni, Mn, and Co (μg/sheet).

TABLE 16

| | Manganese | | Cobalt | | Nickel | |
|---|---|---|---|---|---|---|
| | mass % | μg/sheet | mass % | μg/sheet | mass % | μg/sheet |
| Example A-5 | <0.002 | <0.4 | <0.002 | <0.5 | <0.01 | <2 |
| Comparative | 0.011 | 3.9 | 0.005 | 1.7 | 0.02 | 6 |
| Example A-3 | | | | | | |

* “<” indicates being equal to or lower than quantifiable lower limit value.

As shown in Table 16, the negative electrode of Example A-5 had less amounts of Ni, Mn, and Co (mass o) and less amounts of Ni, Mn, and Co (μg/sheet) when compared to the negative electrode of Comparative Example A-3. When the results shown in Table 16 and the results shown in Table 15 were combined, Example A-5 is understood as to have less elution of metal from the positive electrode, less deposition of the metal eluted from the positive electrode to the negative electrode, and a high capacity retention rate, when compared to Comparative Example A-3.

### Evaluation Example A-14

### Weight per area of Electrode and Output Characteristics

Example A-6 and Comparative Example A-4 which are targets for evaluation in Evaluation Example A-14 are respectively different from the batteries of Example A-1 and Comparative Example A-1 in terms of the weight per areas of the positive electrodes. Regarding Example A-6 and Comparative Example A-4, the weight per areas of the respective positive electrodes was set to 5.5 mg/cm², and the weight per areas of the negative electrodes was set to 4 mg/cm². The weight per areas of the electrodes were half of the weight per area of the electrode of the battery used for the evaluations of input characteristics and output characteristics in (1) to (5) of Evaluation Example A-18, i.e., half of the battery capacity. Input-output characteristics of each of the batteries were measured using the following three conditions. The measurement results are shown in Table 17.

<Measuring Condition>

State of charge (SOC) of 30%, −30° C., usage voltage range of 3 V to 4.2 V, 2-second output

State of charge (SOC) of 30%, −10° C., usage voltage range of 3 V to 4.2 V, 2-second output

State of charge (SOC) 80%, 25° C., usage voltage range of 3 V to 4.2 V, 5-second input

TABLE 17

| | Temperature | −30° C. | −10° C. | 25° C. |
|---|---|---|---|---|
| | SOC | 30% | 30% | 80% |
| | Electrolytic | 2-second | 2-second | 5-second |
| | solution | output | output | input |
| Example A-6 | AN/FSA | 85 mW | 329 mW | 890 mW |
| Comparative Example | LiPF6 | 45 mW | 161 mW | 684 mW |
| A-4 | | | | |

As shown in Table 17, even in the case where the weight per area of the electrode was set to half of the batteries used in the evaluation of (1) to (5), input-output characteristics improved when the electrolytic solution of Example A-6 was used, compared to the electrolytic solution of Comparative Example A-4.

(Battery A-1)

A lithium ion secondary battery of battery A-1 has the same configuration as the lithium ion secondary battery of Example A-1.

Thus, the electrolytic solution used in battery A-1 is electrolytic solution E8. The positive electrode includes: a positive electrode active material layer including 90 parts by mass of LiNi_{0.5}Co_{0.2}Mn_{0.3}O₂ (NCM253) which is the positive electrode active material, 8 parts by mass of acetylene black (AB) which is the conductive additive, and 2 parts by mass of polyvinylidene fluoride (PVdF) which is the binding agent; and an aluminum foil (JIS A1000 series) having a thickness of 20 μm formed of a positive electrode current collector.

The negative electrode used in battery A-1 includes: a negative electrode active material layer including 98 parts by mass of natural graphite which is the negative electrode active material, and 1 part by mass of SBR and 1 part by mass of CMC, which are binding agents; and a copper foil having a thickness of 20 μm as the negative electrode current collector.

The separator used in battery A-1 is a cellulose nonwoven fabric having a thickness of 20 μm.

(Battery A-2)

A lithium ion secondary battery of battery A-2 was obtained by using electrolytic solution E11.

The lithium ion secondary battery of battery A-2 was identical to the lithium ion secondary battery of battery A-1, except for the mixing ratio of the positive electrode active material, the conductive additive, and the binding agent, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

(Battery A-3)

A lithium ion secondary battery of battery A-3 was obtained by using electrolytic solution E13. The lithium ion secondary battery of battery A-3 was identical to the lithium ion secondary battery of battery A-1 except for the mixing ratio of the positive electrode active material, the conductive additive, and the binding agent, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

(Battery A-C1)

A lithium ion secondary battery of battery A-C1 was obtained by using electrolytic solution C5. The lithium ion secondary battery of battery A-C1 was identical to the lithium ion secondary battery of battery A-1 except for the type of the electrolytic solution, the mixing ratio of the positive electrode active material, the conductive additive, and the binding agent, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

### Evaluation Example A-15

### Internal Resistance of Battery

The lithium ion secondary batteries of batteries A-1 to A-3 and A-C1 were prepared, and internal resistances of the respective batteries were evaluated.

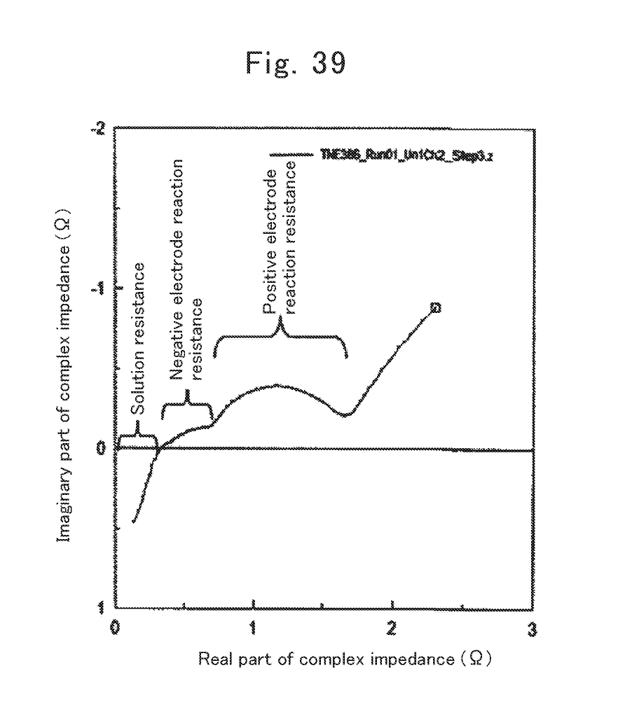

With each of the lithium ion secondary batteries of batteries A-1 to A-3 and A-C1, CC charging and discharging, i.e., constant current charging and discharging, were repeated at room temperature in a range of 3.0 V to 4.1V (vs. Li reference). Then, an alternating current impedance after the first charging and discharging and an alternating current impedance after 100 cycles were measured. Based on obtained complex impedance planar plots, reaction resistances of electrolytic solutions, negative electrodes, and positive electrodes were each analyzed. As shown in FIG. 39, two circular arcs were observed in a complex impedance planar plot. A circular arc on the left side of the figure (i.e., a side in which the real part of complex impedance is smaller) is referred to as a first circular arc. A circular arc on the right side of the figure is referred to as a second circular arc. Reaction resistance of a negative electrode was analyzed based on the size of the first circular arc, and reaction resistance of a positive electrode was analyzed based on the size of the second circular arc. Resistance of an electrolytic solution was analyzed based on a plot continuing from the first circular arc toward the leftmost side in FIG. 39. The analysis results are shown in Tables 18 and 19. Table 18 shows a resistance of an electrolytic solution (i.e., solution resistance), a reaction resistance of a negative electrode, a reaction resistance of a positive electrode, and a diffusion resistance after the first charging and discharging. Table 19 shows respective resistances after 100 cycles.

TABLE 18
<Initial alternating-current resistance> Unit: Ω

| | | Bat- | Bat- | Bat- | Bat- |
|---|---|---|---|---|---|
| | | tery | tery | tery | tery |
| | | A-1 | A-2 | A-3 | A-C1 |
| Electrolytic | Organic | AN | DMC | DMC | EC/ |
| solution | solvent | | | | DEC |
| | Metal salt | LiFSA | LiFSA | LiFSA | LiPF₆ |

| | | | | |
|---|---|---|---|---|
| Solution resistance | 0.3 | 0.5 | 0.4 | 0.3 |
| Negative-electrode reaction resistance | 0.4 | 0.5 | 0.4 | 0.4 |
| Positive-electrode reaction resistance | 0.1 | 0.5 | 0.5 | 1.0 |
| Diffusion resistance | 0.4 | 0.7 | 0.7 | 0.7 |

TABLE 19
<Alternating-current resistance after 100 cycles> Unit: Ω

| | | Bat- | Bat- | Bat- | Bat- |
|---|---|---|---|---|---|
| | | tery | tery | tery | tery |
| | | A-1 | A-2 | A-3 | A-C1 |
| Electrolytic | Organic | AN | DMC | DMC | EC/ |
| solution | solvent | | | | DEC |
| | Metal salt | LiFSA | LiFSA | LiFSA | LiPF₆ |

| | | | | |
|---|---|---|---|---|
| Solution resistance | 0.3 | 0.5 | 0.3 | 0.3 |
| Negative-electrode reaction resistance | 0.2 | 0.4 | 0.3 | 0.4 |
| Positive-electrode reaction resistance | 0.3 | 0.2 | 0.2 | 0.6 |
| Diffusion resistance | 0.5 | 0.6 | 0.5 | 0.6 |

As shown in Tables 18 and 19, in each of the lithium ion secondary batteries, the reaction resistances of the negative and positive electrodes tended to decrease after 100 cycles when compared to respective resistances after the first charging and discharging. After 100 cycles as shown in Table 19, the reaction resistances of the negative and positive electrodes of the lithium ion secondary batteries of batteries A-1 to A-3 were lower compared to the reaction resistances of the negative and positive electrodes of the lithium ion secondary battery of battery A-C1.

As described above, the lithium ion secondary batteries of batteries A-1 and A-2 were obtained by using the electrolytic solution of the present invention, and S,O-containing coatings derived from the electrolytic solution of the present invention were formed on the surfaces of the negative electrodes and the positive electrodes. On the other hand, in the lithium ion secondary battery of battery A-C1 in which the electrolytic solution of the present invention was not used, the S, 0-containing coating was not formed on the surfaces of the negative electrode and the positive electrode. In addition, the reaction resistances of the negative and positive electrodes of batteries A-1 and A-2 were lower than those of the lithium ion secondary battery of battery A-Cl. Based on this, the reaction resistances of the negative and positive electrodes are speculated to be lowered because of the existence of the S,O-containing coating derived from the electrolytic solution of the present invention in batteries A-1 to A-3.

The solution resistances of the electrolytic solutions in the lithium ion secondary batteries of batteries A-2 and A-C1 were almost identical, whereas the solution resistance of the electrolytic solution of the lithium ion secondary battery of battery A-1 was higher compared to those of batteries A-2 and A-C1. In addition, the solution resistance of each of the electrolytic solutions of the lithium ion secondary batteries was comparable between after the first charging and discharging and after 100 cycles. Thus, deterioration in durability is considered not to be occurring in each of the electrolytic solutions. The difference that emerged between the reaction resistances of the negative and positive electrodes in batteries A-C1 and A-1 to A-3 is considered to be occurring in the electrode itself and not related to deterioration in durability of the electrolytic solution.

Internal resistance of a lithium ion secondary battery is comprehensively determined from a solution resistance of an electrolytic solution, a reaction resistance of a negative electrode, and a reaction resistance of a positive electrode. Based on the results of Tables 18 and 19 and from a standpoint of suppressing an increase in internal resistance of a lithium ion secondary battery, the lithium ion secondary battery of battery A-1 are considered to excel the most in terms of durability, and the lithium ion secondary battery of battery A-2 is considered to excel the next in terms of durability.

### Evaluation Example A-16

### Cycle Durability of Battery

With each of the lithium ion secondary batteries of batteries A-1 to A-3 and A-C1, CC charging and discharging were repeated at room temperature in a range of 3.0 V to 4.1 V (vs. Li reference), and a discharge capacity at the first charging and discharging, a discharge capacity at the 100-th cycle, and a discharge capacity at the 500-th cycle were measured. When a capacity of each of the lithium ion secondary batteries at the first charging and discharging was defined as 100%, capacity retention rates (%) of each of the lithium ion secondary batteries at the 100-th cycle and the 500-th cycle were calculated. The results are shown in Table 20.

TABLE 20

| | | Bat- | Bat- | Bat- | Bat- |
|---|---|---|---|---|---|
| | | tery | tery | tery | tery |
| | | A-1 | A-2 | A-3 | A-C1 |
| Electrolytic | Organic | AN | DMC | DMC | EC/DEC |
| solution | solvent | | | | |
| | Metal salt | LiFSA | LiFSA | LiFSA | LiPF₆ |
| Capacity retention | 100 cycle | 92 | 97 | 97 | 96 |
| rate | | | | | |
| (%) | 500 cycle | 67 | 90 | — | 85 |

As shown in Table 20, the lithium ion secondary batteries of batteries A-1 and A-2, even though not containing EC that becomes a material of SEI, showed a capacity retention rate comparable to that of the lithium ion secondary battery of battery A-C1 containing EC. The reason may be that the S,O-containing coating derived from the electrolytic solution of the present invention exists on the positive electrode and the negative electrode of each of the lithium ion secondary batteries of batteries A-1 and A-2. The lithium ion secondary battery of battery A-2 showed an extremely high capacity retention rate particularly even after 500 cycles, and was particularly excellent in durability. Based on this result, durability is considered to improve more when DMC is selected as the organic solvent of the electrolytic solution compared to when AN is selected.

(Battery A-4)

A half-cell using electrolytic solution E8 was produced in the following manner.

90 parts by mass of graphite which is an active material and whose mean particle diameter is 10 μm was mixed with 10 parts by mass of polyvinylidene fluoride which is a binding agent. The mixture was dispersed in a proper amount of N-methyl-2-pyrrolidone to create a slurry. As the current collector, a copper foil having a thickness of 20 μm was prepared. The slurry was applied in a film form on the surface of the copper foil by using a doctor blade. The copper foil on which the slurry was applied was dried to remove N-methyl-2-pyrrolidone, and then the copper foil was pressed to obtain a joined object. The obtained joined object was heated and dried in a vacuum dryer for 6 hours at 120° C. to obtain a copper foil having the active material layer formed thereon . This was used as the working electrode. The mass of the active material per 1 cm² of the copper foil was 1.48 mg. In addition, the density of graphite and polyvinylidene fluoride before pressing was 0.68 g/cm³, whereas the density of the active material layer after pressing was 1.025 g/cm³.

Metal Li was used as the counter electrode.

The working electrode, the counter electrode, and electrolytic solution E8 were housed in a battery case (CR2032 type coin cell case manufactured by Hohsen Corp.) having a diameter of 13.82 mm to form a half-cell. This was used as a half-cell of battery A-4.

(Battery A-5)

A half-cell of battery A-5 was produced with a method similar to that for battery A-4, except for using electrolytic solution E11.

(Battery A-6)

A half-cell of battery A-6 was produced with a method similar to that for battery A-4, except for using electrolytic solution E16.

(Battery A-7)

A half-cell of battery A-7 was produced with a method similar to that for battery A-4, except for using the electrolytic solution of electrolytic solution E19.

(Battery A-C2)

A half-cell of battery A-C2 was produced with a method similar to that for battery A-4, except for using electrolytic solution C5.

### Evaluation Example A-17

### Rate Characteristics

Rate characteristics of the half-cells of batteries A-4 to A-7 and A-C2 were tested using the following method.

With respect to the half-cells, at 0.1 C, 0.2 C, 0.5 C, 1 C, and 2 C rates (1 C refers to a current required for fully charging or discharging a battery in 1 hour under a constant current), charging and then discharging were performed, and the capacity (discharge capacity) of the working electrode was measured at each rate. In the description here, the counter electrode was regarded as the negative electrode and the working electrode was regarded as the positive electrode. With respect to the capacity of the working electrode at 0.1 C rate, proportions of capacities (rate characteristics) at other rates were calculated. The results are shown in Table 21.

TABLE 21

| | Battery | Battery | Battery | Battery | Battery |
|---|---|---|---|---|---|
| | A-4 | A-5 | A-6 | A-7 | A-C2 |
| 0.2 C capacity/0.1 C | 0.982 | 0.981 | 0.981 | 0.985 | 0.974 |
| capacity | | | | | |
| 0.5 C capacity/0.1 C | 0.961 | 0.955 | 0.956 | 0.960 | 0.931 |
| capacity | | | | | |
| 1 C capacity/0.1 C | 0.925 | 0.915 | 0.894 | 0.905 | 0.848 |
| capacity | | | | | |
| 2 C capacity/0.1 C | 0.840 | 0.777 | 0.502 | 0.538 | 0.575 |
| capacity | | | | | |

When compared to the half-cell of battery A-C1, since decrease in capacity was suppressed at rates of 0.2 C, 0.5 C, and 1 C in the half-cells of batteries A-4 to A-7, and at 2 C rate in batteries A-4 and A-5, the half-cells of batteries A-4 to A-7 were confirmed to display excellent rate characteristics.

### Evaluation Example A-18

### Capacity Retention Rate

Capacity retention rate of each of the half-cells of batteries A-4 to A-7 and A-C2 was tested using the following method.

With respect to the respective half-cells, a charging/discharging cycle from 2.0 V to 0.01 V of CC charging (constant current charging) to a voltage of 2.0 V and CC discharging (constant current discharging) to a voltage of 0.01 V was performed at 25° C. for three cycles at a charging/discharging rate of 0.1 C. Then, charging and discharging were performed for three cycles at respective charging/discharging rates of 0.2 C, 0.5 C, 1 C, 2 C, 5 C, and 10 C, sequentially. Lastly, charging and discharging were performed for three cycles at 0.1 C. Capacity retention rate (%) of each of the half-cells was obtained from the following formula.

Capacity Retention Rate (%)=B/A×100

A: Second discharge capacity of the working electrode in the first charging/discharging cycle at 0.1 C

B: Second discharge capacity of the working electrode in the last charging/discharging cycle at 0.1 C

The results are shown in Table 22. In the description here, the counter electrode was regarded as the negative electrode and the working electrode was regarded as the positive electrode.

TABLE 22

| | Battery | Battery | Battery | Battery | Battery |
|---|---|---|---|---|---|
| | A-4 | A-5 | A-6 | A-7 | A-C2 |
| Capacity retention rate | 98.1 | 98.7 | 98.9 | 99.8 | 98.8 |
| (%) | | | | | |

All the half-cells performed the charging/discharging reaction finely, and displayed suitable capacity retention rate. In particular, capacity retention rate was significantly superior in the half-cells of batteries A-5, A-6, and A-7.

(Battery A-8)

A lithium ion secondary battery of battery A-8 using electrolytic solution E8 was similar to the lithium ion secondary battery of battery A-1 described above. The component formulation ratio in the positive electrode active material layer was NCM523:AB:PVdF=94:3:3, and a filter paper for experiments (Toyo Roshi Kaisha, Ltd., made from cellulose, thickness of 260 μm) was used as the separator. The concentration of (FSO₂)₂NLi in electrolytic solution E8 in the lithium ion secondary battery of battery A-8 was 4.5 mol/L. In electrolytic solution E8, 2.4 molecules of acetonitrile were contained with respect to 1 molecule of (FSO₂)₂NLi.

(Battery A-9)

The lithium ion secondary battery of battery A-9 was identical to the lithium ion secondary battery of battery A-8, except for using electrolytic solution E4 as the electrolytic solution. The electrolytic solution in the lithium ion secondary battery of battery A-9 is obtained by dissolving (SO₂CF₃)₂NLi (LiTFSA), which serves as the supporting salt, in acetonitrile, which serves as the solvent . The concentration of the lithium salt contained in 1 liter of the electrolytic solution was 4.2 mol/L. The electrolytic solution contains 2 molecules of acetonitrile with respect to 1 molecule of the lithium salt.

(Battery A-10)

The lithium ion secondary battery of battery A-10 was identical to the lithium ion secondary battery of battery A-8, except for using electrolytic solution E11 as the electrolytic solution. The electrolytic solution in the lithium ion secondary battery of battery A-10 is obtained by dissolving LiFSA, which serves as the supporting salt, in DMC, which serves as the solvent. The concentration of the lithium salt contained in 1 liter of the electrolytic solution was 3.9 mol/L. The electrolytic solution contains 2 molecules of DMC with respect to 1 molecule of the lithium salt.

(Battery A-11)

A lithium ion secondary battery of battery A-11 was obtained by using electrolytic solution E11. The lithium ion secondary battery of battery A-11 was identical to the lithium ion secondary battery of battery A-8, except for the type of the electrolytic solution, the mixing ratio of the positive electrode active material, the conductive additive, and the binding agent, the mixing ratio of the negative electrode active material and the binding agent, and the separator. In the positive electrode, NCM523 was used as the positive electrode active material, AB was used as the conductive additive for the positive electrode, and PVdF was used as the binding agent . These were similar to those of battery A-8. The blend ratio of those was NCM523:AB:PVdF=90:8:2. The active material layer of the positive electrode had a weight per area of 5.5 mg/cm² and a density of 2.5 g/cm³. The same applies for the following batteries A-12 to A-15 and A-C3 to A-C5.

In the negative electrode, natural graphite was used as the negative electrode active material, and SBR and CMC were used as the binding material for the negative electrode. These are also similar to those of battery A-8. The blend ratio of those was natural graphite:SBR:CMC=98:1:1. The active material layer of the negative electrode had a weight per area of 3.8 mg/cm² and a density of 1.1 g/cm³. The same applies for the following batteries A-12 to A-15 and A-C3 to A-C5.

As the separator, a cellulose nonwoven fabric having a thickness of 20 μm was used.

The electrolytic solution in the lithium ion secondary battery of battery A-11 was obtained by dissolving LiFSA, which serves as the supporting salt, in DMC, which serves as the solvent. The concentration of the lithium salt contained in 1 liter of the electrolytic solution was 3.9 mol/L. The electrolytic solution contains 2 molecules of DMC with respect to 1 molecule of the lithium salt.

(Battery A-12)

A lithium ion secondary battery of battery A-12 was obtained by using electrolytic solution E8. The lithium ion secondary battery of battery A-12 was identical to the lithium ion secondary battery of battery A-8, except for the mixing ratio of the positive electrode active material, the conductive additive, and the binding agent, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

(Battery A-13)

A lithium ion secondary battery of battery A-13 was obtained by using electrolytic solution E11. The lithium ion secondary battery of battery A-13 was identical to the lithium ion secondary battery of battery A-8, except for the type of the electrolytic solution, the mixing ratio of the positive electrode active material, the conductive additive, and the binding agent, the type of the binding material for the negative electrode, the mixing ratio of the negative electrode active material and the binding agent, and the separator. NCM523:AB:PVdF=90:8:2 was used for the positive electrode. In the negative electrode, natural graphite was used as the negative electrode active material, and polyacrylic acid (PAA) was used as the binding material for the negative electrode. The blend ratio of those was natural graphite:PAA=90:10. As the separator, a cellulose nonwoven fabric having a thickness of 20 μm was used.

(Battery A-14)

A lithium ion secondary battery of battery A-14 was obtained by using electrolytic solution E8. The lithium ion secondary battery of battery A-14 was identical to the lithium ion secondary battery of battery A-8, except for the mixing ratio of the positive electrode active material, the conductive additive, and the binding agent, the type of the binding material for the negative electrode, the mixing ratio of the negative electrode active material and the binding agent, and the separator. NCM523:AB:PVdF=90:8:2 was used for the positive electrode. Natural graphite:PAA=90:10 was used for the negative electrode. As the separator, a cellulose nonwoven fabric having a thickness of 20 μm was used.

(Battery A-15)

A lithium ion secondary battery of battery A-15 was obtained by using electrolytic solution E13. The lithium ion secondary battery of battery A-15 was identical to the lithium ion secondary battery of battery A-1, except for the mixing ratio of the positive electrode active material and the conductive additive, the type of the binding material for the negative electrode, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

(Battery A-C3)

A lithium ion secondary battery of battery A-C3 was similar to that of battery A-1 except for using electrolytic solution C5.

(Battery A-C4)

A lithium ion secondary battery of battery A-C4 was obtained by using electrolytic solution C5. The lithium ion secondary battery of battery A-C4 was identical to the lithium ion secondary battery of battery A-1, except for the type of the electrolytic solution, the mixing ratio of the positive electrode active material, the conductive additive, and the binding agent, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

(Battery A-C5)

A lithium ion secondary battery of battery A-C5 was obtained by using electrolytic solution C5. The lithium ion secondary battery of battery A-C5 was identical to the lithium ion secondary battery of battery A-1, except for the type of the electrolytic solution, the mixing ratio of the positive electrode active material, the conductive additive, and the binding agent, the type of the binding material for the negative electrode, the mixing ratio of the negative electrode active material and the binding agent, and the separator. NCM523:AB:PVdF=90:8:2 was used for the positive electrode. Natural graphite:PAA=90:10 was used for the negative electrode. As the separator, a cellulose nonwoven fabric having a thickness of 20 μm was used.

The configuration of a battery in each of the batteries is shown in Table 23.

TABLE 23

| | | | | | | Positive |
|---|---|---|---|---|---|---|
| | Positive | Negative electrode | | | | electrode |
| | electrode | Natural | Natural | Electrolytic | | current |
| | NCM:AB:PVdF | graphite:SBR:CMC | graphite:PAA | solution | Separator | collector |
| Battery | 94:3:3 | 98:1:1 | | Electrolytic | 260 μm-filter | Al current |
| A-8 | | | | solution E8 | paper for | collector |
| | | | | | experiments | |
| Battery | 94:3:3 | 98:1:1 | | Electrolytic | 260 μm-filter | Al current |
| A-9 | | | | solution E4 | paper for | collector |
| | | | | | experiments | |
| Battery | 94:3:3 | 98:1:1 | | Electrolytic | 260 μm-filter | Al current |
| A-10 | | | | solution E11 | paper for | collector |
| | | | | | experiments | |
| Battery | 90:8:2 | 98:1:1 | | Electrolytic | 20 μm- | Al current |
| A-11 | | | | solution E11 | cellulose | collector |
| | | | | | nonwoven | |
| | | | | | fabric | |
| Battery | 90:8:2 | 98:1:1 | | Electrolytic | 20 μm- | Al current |
| A-12 | | | | solution E8 | cellulose | collector |
| | | | | | nonwoven | |
| | | | | | fabric | |
| Battery | 90:8:2 | | 90:10 | Electrolytic | 20 μm- | Al current |
| A-13 | | | | solution E11 | cellulose | collector |
| | | | | | nonwoven | |
| | | | | | fabric | |
| Battery | 90:8:2 | | 90:10 | Electrolytic | 20 μm- | Al current |
| A-14 | | | | solution E8 | cellulose | collector |
| | | | | | nonwoven | |
| | | | | | fabric | |
| Battery | 90:8:2 | 98:1:1 | | Electrolytic | 20 μm- | Al current |
| A-15 | | | | solution E13 | cellulose | collector |
| | | | | | nonwoven | |
| | | | | | fabric | |
| Battery | 94:3:3 | 98:1:1 | | Electrolytic | 260 μm-filter | Al current |
| A-C3 | | | | solution C5 | paper for | collector |
| | | | | | experiments | |
| Battery | 90:8:2 | 98:1:1 | | Electrolytic | 20 μm- | Al current |
| A-C4 | | | | solution C5 | cellulose | collector |
| | | | | | nonwoven | |
| | | | | | fabric | |
| Battery | 90:8:2 | | 90:10 | Electrolytic | 20 μm- | Al current |
| A-C5 | | | | solution C5 | cellulose | collector |
| | | | | | nonwoven | |
| | | | | | fabric | |

### Evaluation Example A-19

### Analysis of S,O-Containing Coating

Hereinafter, if necessary, an S,O-containing coating formed on each of the surfaces of the negative electrodes in the lithium ion secondary batteries of batteries A-8 to A-15 is abbreviated as a negative-electrode S,O-containing coating of each of the batteries, and a coating formed on the each of the surfaces of the negative electrodes in the lithium ion secondary batteries of batteries A-C3 to A-C5 is abbreviated as a negative-electrode coating of each of the batteries.

In addition, if necessary, a coating formed on each of the surfaces of the positive electrodes in the lithium ion secondary batteries of batteries A-8 to A-15 is abbreviated as a positive-electrode S,O-containing coating of each of the batteries A-8 to A-15, and a coating formed on each of the surfaces of the positive electrodes in the lithium ion secondary batteries of the batteries A-C3 to A-C5 is abbreviated as a positive-electrode coating of each of the batteries A-C3 to A-C5.

(Analysis of Negative-Electrode S,O-Containing Coating and Negative-Electrode Coating)

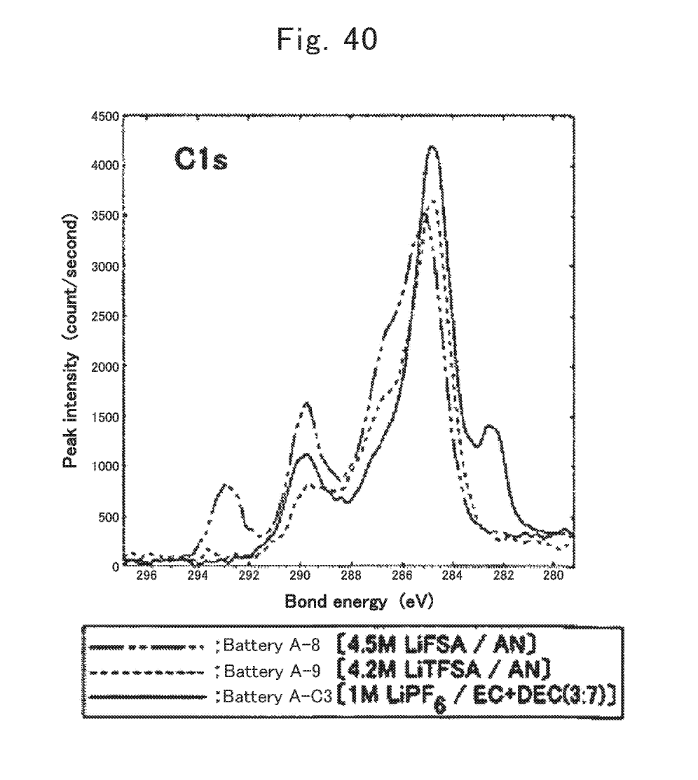

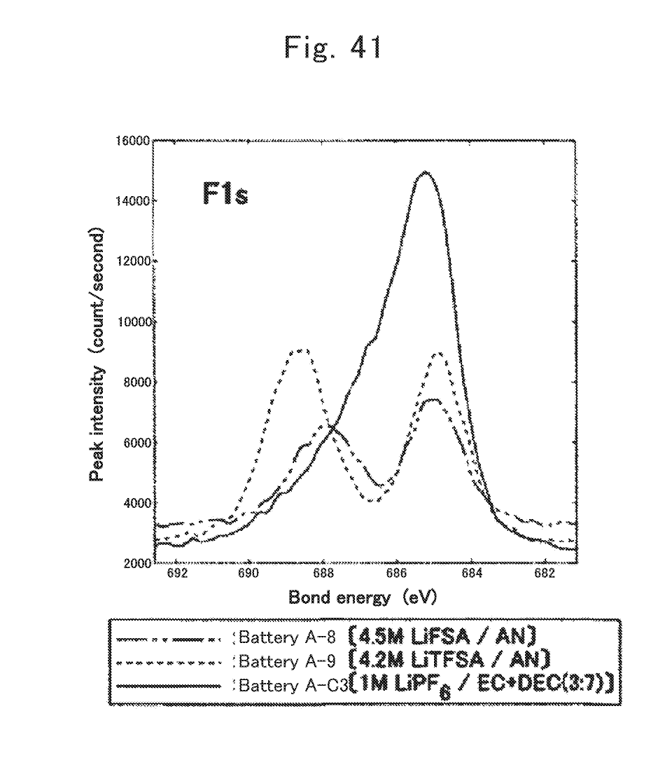

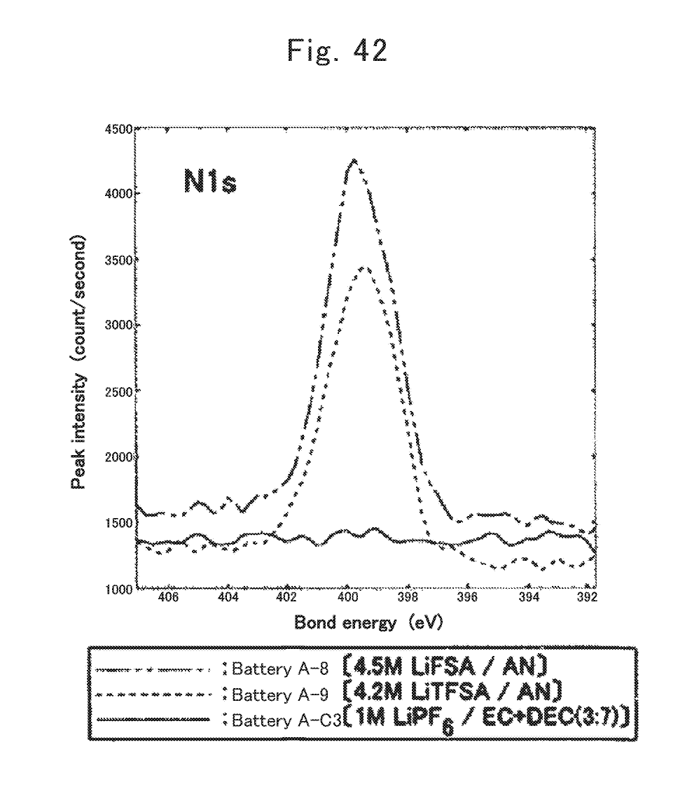

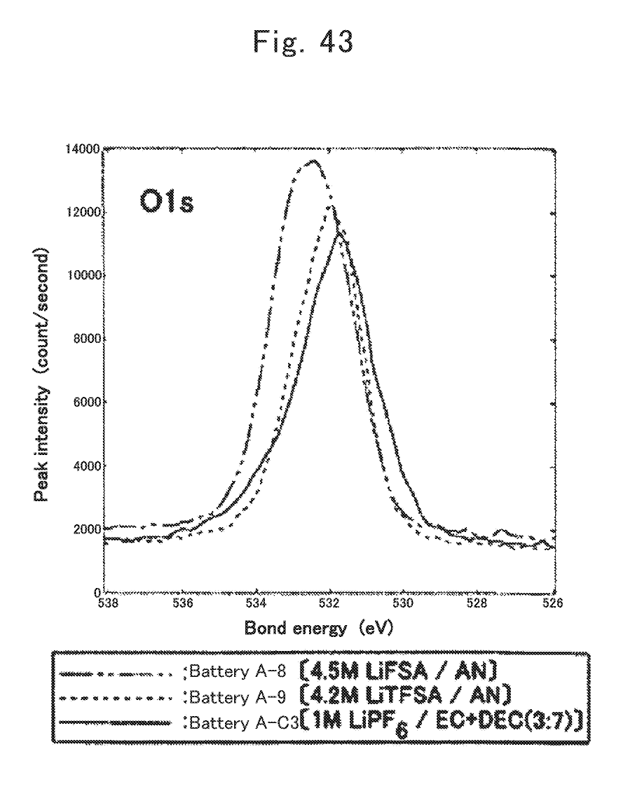

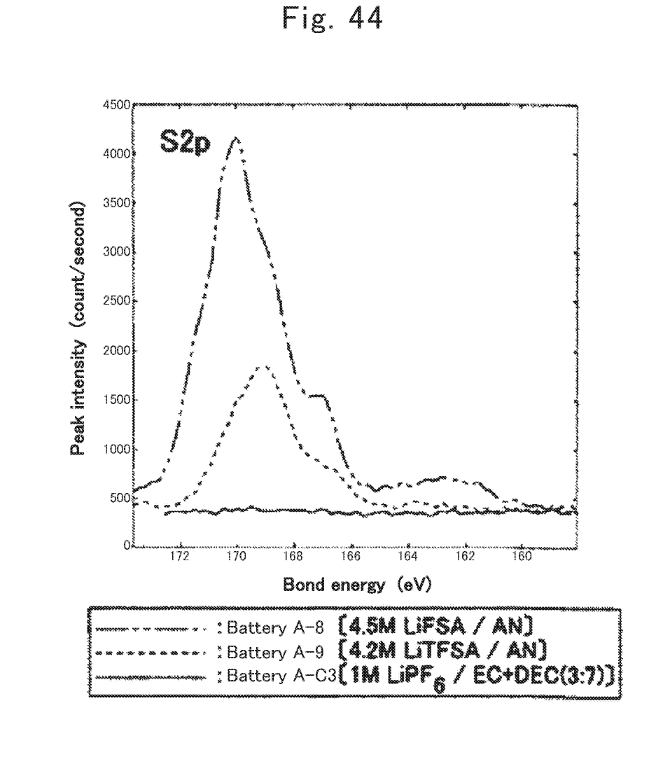

With respect to the lithium ion secondary batteries of batteries A-8, A-9, and A-C3, charging and discharging were repeated for 100 cycles, and analysis of the surfaces of the S,O-containing coating or the coating was performed using X-ray photoelectron spectroscopy (XPS) at a discharged state with a voltage of 3.0 V. As a pre-treatment, the following treatment was performed. Firstly, a lithium ion secondary battery was disassembled to extract a negative electrode, and the negative electrode was rinsed and dried to obtain the negative electrode that was a subject for analysis. The rinsing was performed for three times using DMC (dimethyl carbonate). In addition, all the steps from disassembling the cell to transporting the negative electrode as the subject for analysis into an analysis device were performed under an Ar gas atmosphere without exposing the negative electrode to air. The following pre-treatment was performed on each of the lithium ion secondary batteries of batteries A-8, A-9, and A-C3, and XPS analysis was performed on an obtained negative electrode sample. As the device, PHI 5000 VersaProbe II of ULVAC-PHI, Inc., was used. The X-ray source was monochromatic Al K-alpha radiation (15 kV, 10 mA). The analysis results of the negative-electrode S,O-containing coatings of batteries A-8 and A-9 and the negative-electrode coating of battery A-C3 measured through XPS are shown in FIGS. 40 to 44. Specifically, FIG. 40 shows the results of analysis regarding carbon element, FIG. 41 shows the results of analysis regarding fluorine element, FIG. 42 shows the results of analysis regarding nitrogen element, FIG. 43 shows the results of analysis regarding oxygen element, and FIG. 44 shows the results of analysis regarding sulfur element.

The electrolytic solution in the lithiumion secondary battery of battery A-8 and the electrolytic solution in the lithium ion secondary battery of battery A-9 include sulfur element (S), oxygen element, and nitrogen element (N) in the salts. On the other hand, the electrolytic solution in the lithium ion secondary battery of battery A-C3 does not include these in the salt. Furthermore, the electrolytic solutions in the lithium ion secondary batteries of batteries A-8, A-9, and A-C3 all include fluorine element (F), carbon element (C), and oxygen element (O) in the salts.

As shown in FIGS. 40 to 44, as a result of the analysis on the negative-electrode S,O-containing coating of battery A-8 and the negative-electrode S,O-containing coating of battery A-9, a peak indicating the existence of S (FIG. 44) and a peak indicating the existence of N (FIG. 42) were observed. Thus, the negative-electrode S,O-containing coating of battery A-8 and the negative-electrode S,O-containing coating of battery A-9 included S and N. However, these peaks were not identified in the analysis results of the negative-electrode coating of battery A-C3. Thus, the negative-electrode coating of battery A-C3 did not include any of S and N at an amount equal to or more than a detection limit. The peaks indicating the existence of F, C, and O were observed in all the analysis results regarding the negative-electrode S,O-containing coatings of batteries A-8 and A-9, and the negative-electrode coating of battery A-C3. Thus, the negative-electrode S,O-containing coatings of batteries A-8 and A-9 and the negative-electrode coating of battery A-C3 all included F, C, and O.

These elements are all components derived from the electrolytic solution. In particular, S, O, and F are components included in the metal salt of the electrolytic solution, more specifically, components included in the chemical structure of the anion of the metal salt. Based on these results, the negative-electrode S,O-containing coatings and the negative-electrode coatings are understood as to include components derived from the chemical structure of the anion of the metal salt (i.e., supporting salt).

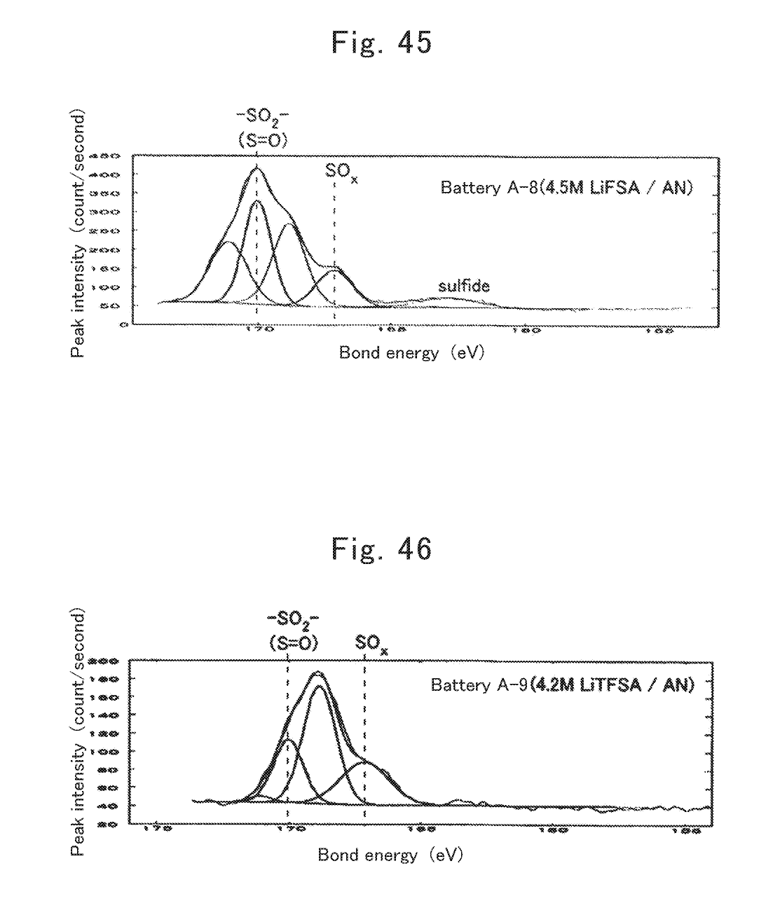

Detailed analysis was further performed on the analysis result regarding sulfur element (S) shown in FIG. 44. With respect to the analysis result of batteries A-8 and A-9, peak resolution was performed using mixed Gaussian/Lorentzian function. The analysis results of batteries A-8 and A-9 are respectively shown in FIGS. 45 and 46.

As shown in FIGS. 45 and 46, as a result of analyzing the negative-electrode S,O-containing coatings of batteries A-8 and A-9, a relatively large peak (waveform) was observed at around 165 to 175 eV. Then, as shown in FIGS. 45 and 46, this peak (waveform) at around 170 eV was separated into four peaks. Among these, one is a peak around 170 eV indicating the existence of SO₂ (S═O structure). Based on this result, the S,O-containing coating formed on the surface of the negative electrode in the lithium ion secondary battery of the present invention is considered to have a S═O structure. When this result and the XPS analysis results described above are considered, S included in the S═O structure of the S,O-containing coating is speculated to be S included in the chemical structure of the anion of the metal salt, i.e., supporting salt.

(S Element Ratio in Negative-Electrode S,O-Containing Coating)

Based on the XPS analysis results of the negative-electrode S,O-containing coatings described above, the ratio of S element at the discharged state in the negative-electrode S,O-containing coatings of battery A-8 and battery A-9 and the negative-electrode coating of battery A-C3 were calculated. Specifically, with respect to each of the negative-electrode S,O-containing coatings and the negative-electrode coating, the element ratio of S was calculated when the total of peak intensities of S, N, F, C, and O were defined as 100%. The results are shown in Table 24.

TABLE 24

| | Battery A-8 | Battery A-9 | Battery A-C3 |
|---|---|---|---|
| S element ratio (at. %) | 10.4 | 3.7 | 0.0 |

As described above, although the negative-electrode coating of battery A-C3 did not include S at an amount equal to or more than the detection limit, S was detected in the negative-electrode S,O-containing coating of battery A-8 and the negative-electrode S,O-containing coating of battery A-9. In addition, the negative-electrode S,O-containing coating of battery A-8 included more S than the negative-electrode S,O-containing coating of battery A-9. Since S was not detected in the negative-electrode S,O-containing coating of battery A-C3, S included in the negative-electrode S,O-containing coating of each of the batteries is said to be derived not from unavoidable impurities and other additives included in the positive electrode active material but from the metal salt in the electrolytic solution.

Since the S element ratio in the negative-electrode S,O-containing coating of battery A-8 was 10.4 at. % and the S element ratio in the negative-electrode S,O-containing coating of battery A-9 was 3.7 at. %; in the nonaqueous electrolyte secondary battery of the present invention, the S element ratio in the negative-electrode S,O-containing coating is not lower than 2.0 at. %, preferably not lower than 2.5 at. %, more preferably not lower than 3.0 at. %, and further preferably not lower than 3.5 at. %. The element ratio (at. %) of S refers to a peak intensity ratio of S when the total of peak intensities of S, N, F, C, and O was defined as 100%. Although the upper limit value of the element ratio of S is not determined in particular, a ratio not higher than 25 at. % is preferable.

(Thickness of Negative-Electrode S,O-Containing Coating)

With respect to the lithium ion secondary battery of battery A-8, one that was set in a discharged state with a voltage of 3.0 V after charging and discharging were repeated for 100 cycles, and one that was set in a charged state with a voltage of 4.1 V after charging and discharging were repeated for 100 cycles were prepared, and negative electrode samples that were subjects for analysis were obtained with a method similar to the pre-treatment in the XPS analysis described above. By performing FIB (Focused Ion Beam) processing on the obtained negative electrode samples, samples having a thickness of about 100 nm for STEM analysis were obtained. As a pre-treatment for the FIB processing, Pt was vapor-deposited on the negative electrode. The steps above were performed without exposing the negative electrode to air.

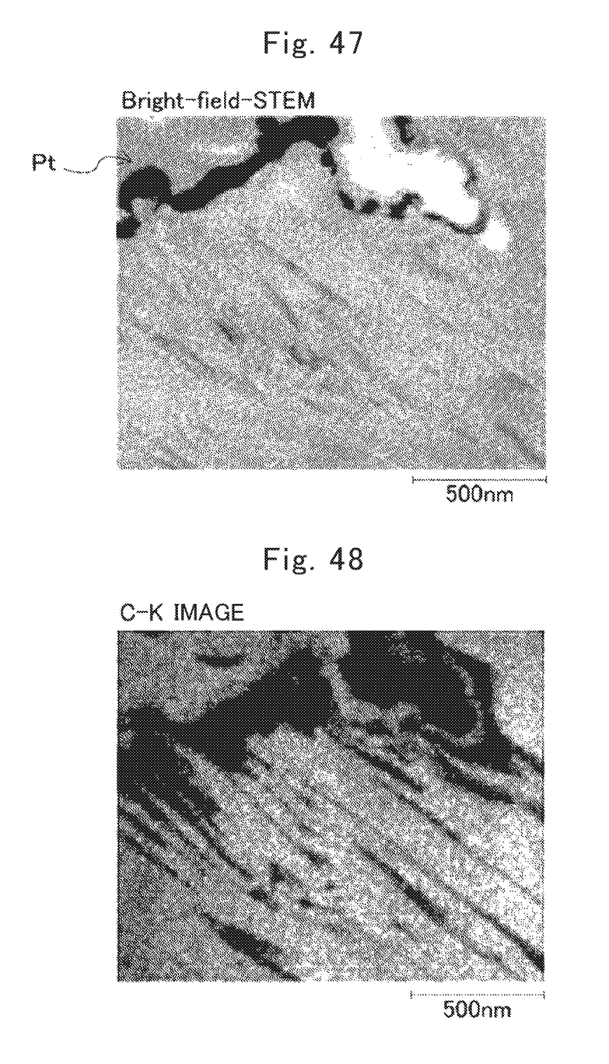

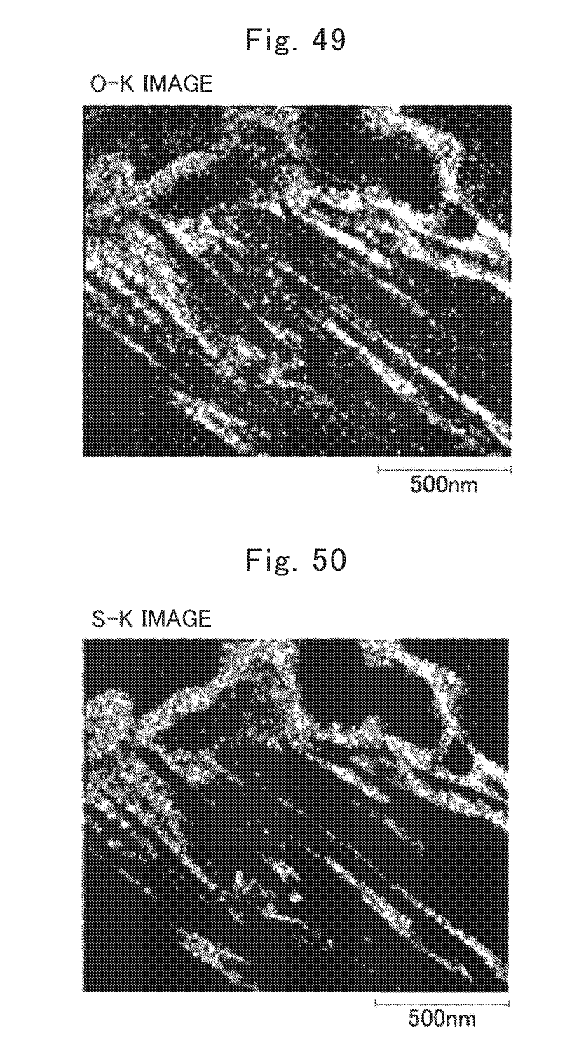

Each of the samples for STEM analysis was analyzed using a STEM (Scanning Transmission Electron Microscope) to which an EDX (Energy Dispersive X-ray spectroscopy) device was attached. The results are shown in FIGS. 47 to 50. Of these, FIG. 47 is a BF (Bright-field) -STEM image, and FIGS. 48 to 50 are element distribution images obtained using the SETM-EDX in the observation area identical to that in FIG. 47. FIG. 48 shows the results of analysis regarding C, FIG. 49 shows the results of analysis regarding O, and FIG. 50 shows the results of analysis regarding S. FIGS. 48 to 50 are analysis results of the negative electrode in the lithium ion secondary battery in the discharged state.

As show in FIG. 47, a black portion exists in the upper left part of the STEM image. The black portion is derived from Pt vapor-deposited in the pre-treatment of the FIB processing. In each of the STEM images, a portion above the portion derived from Pt (referred to as Pt part) is regarded as a portion that was tainted after vapor deposition of Pt. Thus, in FIGS. 48 to 50, only the portion below the Pt part was studied.

As shown in FIG. 48, C formed a layer below the Pt part. This is considered as a sheet structure of graphite which is the negative electrode active material. In FIG. 49, O was found at portions corresponding to the outer circumference and interlayer of graphite. Also in FIG. 50, S was found at portions corresponding to the outer circumference and interlayer of graphite. Based on these results, the negative-electrode S,O-containing coating including S and O such as a S═O structure is speculated to be formed on the surface and interlayer of graphite.

Ten parts of the negative-electrode S,O-containing coating formed on the surface of graphite were randomly selected, and thicknesses of the negative-electrode S,O-containing coating were measured to calculate an average value of the measured values. The negative electrode in the lithium ion secondary battery in a charged state was also analyzed similarly, and, based on the analysis results, an average value of the thickness of the negative-electrode S,O-containing coating formed on the surface of graphite was calculated. The results are shown in Table 25.

TABLE 25

| | Negative-electrode S,O-containing | |
|---|---|---|
| | coating of Battery A-8 | |
| | Discharged state | Charged state |
| | (3.0 V) | (4.1 V) |
| Thickness (nm) of negative-electrode | 40 | 48 |
| S,O-containing coating | | |

As shown in Table 25, the thickness of the negative-electrode S,O-containing coating increased after charging. Based on this result, in the negative-electrode S,O-containing coating, a fixed portion that exists stably against charging and discharging and an adsorption portion that increases or decreases associated with charging and discharging are speculated to exist. The negative-electrode S,O-containing coating is speculated to increase or decrease in thickness upon charging and discharging because the adsorption portion exists.

(Analysis of Positive-Electrode Coating)

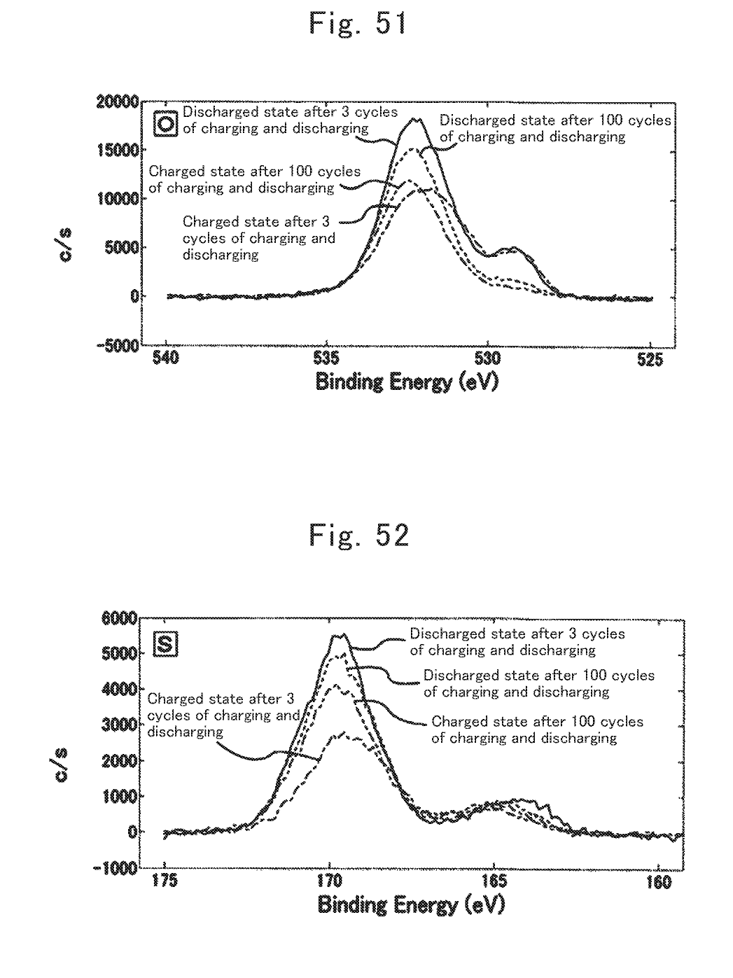

With respect to the lithium ion secondary battery of battery A-8, the following four were prepared: one that was set in a discharged state with a voltage of 3.0 V after charging and discharging were repeated for 3 cycles; one that was set in a charged state with a voltage of 4.1 V after charging and discharging were repeated for 3 cycles; one that was set in a discharged state with a voltage of 3.0 V after charging and discharging were repeated for 100 cycles; and one that was set in a charged state with a voltage of 4.1 V after charging and discharging were repeated for 100 cycles. With respect to each of the four lithium ion secondary batteries of battery A-8, a positive electrode that was the subject for analysis was obtained using a method similar to that described above. Then, XPS analysis was performed on the obtained positive electrodes. The results are shown in FIGS. 51 and 52. FIG. 51 shows the results of analysis regarding oxygen element, and FIG. 52 shows the results of analysis regarding sulfur element.

As shown in FIGS. 51 and 52, the positive-electrode S,O-containing coating of battery A-8 is also understood as to include S and O. In addition, since a peak around 170 eV was observed in FIG. 52, the positive-electrode S,O-containing coating of battery A-8 is understood as to include a S═O structure derived from the electrolytic solution of the present invention, similarly to the negative-electrode S,O-containing coating of battery A-8.

As shown in FIG. 51, the height of a peak existing around 529 eV was decreased after the cycles. This peak is thought to show existence of O derived from the positive electrode active material, and, more specifically, is thought to be a result of a photoelectron, excited by an O atom in the positive electrode active material, passing the S,O-containing coating and being detected in the XPS analysis. Since the peak was decreased after the cycles, the thickness of the S,O-containing coating formed on the surface of the positive electrode is thought to have increased associated with the cycles.

As shown in FIGS. 51 and 52, O and S in the positive-electrode S,O-containing coating increased at the discharged state and decreased at the charged state. Based on this result, O and S are thought to move in and out of the positive-electrode S,O-containing coating in association with charging and discharging. Based on this, associated with charging and discharging, the concentration of S and O in the positive-electrode S,O-containing coating is speculated to increase and decrease, or, similarly to the negative-electrode S,O-containing coating, the thickness is speculated to increase and decrease also in the positive-electrode S,O-containing coating due to existence of the adsorption portion.

In addition, XPS analysis was also performed on the positive-electrode S,O-containing coating and the negative-electrode S,O-containing coating in the lithium ion secondary battery of battery A-11.

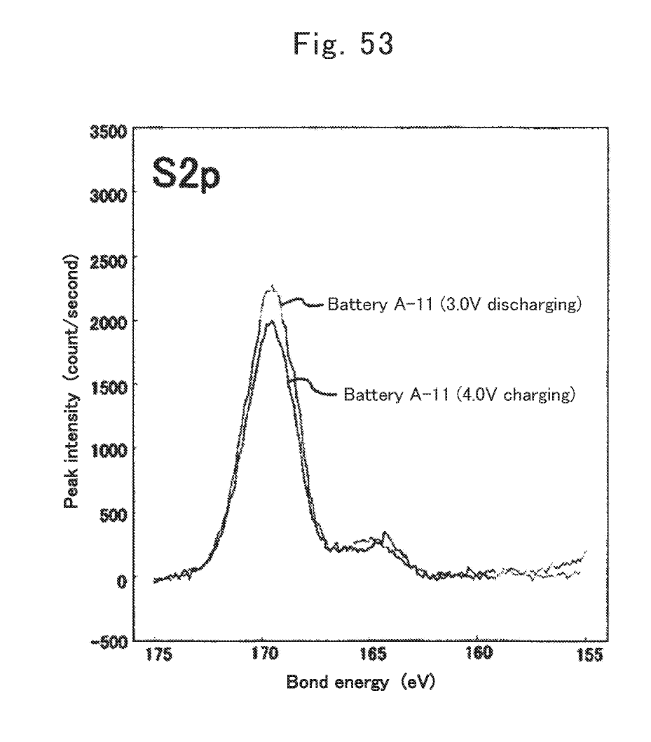

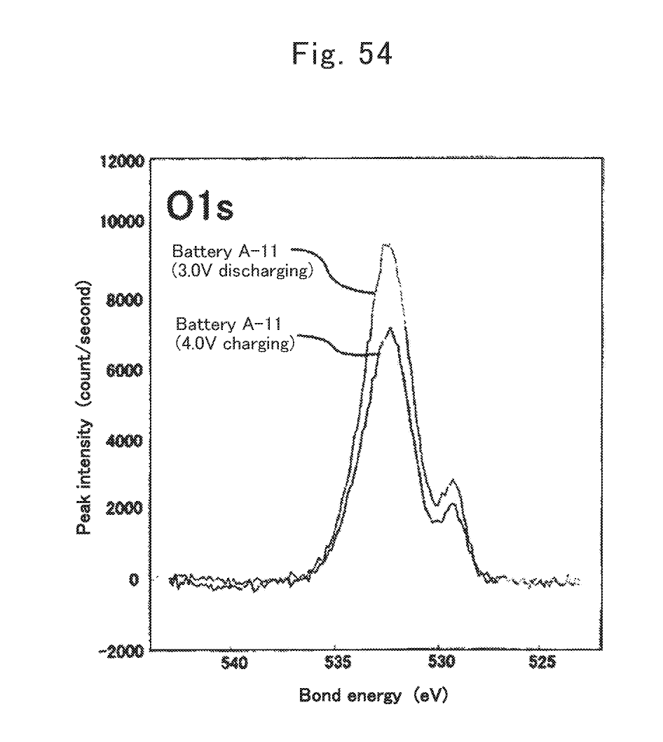

By using the lithium ion secondary battery of battery A-11, CC charging and discharging were repeated for 500 cycles at a rate of 1 C at 25° C. in a usage voltage range of 3.0 V to 4.1 V. After 500 cycles, XPS spectra of the positive-electrode S,O-containing coating at a discharged state of 3.0 V and a charged state of 4.0 V were measured. In addition, with respect to the negative-electrode S,O-containing coating in the discharged state of 3.0 V before the cycle test (i.e., after the first charging and discharging) and the negative-electrode S,O-containing coating in the discharged state of 3.0 V after 500 cycles; elemental analysis using XPS was performed and the ratios of S element contained in the negative-electrode S,O-containing coatings were calculated. FIGS. 53 and 54 show the analysis results of the positive-electrode S,O-containing coating of battery A-11 measured through XPS. Specifically, FIG. 53 shows the results of analysis regarding sulfur element, and FIG. 54 shows the results of analysis regarding oxygen element. In addition, Table 26 shows the S element ratio (at. %) of the negative-electrode coating measured through XPS. The S element ratio was calculated similarly to that in the above described section of “S element ratio of negative-electrode S,O-containing coating.”

As shown in FIGS. 53 and 54, also from the positive-electrode S,O-containing coating in the lithium ion secondary battery of battery A-11, a peak indicating the existence of S and a peak indicating the existence of O were detected. In addition, both the peak of S and the peak of O increased at the discharged state and decreased at the charged state. This result also confirms the positive-electrode S,O-containing coating having the S═O structure, and O and S in the positive-electrode S,O-containing coating moving in and out of the positive-electrode S,O-containing coating in association with charging and discharging.

TABLE 26
<S element ratio of negative-electrode S,O-containing coating>

| | After first charging | |
|---|---|---|
| | and discharging | After 500 cycles |
| S element ratio (at. %) | 3.1 | 3.8 |

In addition, as shown in Table 26, the negative-electrode S,O-containing coating of battery A-11 included S by 2.0 at. % or more after the first charging and discharging and also after 500 cycles. Based on this result, the negative-electrode S,O-containing coating of the nonaqueous electrolyte secondary battery of the present invention is understood as to include S by 2.0 at. % or more in both before the cycles and after the cycles.

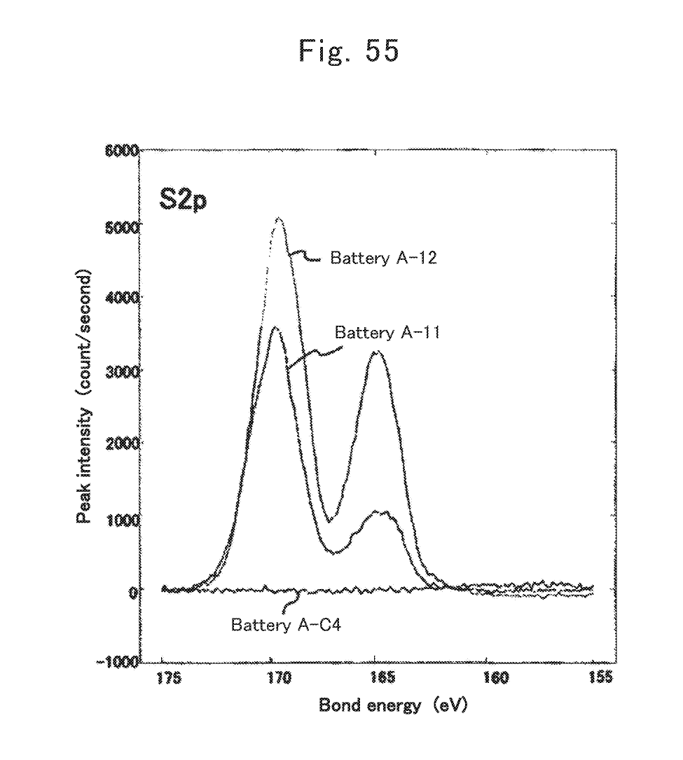

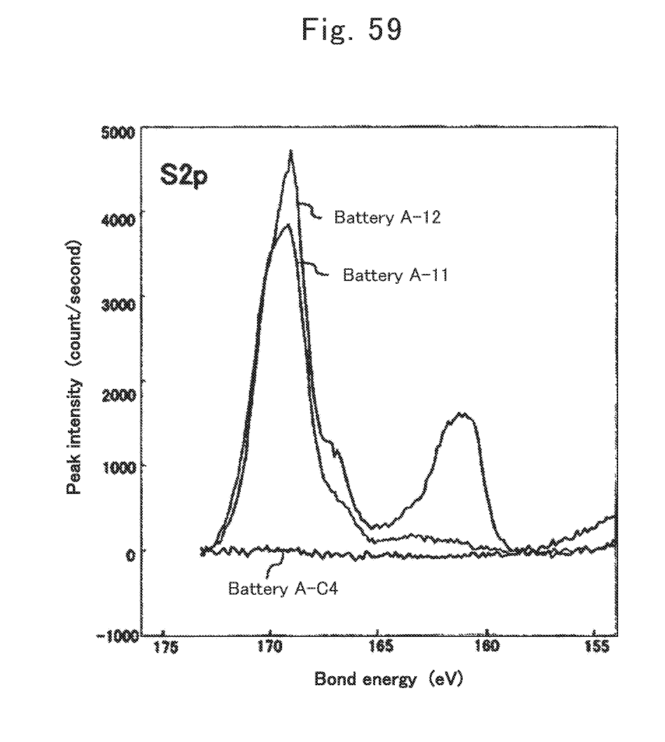

With respect to the lithium ion secondary batteries of batteries A-11 to A-14, A-C4, and A-C5, a high-temperature storage test of storing at 60° C. for 1 week was performed, and, after the high-temperature storage test, the positive-electrode S,O-containing coatings and the negative-electrode S,O-containing coatings of respective batteries A-11 to A-14, and the positive-electrode coatings and the negative-electrode coatings of respective batteries A-C4 and A-C5 were analyzed. Before starting the high-temperature storage test, CC-CV charging was performed at a rate of 0.33 C from 3.0 V to 4.1 V. The charge capacity at this time was used as a standard (SOC100), and a portion of 20% with respect to this standard was CC discharged to adjust each of the batteries to SOC80, and the high-temperature storage test was started. After the high-temperature storage test, CC-CV discharging to 3.0 V was performed at 1 C. After the discharging, XPS spectra of the positive-electrode S,O-containing coatings, the negative-electrode S,O-containing coatings, the positive-electrode coatings, and the negative-electrode coatings were measured. FIGS. 55 to 58 show analysis results of the positive-electrode S,O-containing coatings of batteries A-11 to A-14, and the positive-electrode coatings of batteries A-C4 and A-C5 measured through XPS. In addition, FIGS. 59 to 62 show analysis results of the negative-electrode S,O-containing coatings of batteries A-11 to A-14 and the negative-electrode coatings of batteries A-C4 and A-C5 measured through XPS.

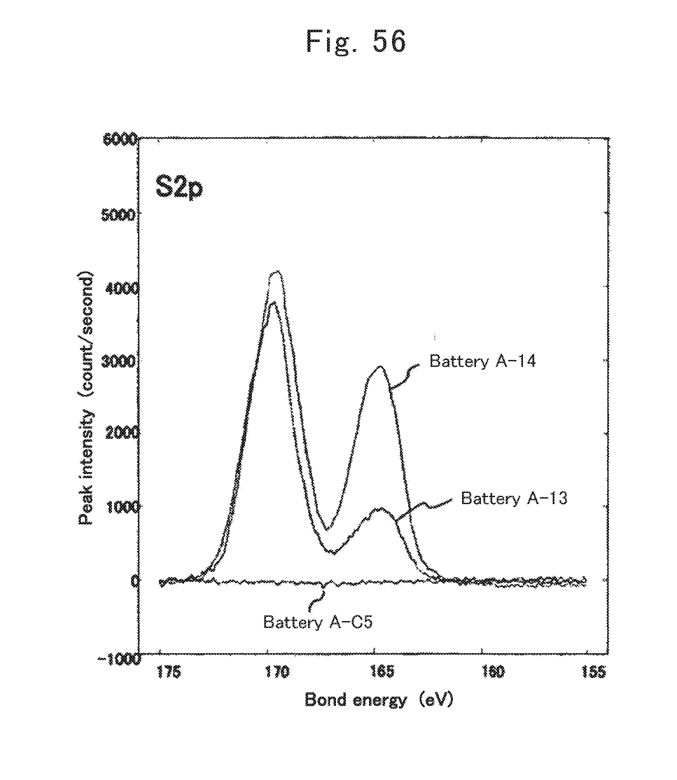

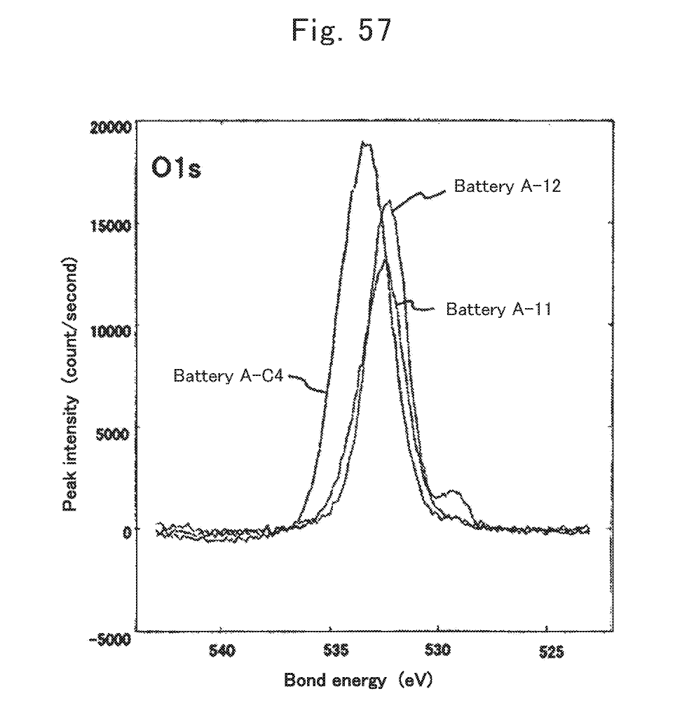

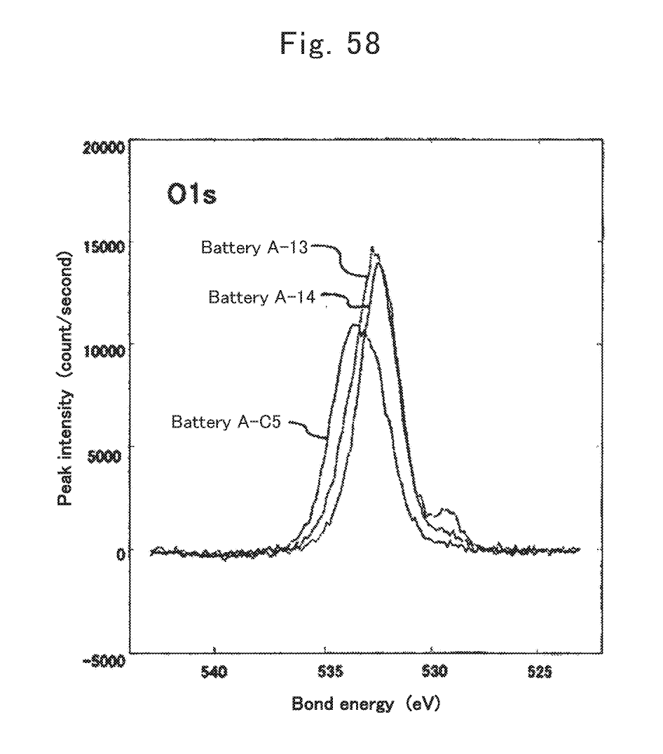

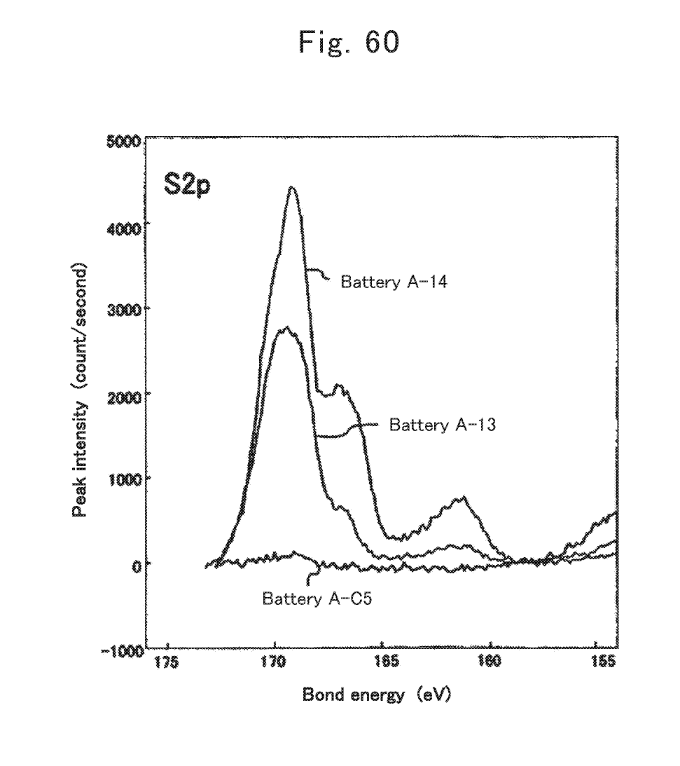

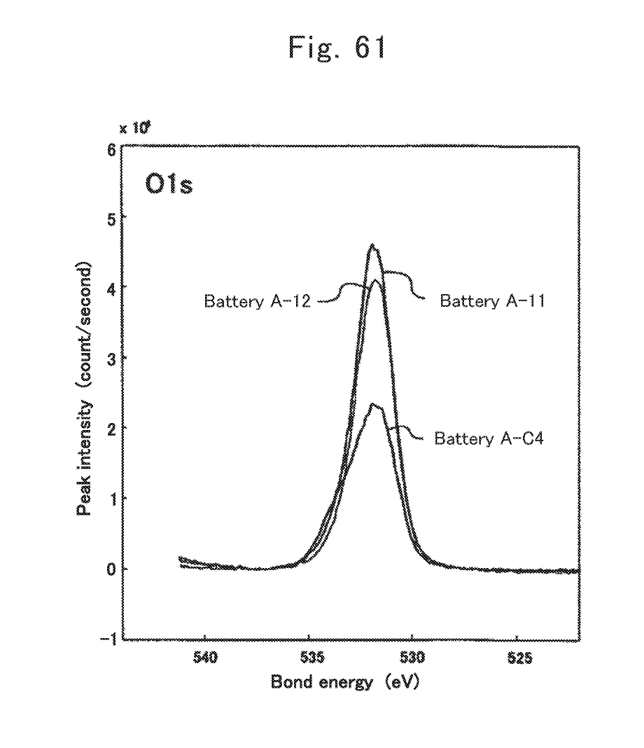

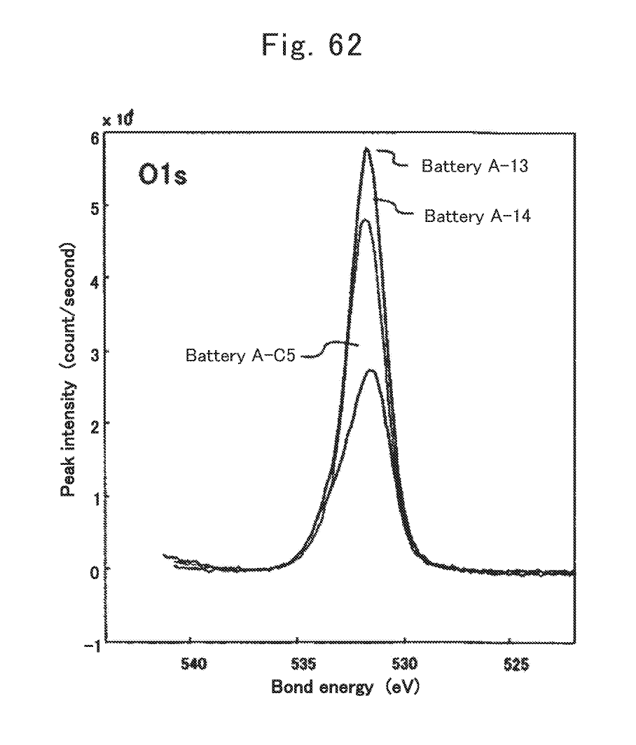

Specifically, FIG. 55 shows the results of analysis regarding sulfur element in the positive-electrode S,O-containing coatings of batteries A-11 and A-12 and the positive-electrode coating of battery A-C4 . FIG. 56 shows the results of analysis regarding sulfur element in the positive-electrode S,O-containing coatings of batteries A-13 and A-14 and the positive-electrode coating of battery A-C5. FIG. 57 shows the results of analysis regarding oxygen element in the positive-electrode S,O-containing coatings of batteries A-11 and A-12 and the positive-electrode coating of battery A-C4. FIG. 58 shows the results of analysis regarding oxygen element in the positive-electrode S,O-containing coatings of batteries A-13 and A-14 and the positive-electrode coating of battery A-C5. FIG. 59 shows the results of analysis regarding sulfur element in the negative-electrode S,O-containing coatings of batteries A-11 and A-12 and the negative-electrode coating of battery A-C4. FIG. 60 shows the results of analysis regarding sulfur element in the negative-electrode S,O-containing coatings of batteries A-13 and A-14 and the negative-electrode coating of battery A-C5. FIG. 61 shows the results of analysis regarding oxygen element in the negative-electrode S,O-containing coatings of batteries A-11 and A-12 and the negative-electrode coating of battery A-C4. FIG. 62 shows the results of analysis regarding oxygen element in the negative-electrode S,O-containing coatings of batteries A-13 and A-14 and the negative-electrode coating of battery A-C5.

As shown in FIGS. 55 and 56, although the lithium ion secondary batteries of batteries A-C4 and A-C5 using the conventional electrolytic solution did not include S in the positive-electrode coatings, the lithium ion secondary batteries of batteries A-11 to A-14 using the electrolytic solution of the present invention included S in the positive-electrode S,O-containing coatings. As shown in FIGS. 57 and 58, all the lithium ion secondary batteries of batteries A-11 to A-14 included O in the positive-electrode S,O-containing coatings. Furthermore, as shown in FIGS. 55 and 56, from all the positive-electrode S,O-containing coatings of the lithium ion secondary batteries of batteries A-11 to A-14, a peak of around 170 eV indicating the existence of SO₂ (S═O structure) was detected. From these results, in both when AN was used and when DMC was used as the organic solvent for the electrolytic solution in the lithium ion secondary battery of the present invention, a stable positive-electrode S,O-containing coating that includes S and O is understood as to be formed. In addition, since the positive-electrode S,O-containing coating is not affected by the type of the negative electrode binder, O in the positive-electrode S,O-containing coating is thought to be not derived from CMC. Furthermore, as shown in FIG. 57 and FIG. 58, when DMC was used as the organic solvent for the electrolytic solution, a peak of O derived from the positive electrode active material was detected at around 530 eV. Thus, when DMC was used as the organic solvent for the electrolytic solution, the thickness of the positive-electrode S,O-containing coating is thought to be smaller compared to when AN was used.

Similarly, as shown in FIGS. 59 to 62, the lithium ion secondary batteries of batteries A-11 to A-14 are understood as to each include S and O also in the negative-electrode S,O-containing coating, and these are understood as to form a S═O structure and be derived from the electrolytic solution. In addition, the negative-electrode S,O-containing coating is understood as to be formed in both when AN was used and when DMC was used as the organic solvent for the electrolytic solution.

With respect to the lithium ion secondary batteries of batteries A-11, A-12, and A-C4, after the high-temperature storage test and discharging, XPS spectra of the respective negative-electrode S,O-containing coatings and the negative-electrode coatings were measured, and the ratio of S element at discharged state was calculated in each of the negative-electrode S,O-containing coatings of batteries A-11 and A-12 and the negative-electrode coating of battery A-C4. Specifically, with respect to each of the negative-electrode S,O-containing coatings or the negative-electrode coatings, an element ratio of S when the total peak intensity of S, N, F, C, and O was defined as 100% was calculated. The results are shown in Table 27.

TABLE 27

| | Battery A-11 | Battery A-12 | Battery A-C4 |
|---|---|---|---|
| S element ratio (at. %) | 4.2 | 6.4 | 0.0 |

As shown in Table 27, although the negative-electrode coating of battery A-C4 did not include S at an amount equal to or more than the detection limit, S was detected in the negative-electrode S,O-containing coatings of batteries A-11 and A-12. In addition, the negative-electrode S,O-containing coating of battery A-12 included more S than the negative-electrode S,O-containing coating of battery A-11. Based on this result, the S element ratio in the negative-electrode S,O-containing coating is understood as to be equal to or higher than 2.0 at .% even after high temperature storage.

### Evaluation Example A-20

### Cycle Durability of Battery

With respect to each of the lithium ion secondary batteries of batteries A-11, A-12, A-15, and A-C4, in a range of 3.0 V to 4.1 V (vs. Li reference) at room temperature, CC charging and discharging were repeated, and a discharge capacity at the first charging and discharging, a discharge capacity at the 100-th cycle, and a discharge capacity at the 500-th cycle were measured. When a capacity of each of the lithium ion secondary batteries at the first charging and discharging was defined as 100%, capacity retention rates (%) of each of the lithium ion secondary batteries at the 100-th cycle and the 500-th cycle were calculated. The results are shown in Table 28.

TABLE 28

| | | Battery | Battery | Battery | Battery |
|---|---|---|---|---|---|
| | | A-11 | A-12 | A-15 | A-C4 |
| Electrolytic solution | Organic | DMC | AN | DMC | EC/DEC |
| | solvent | | | | |
| | Metal salt | LiFSA | LiFSA | LiFSA | LiPF₆ |
| Capacity retention | 100 cycle | 97 | 92 | 97 | 96 |
| rate (%) | 500 cycle | 90 | 67 | — | 85 |

As shown in Table 28, the lithium ion secondary batteries of batteries A-11, A-12, and A-15, even though not containing EC that becomes a material of SEI, each showed a capacity retention rate comparable to that of the lithium ion secondary battery of battery A-C4 containing EC. The reason may be that the S,O-containing coating derived from the electrolytic solution of the present invention existed on the positive electrode and the negative electrode of the lithium ion secondary battery of each of the batteries. The lithium ion secondary battery of battery A-11 particularly showed an extremely high capacity retention rate even after 500 cycles, and was particularly excellent in durability. Based on this result, durability is considered to improve more when DMC is selected as the organic solvent of the electrolytic solution compared to when AN is selected.

With respect to the lithium ion secondary batteries of batteries A-11, A-12, and A-C4, a high-temperature storage test of storing at 60° C. for 1 week was performed. Before starting the high-temperature storage test, CC-CV (constant current constant voltage) charging was performed from 3.0 V to 4.1 V. The charge capacity at this time was used as a standard (SOC100), and a portion of 20% with respect to this standard was CC discharged to adjust each of the batteries to SOC80, and the high-temperature storage test was started. After the high-temperature storage test, CC-CV discharging to 3.0 V was performed at 1 C. Based on a ratio of a discharge capacity at this moment and a capacity at SOC80 before storage, a remaining capacity was calculated using the following formula. The results are shown in Table 29.

Remaining capacity=100×(CC-CV discharge capacity after storage)/(Capacity at SOC80 before storage)

TABLE 29

| | | Battery A-11 | Battery A-12 | Battery A-C4 |
|---|---|---|---|---|
| Electrolytic | Organic | DMC | AN | EC/DEC |
| solution | solvent | | | |
| | Metal salt | LiFSA | LiFSA | LiPF₆ |

| | | | |
|---|---|---|---|
| Remaining capacity (%) | 54 | 36 | 20 |

The remaining capacities of the nonaqueous electrolyte secondary batteries of batteries A-11 and A-12 were larger than the remaining capacity of the nonaqueous electrolyte secondary battery of battery A-C4. Based on this result, the S,O-containing coatings derived from the electrolytic solution of the present invention and formed on the positive electrode and the negative electrode are considered to also contribute to increase the remaining capacity.

### Evaluation Example A-21

### Surface Analysis of A1 Current Collector

The lithium ion secondary batteries of batteries A-8 and A-9 were subjected to 100 repeats of charging and discharging at a rate of 1 C in a usage voltage range of 3 V to 4.2 V, and were disassembled after 100 times of charging and discharging. The aluminum foils which are the positive electrode current collectors were each removed and the surfaces of the aluminum foils were rinsed using dimethyl carbonate.

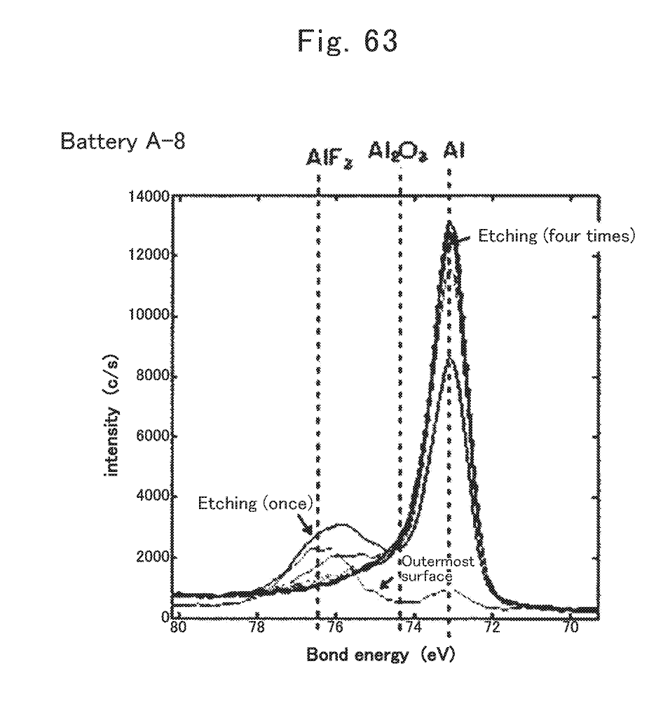

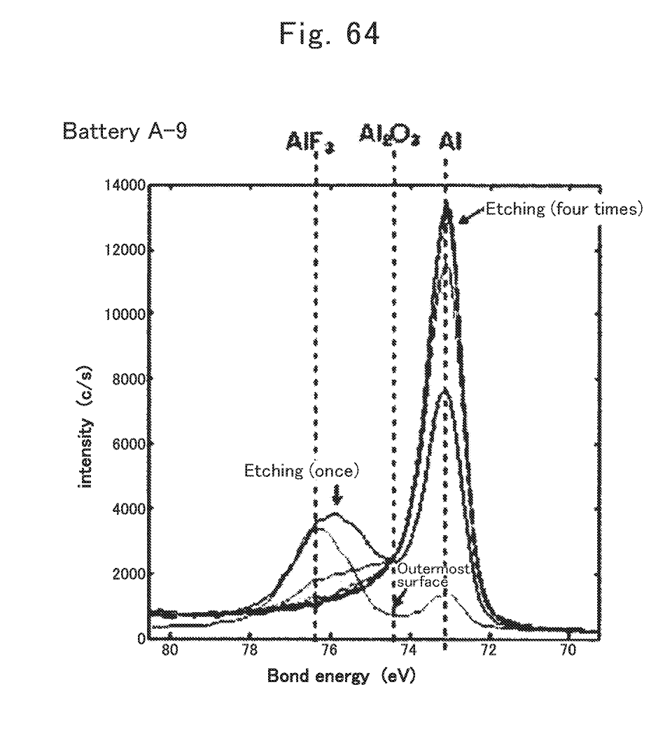

After the rinsing, surface analysis using X-ray photoelectron spectroscopy (XPS) was performed on the surfaces of the aluminum foils of the lithium ion secondary batteries of batteries A-8 and A-9 while etching was performed thereon through Ar sputtering. The results of surface analysis of the aluminum foils after charging and discharging the lithium ion secondary batteries of batteries A-8 and A-9 are shown in FIGS. 63 and 64.

When FIGS. 63 and 64 are compared, the results of surface analysis of the aluminum foils, which are the positive electrode current collectors, after charging and discharging the lithium ion secondary batteries of batteries A-8 and A-9 were almost the same, and whereby the following is determined. At the surfaces of the aluminum foils, the chemical state of Al on the outermost surface was AlF₃. When etching was performed on the aluminum foils in the depth direction, peaks for Al, O, and F were detected. At parts reachable after one to three times of etching from the surfaces of the aluminum foils, the chemical state of Al was revealed to be a composite state of Al—F bonds and Al—O bonds . After further etching, peaks for O and F disappeared and only a peak for Al was observed from the fourth time of etching (a depth of approximately 25 nm calculated based on SiO₂). In XPS measurement data, AlF₃ was observed at Al peak position 76.3 eV, pure Al was observed at Al peak position 73 eV, and the composite state of Al—F bonds and Al—O bonds was observed at Al peak position 74 eV to 76.3 eV. Dashed lines shown in FIGS. 63 and 64 show respective peak positions representative for AlF₃, Al, and Al₂O₃.

Based on the results above, on the surfaces of the aluminum foils of the lithium ion secondary batteries of the present invention after charging and discharging, a layer of Al-F bonds (speculated to be AlF₃) and a layer in which Al-F bonds (speculated to be AlF₃) and Al—O bonds (speculated to be Al₂O₃) coexist were confirmed to be formed in a thickness of approximately 25 nm in the depth direction.

Thus, in the lithium ion secondary batteries of the present invention each using an aluminum foil as the positive electrode current collector, also when the electrolytic solution of the present invention is used, a passive film including Al—F bonds (speculated to be AlF₃) was revealed to be formed on the outermost surfaces of the aluminum foils after charging and discharging.

Based on the results of Evaluation Example A-21, in the lithium ion secondary battery obtained by combining the electrolytic solution of the present invention and the positive electrode current collector formed of aluminum or an aluminum alloy, a passive film was revealed to be formed on the surface of the positive electrode current collector through charging and discharging, and elution of Al from the positive electrode current collector was revealed to be suppressed even in a high potential state.

### Evaluation Example A-22

### Analysis of Positive-Electrode S,O-Containing Coating

By using TOF-SIMS (Time-of-Flight Secondary Ion Mass Spectrometry), structural information of each molecule included in the positive-electrode S,O-containing coating of battery A-11 was analyzed.

The nonaqueous electrolyte secondary battery of battery A-11 was subjected to 3 cycles of charging and discharging at 25° C., and disassembled at a 3 V-discharged state to remove the positive electrode. Aside from this, the nonaqueous electrolyte secondary battery of battery A-11 was subjected to 500 cycles of charging and discharging at 25° C., and disassembled at the 3 V-discharged state to remove the positive electrode. Also aside from this, the nonaqueous electrolyte secondary battery of battery A-11 was subjected to 3 cycles of charging and discharging at 25° C., left for one month at 60° C., and disassembled at the 3 V-discharged state to remove the positive electrode. Each of the positive electrodes was rinsed three times with DMC to obtain a positive electrode for analysis. On each of the positive electrodes, a positive-electrode S,O-containing coating was formed, and structural information of molecules included in the positive-electrode S,O-containing coating was analyzed in the following analysis.

Each of the positive electrodes for analysis was analyzed using TOF-SIMS. A time-of-flight secondary ion mass spectrometer was used as a mass spectrometer to measure positive secondary ions and negative secondary ions. Bi was used as a primary ion source, and the primary accelerating voltage was 25 kV. Ar-GCIB (Ar1500) was used as a sputtering ion source. The results of the measurement are shown in Tables 30 to 32. A positive ionic strength (relative value) of each fragment in Table 31 is a relative value when the total of the positive ionic strength of all the detected fragments was defined as 100%. Similarly, a negative ionic strength (relative value) of each fragment described in Table 32 is a relative value when the total of the negative ionic strength of all the detected fragments was defined as 100%.

TABLE 30
(Detected main fragments)

| | Positive | |
|---|---|---|
| | secondary ion | Negative secondary ion |
| S-containing fragments | SO, Li₂SO₂, | SO₃, Li₃S₂O₃, SNO₂, |
| (estimated to be coating | Li₃SO₃, Li₃SO₄ | SFO₂, SFO₃, S₂F₂NO₄ |
| component derived from | | |
| metal salt) | | |
| Hydrocarbon fragments | C₃H₃, C₄H₃ | Attributable |
| (estimated to be coating | | fragments not present |
| component derived from | | |
| solvent) | | |
| Other Li containing | Li, Li₃O, Li₂F, | LiF₂, Li₂F₃ |
| fragments | Li₃F₂, Li₃CO₃ | |

TABLE 31
(Positive ion analysis results)

| | | Positive ionic strength (relative value) | | |
|---|---|---|---|---|
| | | 3 cycle | 500 cycle | 60° C. storage |
| Positive secondary ion | SO | 2.2E−04 | 2.2E−04 | 2.5E−04 |
| | Li₂SO₂ | 1.9E−03 | 2.0E−03 | 1.5E−03 |
| | Li₃SO₃ | 4.4E−03 | 4.2E−03 | 2.2E−03 |
| | Li₃SO₄ | 7.5E−03 | 5.4E−03 | 2.6E−03 |
| | C₃H₃ | 1.2E−02 | 1.3E−02 | 1.5E−02 |
| | C₄H₃ | 2.8E−03 | 3.6E−03 | 4.2E−03 |
| | Li | 4.5E−02 | 3.6E−02 | 2.2E−02 |
| | Li₃O | 2.4E−02 | 1.7E−02 | 5.7E−03 |
| | Li₂F | 1.3E−01 | 1.4E−01 | 8.2E−02 |
| | Li₃F₂ | 4.7E−02 | 5.3E−02 | 2.9E−02 |
| | Li₃CO₃ | 3.7E−03 | 2.3E−03 | 1.8E−03 |

TABLE 32
(Negative ion analysis results)

| | | Negative ionic strength (relative value) | | |
|---|---|---|---|---|
| | | 3 cycle | 500 cycle | 60° C. storage |
| Negative secondary | SO₃ | 3.0E−02 | 4.0E−02 | 2.5E−02 |
| ion | Li₃S₂O₆ | 1.6E−03 | 1.3E−03 | 1.3E−03 |
| | SNO₂ | 2.0E−02 | 2.4E−02 | 3.1E−02 |
| | SFO₂ | 1.6E−02 | 2.1E−02 | 2.6E−02 |
| | SFO₃ | 4.6E−03 | 7.6E−03 | 9.1E−03 |
| | S₂F₂NO₄ | 2.2E−01 | 3.1E−01 | 4.6E−01 |
| | LiF₂ | 8.0E−03 | 1.1E−02 | 6.1E−03 |
| | Li₂F₃ | 4.0E−03 | 5.5E−03 | 2.8E−03 |

As shown in Table 30, fragments that were estimated to be derived from the solvent of the electrolytic solution were only C₃H₃ and C₄H₃ detected as positive secondary ions. Fragments estimated to be derived from the salt of the electrolytic solution were mainly detected as negative secondary ions, and had larger ionic strengths than the fragments derived from the solvent described above. In addition, fragments including Li were mainly detected as positive secondary ions, and the ionic strength of the fragments including Li accounted for a large proportion among the positive secondary ions and the negative secondary ions.

Thus, the main component of the S,O-containing coating of the present invention is speculated to be a component derived from the metal salt contained in the electrolytic solution, and the S,O-containing coating of the present invention is speculated to include a large amount of Li.

Furthermore, as shown in Table 30, as fragments estimated to be derived from the salt, SNO₂, SFO₂, and S₂F₂NO₄, etc., were also detected. All of these have the S═O structure, and a structure in which N or F are bound to S. Thus, in the S,O-containing coating of the present invention, S is capable of not only forming a double bond with O, but also is capable of forming a structure bound to other elements such as SNO₂, SFO₂, and S₂F₂NO₄. Thus, the S,O-containing coating of the present invention preferably has at least the S═O structure, and S included in the S═O structure may bind with other elements. Obviously, the S,O-containing coating of the present invention may include S and O that do not form the S═O structure.

In a conventional electrolytic solution described in, for example, JP2013145732 (A) described above, more specifically, in a conventional electrolytic solution including EC as the organic solvent, LiPF₆ as the metal salt, and LiFSA as the additive; S is taken into a degradation product of the organic solvent. Thus, in the negative-electrode coating and/or the positive-electrode coating, S is thought to exist as an ion of such as CₚH_{q}S (p and q are independently an integer). On the other hand, as shown in Tables 30 to 32, the fragments including S, detected in the S,O-containing coating of the present invention, were not fragments of CₚH_{q}S, but were mainly fragments reflecting an anion structure. This also reveals that the S,O-containing coating of the present invention is fundamentally different from a coating formed on a conventional nonaqueous electrolyte secondary battery.

(Battery A1)

A half-cell using electrolytic solution E8 was produced in the following manner.

An aluminum foil (JIS A1000 series) having a diameter of 13.82 mm, an area size of 1.5 cm², and a thickness of 20 μm was used as the working electrode, and metal Li was used as the counter electrode. As the separator, a Whatman glass nonwoven fabric filter (stock number: 1825-055) having a thickness of 400 μm was used.

The working electrode, the counter electrode, the separator, and the electrolytic solution were housed in a battery case (CR2032 type coin cell case manufactured by Hohsen Corp.) to form a half-cell. This was used as a half-cell of battery A1.

(Battery A2)

A half-cell of battery A2 was produced similarly to the half-cell of battery Al, except for using electrolytic solution E11.

(Battery A3)

A half-cell of battery A3 was produced similarly to the half-cell of battery A1, except for using electrolytic solution E16.

(Battery A4)

A half-cell of battery A4 was produced similarly to the half-cell of battery Al, except for using electrolytic solution E19.

(Battery A5)

A half-cell of battery AS was produced similarly to the half-cell of battery A1, except for using electrolytic solution E13.

(Battery AC1)

A half-cell of battery AC1 was produced similarly to the half-cell of battery A1, except for using electrolytic solution C5.

(Battery AC2)

A half-cell of battery AC2 was produced similarly to the half-cell of battery A1, except for using battery C6.

### Evaluation Example 23

### Cyclic Voltammetry Evaluation Using A1 Working Electrode

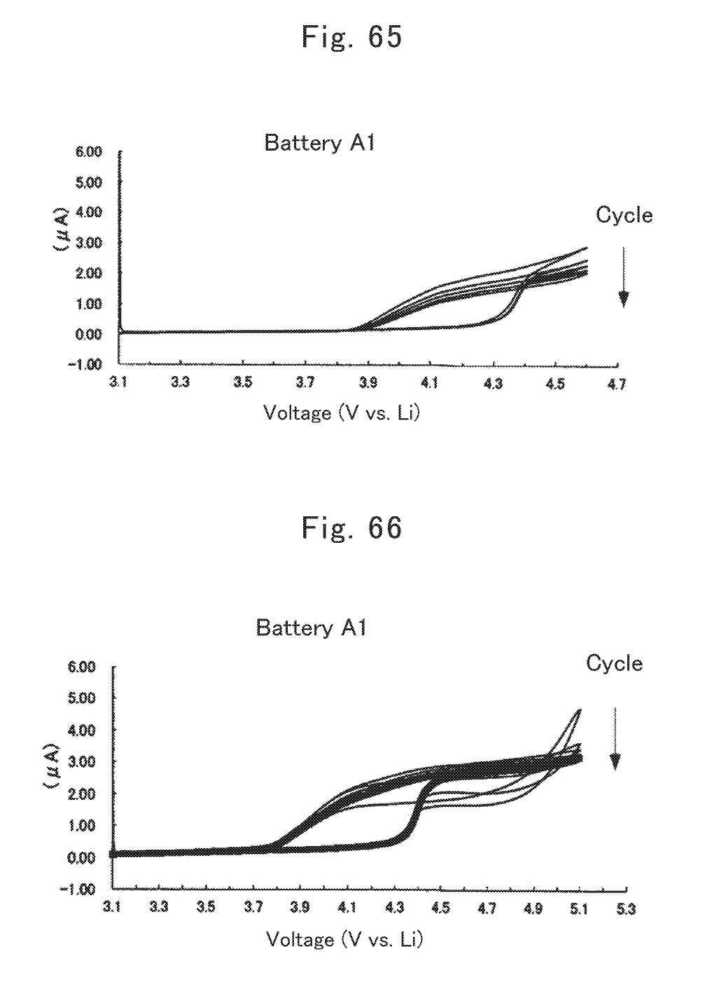

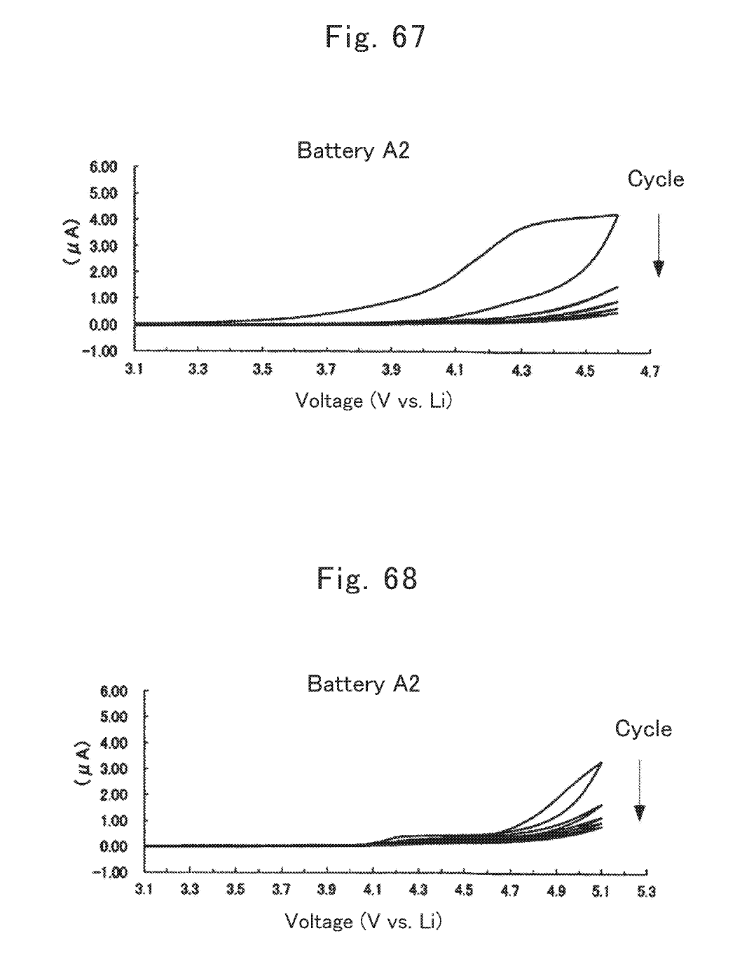

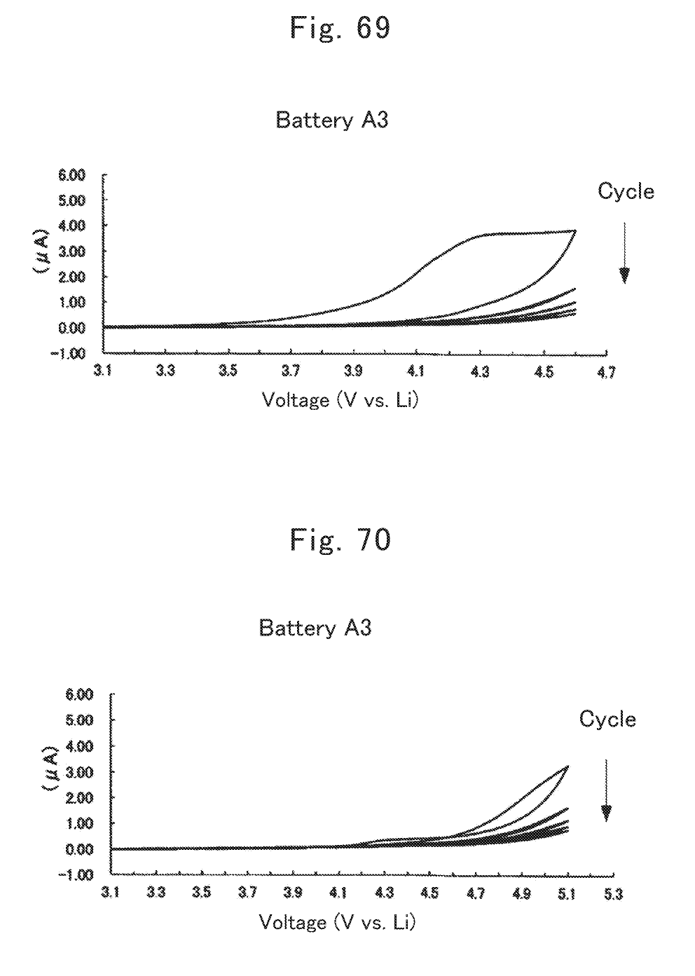

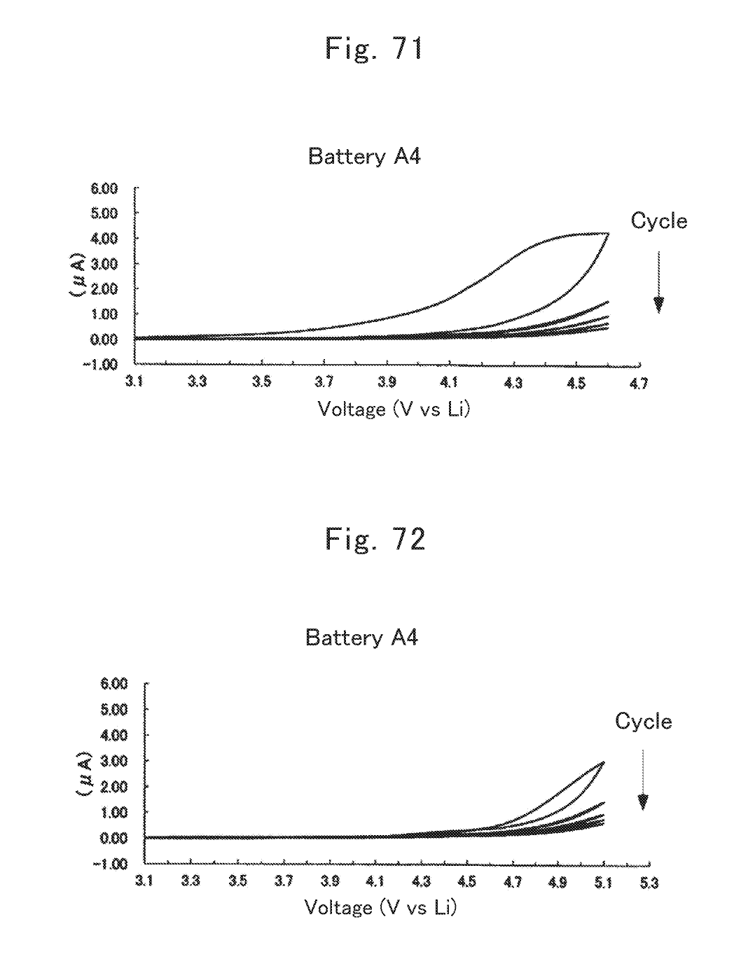

With respect to the half-cells of batteries A1 to A4 and AC1, 5 cycles of cyclic voltammetry evaluation were performed with a condition of 1 mV/s in a range of 3.1 V to 4.6 V. Then, 5 cycles of cyclic voltammetry evaluation were performed with a condition of 1 mV/s in a range of 3.1 V to 5.1 V. FIGS. 65 to 73 show graphs showing the relationship between potential and response current in the half-cells of batteries A1 to A4 and AC1.

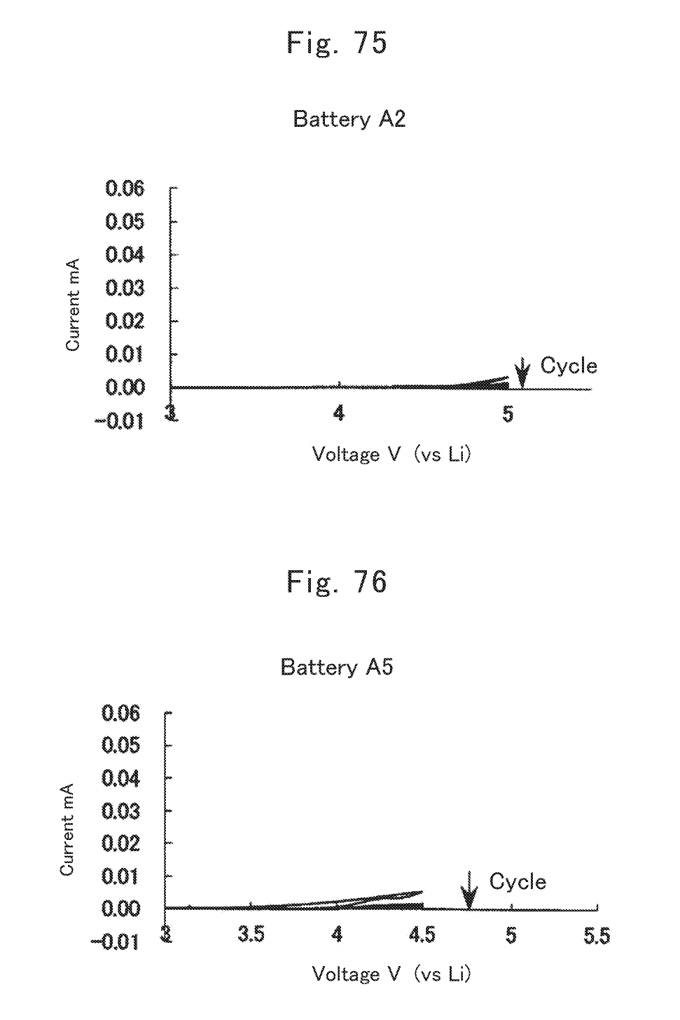

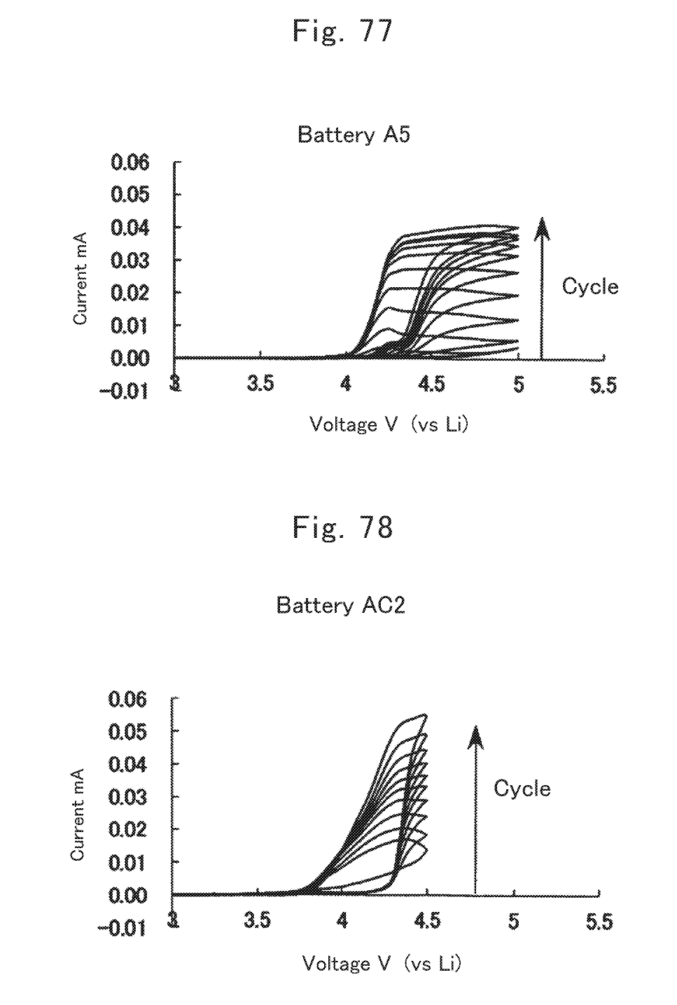

In addition, with respect to the half-cells of batteries A2, A5, and AC2, 10 cycles of cyclic voltammetry evaluation were performed with a condition of 1 mV/s in a range of 3.0 V to 4.5 V. Then, 10 cycles of cyclic voltammetry evaluation were performed with a condition of 1 mV/s in a range of 3.0 V to 5.0 V. FIG. 74 to FIG. 79 show graphs showing the relationship between potential and response current in the half-cells of batteries A2, A5, and AC2.

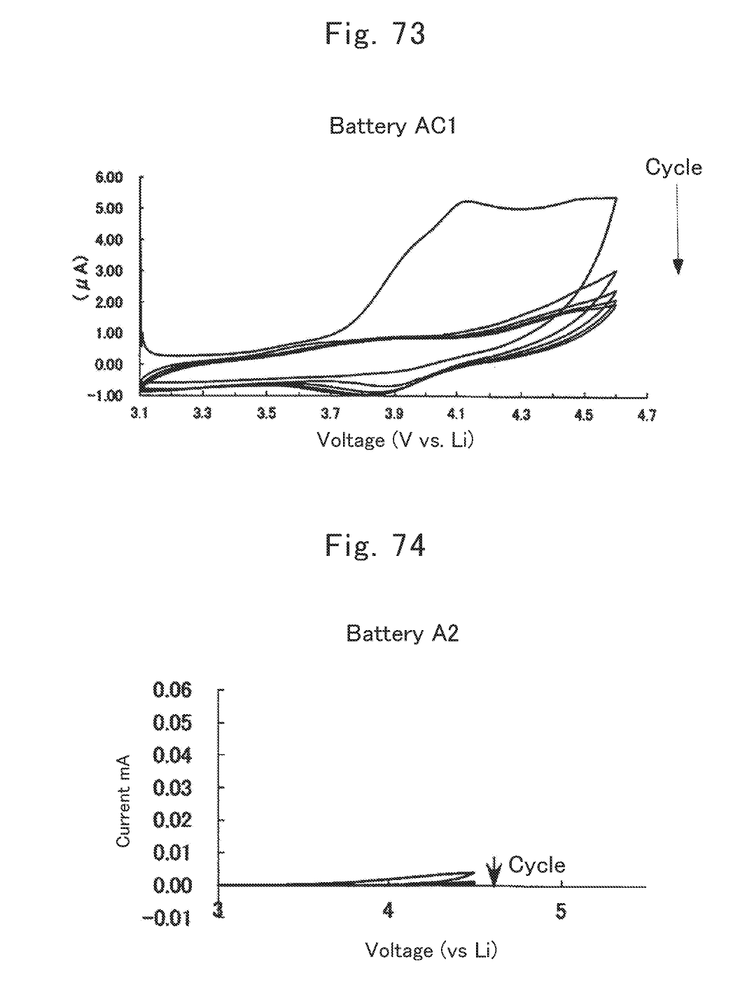

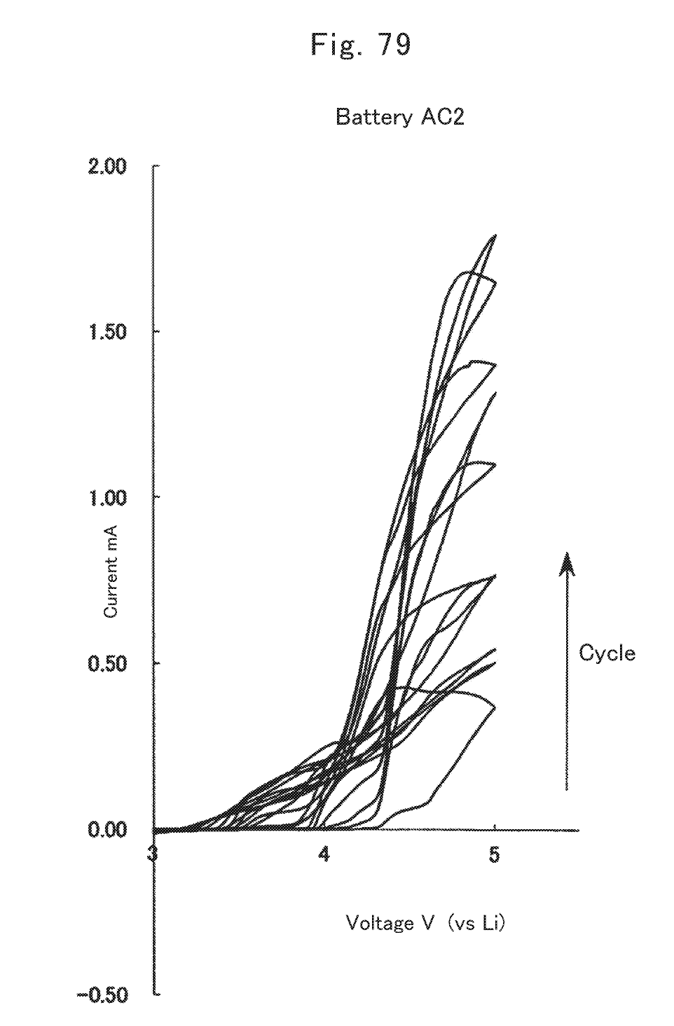

From FIG. 73, with the half-cell of battery AC1, current is understood to be flowing in a range of 3.1 V to 4.6 V during and after the second cycle, and the current is understood to increase as the potential became higher. In addition, from FIGS. 78 and 79, also with the half-cell of battery AC2, current flowed in a range of 3.0 V to 4.5 V during and after the second cycle, and current increased as the potential became higher. This current is estimated to be a current resulting from oxidation of A1, generated through corrosion of aluminum of the working electrode.

On the other hand, from FIGS. 65 to 72, with the half-cells of batteries A1 to A4, almost no current is understood as to flow in a range of 3.1 V to 4.6 V during and after the second cycle . Although a slight increase in current was observed associated with an increase in potential in a range equal to or higher than 4.3 V, the amount of current decreased and became steady as the cycle was repeated. Particularly in the half-cells of batteries A1 to A4, a significant increase in current was not observed up to a high potential of 5.1 V, and a decrease in the amount of current associated with repeated cycles was observed.

In addition, from FIGS. 74 to 77, similarly with the half-cells of batteries A2 and A5, almost no current is understood as to flow in a range of 3.0 V to 4.5 V during and after the second cycle. In particular, during and after the third cycle, almost no increase in current was observed until reaching 4.5 V. Although an increase in current beyond a high potential of 4.5 V was observed in the half-cell of battery A5, the value was much smaller when compared to a current value beyond 4.5 V in the half-cell of battery AC2. In the half-cell of battery A2, almost no increase in current was observed beyond 4.5 V up to 5.0 V, and a decrease in the amount of current associated with repeated cycles was observed.

From the results of cyclic voltammetry evaluation, corrosiveness of respective electrolytic solutions of electrolytic solutions E8, E11, E16, and E19 with respect to aluminum is considered to be low even at a high potential condition exceeding 5 V. Thus, respective electrolytic solutions of electrolytic solutions E8, E11, E16, and E19 are considered as electrolytic solutions suitable for a battery using aluminum as a current collector or the like.

The following specific electrolytic solutions are provided as the electrolytic solution of the present invention. The following electrolytic solutions also include those previously stated.

(Electrolytic Solution A)

The electrolytic solution of the present invention was produced in the following manner.

Approximately 5 mL of 1,2-dimethoxyethane, which is an organic solvent, was placed in a flask including a stirring bar and a thermometer. Under a stirring condition, with respect to 1,2-dimethoxyethane in the flask, (CF₃SO₂)₂NLi, which is a lithium salt, was gradually added so as to maintain a solution temperature equal to or lower than 40° C. to be dissolved. Since dissolving of (CF₃SO₂)₂NLi momentarily stagnated at a time point when approximately 13 g of (CF₃SO₂)₂NLi was added, the flask was heated by placing the flask in a temperature controlled bath such that the solution temperature in the flask reaches 50° C. to dissolve (CF₃SO₂)₂NLi. Since dissolving of (CF₃SO₂)₂NLi stagnated again at a time point when approximately 15 g of (CF₃SO₂)₂NLi was added, a single drop of 1,2-dimethoxyethane was added thereto using a pipette to dissolve (CF₃SO₂)₂NLi. Furthermore, (CF₃SO₂)₂NLi was gradually added to accomplish adding an entire predetermined amount of (CF₃SO₂)₂NLi. The obtained electrolytic solution was transferred to a 20-mL measuring flask, and 1,2-dimethoxyethane was added thereto until a volume of 20 mL was obtained. The volume of the obtained electrolytic solution was 20 mL, and 18.38 g of (CF₃SO₂)₂NLi was contained in the electrolytic solution. This was used as electrolytic solution A. In electrolytic solution A, the concentration of (CF₃SO₂)₂NLi was 3.2 mol/L and the density was 1.39 g/cm³. The density was measured at 20° C.

The production was performed within a glovebox under an inert gas atmosphere.

(Electrolytic Solution B)

With a method similar to that of electrolytic solution A, electrolytic solution B whose concentration of (CF₃SO₂)₂NLi was 2.8 mol/L and whose density was 1.36 g/cm³ was produced.

(Electrolytic Solution C)

Approximately 5 mL of acetonitrile, which is an organic solvent, was placed in a flask including a stirring bar. Under a stirring condition, with respect to acetonitrile in the flask, (CF₃SO₂)₂NLi, which is a lithium salt, was gradually added to be dissolved. A predetermined amount of (CF₃SO₂)₂NLi was added to the flask, and stirring was performed overnight in the flask. The obtained electrolytic solution was transferred to a 20-mL measuring flask, and acetonitrile was added thereto until a volume of 20 mL was obtained. This was used as electrolytic solution C. The production was performed within a glovebox under an inert gas atmosphere.

Electrolytic solution C contained (CF₃SO₂)₂NLi at a concentration of 4.2 mol/L, and had a density of 1.52 g/cm³.

(Electrolytic Solution D)

With a method similar to that of electrolytic solution C, electrolytic solution D whose concentration of (CF₃SO₂)₂NLi was 3.0 mol/L and whose density was 1.31 g/cm³ was produced.

(Electrolytic Solution E)

With a method similar to that of electrolytic solution C except for using sulfolane as the organic solvent, electrolytic solution E whose concentration of (CF₃SO₂)₂NLi was 3.0 mol/L and whose density was 1.57 g/cm³ was produced.

(Electrolytic Solution F)

With a method similar to that of electrolytic solution C except for using dimethyl sulfoxide as the organic solvent, electrolytic solution F whose concentration of (CF₃SO₂)₂NLi was 3.2 mol/L and whose density was 1.49 g/cm³ was produced.

(Electrolytic Solution G)

With a method similar to that of electrolytic solution C except for using (FSO₂)₂NLi as the lithium salt and using 1,2-dimethoxyethane as the organic solvent, electrolytic solution G whose concentration of (FSO₂)₂NLi was 4.0 mol/L and whose density was 1.33 g/cm³ was produced.

(Electrolytic Solution H)

With a method similar to that of electrolytic solution G, electrolytic solution H whose concentration of (FSO₂)₂NLi was 3.6 mol/L and whose density was 1.29 g/cm³ was produced.

(Electrolytic Solution I)

With a method similar to that of electrolytic solution G, electrolytic solution I whose concentration of (FSO₂)₂NLi was 2.4 mol/L and whose density was 1.18 g/cm³ was produced.

(Electrolytic Solution J)

With a method similar to that of electrolytic solution G except for using acetonitrile as the organic solvent, electrolytic solution J whose concentration of (FSO₂)₂NLi was 5.0 mol/L and whose density was 1.40 g/cm³ was produced.

(Electrolytic Solution K)

With a method similar to that of electrolytic solution J, electrolytic solution K whose concentration of (FSO₂)₂NLi was 4.5 mol/L and whose density was 1.34 g/cm³ was produced.

(Electrolytic Solution L)

Approximately 5 mL of dimethyl carbonate, which is an organic solvent, was placed in a flask including a stirring bar. Under a stirring condition, with respect to dimethyl carbonate in the flask, (FSO₂)₂NLi, which is a lithium salt, was gradually added to be dissolved. A total amount of 14.64 g of (FSO₂)₂NLi was added to the flask, and stirring was performed overnight in the flask. The obtained electrolytic solution was transferred to a 20-mL measuring flask, and dimethyl carbonate was added thereto until a volume of 20 mL was obtained. This was used as electrolytic solution L. The production was performed within a glovebox under an inert gas atmosphere.

The concentration of (FSO₂)₂NLi in electrolytic solution L was 3.9 mol/L, and the density of electrolytic solution L was 1.44 g/cm³.

(Electrolytic Solution M)

With a method similar to that of electrolytic solution L, electrolytic solution M whose concentration of (FSO₂)₂NLi was 2.9 mol/L and whose density was 1.36 g/cm³ was produced.

(Electrolytic Solution N)

Approximately 5 mL of ethyl methyl carbonate, which is an organic solvent, was placed in a flask including a stirring bar. Under a stirring condition, with respect to ethyl methyl carbonate in the flask, (FSO₂)₂NLi, which is a lithium salt, was gradually added to be dissolved. A total amount of 12.81 g of (FSO₂)₂NLi was added to the flask, and stirring was performed overnight in the flask. The obtained electrolytic solution was transferred to a 20-mL measuring flask, and ethyl methyl carbonate was added thereto until a volume of 20 mL was obtained. This was used as electrolytic solution N. The production was performed within a glovebox under an inert gas atmosphere.

The concentration of (FSO₂)₂NLi in electrolytic solution N was 3.4 mol/L, and the density of electrolytic solution N was 1.35 g/cm³.

(Electrolytic Solution O)

Approximately 5 mL of diethyl carbonate, which is an organic solvent, was placed in a flask including a stirring bar. Under a stirring condition, with respect to diethyl carbonate in the flask, (FSO₂)₂NLi, which is a lithium salt, was gradually added to be dissolved. A total amount of 11.37 g of (FSO₂)₂NLi was added to the flask, and stirring was performed overnight in the flask. The obtained electrolytic solution was transferred to a 20-mL measuring flask, and diethyl carbonate was added thereto until a volume of 20 mL was obtained. This was used as electrolytic solution 0. The production was performed within a glovebox under an inert gas atmosphere.

The concentration of (FSO₂)₂NLi in electrolytic solution O was 3.0 mol/L, and the density of electrolytic solution O was 1.29 g/cm³.

Table 33 shows a list of the electrolytic solutions described above.

TABLE 33

| | Lithium salt | Organic solvent | Density d (g/cm³) |
|---|---|---|---|
| Electrolytic solution A | LiTFSA | DME | 1.39 |
| Electrolytic solution B | LiTFSA | DME | 1.36 |
| Electrolytic solution C | LiTFSA | AN | 1.52 |
| Electrolytic solution D | LiTFSA | AN | 1.31 |
| Electrolytic solution E | LiTFSA | SL | 1.57 |
| Electrolytic solution F | LiTFSA | DMSO | 1.49 |
| Electrolytic solution G | LiFSA | DME | 1.33 |
| Electrolytic solution H | LiFSA | DME | 1.29 |
| Electrolytic solution I | LiFSA | DME | 1.18 |
| Electrolytic solution J | LiFSA | AN | 1.40 |
| Electrolytic solution K | LiFSA | AN | 1.34 |
| Electrolytic solution L | LiFSA | DMC | 1.44 |
| Electrolytic solution M | LiFSA | DMC | 1.36 |
| Electrolytic solution N | LiFSA | EMC | 1.35 |
| Electrolytic solution O | LiFSA | DEC | 1.29 |

LiTFSA: (CF₃SO₂)₂NLi,
LiFSA: (FSO₂)₂NLi,
AN: acetonitrile,
DME: 1,2-dimethoxyethane,
DMSO: dimethyl sulfoxide,
SL: sulfolane,
DMC: dimethyl carbonate,
EMC: ethyl methyl carbonate,
DEC: diethyl carbonate

### Example B-1

A half-cell including a positive electrode (working electrode) and an electrolytic solution was produced, and cyclic voltammetry (CV) evaluation was performed thereon.

The positive electrode includes a positive electrode active material layer, and a current collector coated with the positive electrode active material layer. The positive electrode active material layer includes a positive electrode active material, a binding agent, and a conductive additive. The positive electrode active material is formed from LiMn₂O₄. The binding agent is formed from polyvinylidene fluoride (PVDF). The conductive additive is formed from acetylene black (AB). The current collector is formed from an aluminum foil having a thickness of 20 μm. The contained mass ratio of the positive electrode active material, the binding agent, and the conductive additive is 94:3:3 when mass of the positive electrode active material layer is defined as 100 parts by mass.

In order to produce the positive electrode, LiMn₂O₄, PVDF, and AB were mixed in the above described mass ratio, and N-methyl-2-pyrrolidone (NMP) was added thereto as the solvent to obtain a positive electrode material in a paste form. The positive electrode material in the paste form was applied on the surface of the current collector using a doctor blade to form the positive electrode active material layer. The positive electrode active material layer was dried for 20 minutes at 80° C. to remove the NMP through volatilization. An aluminum foil having the positive electrode active material layer formed on the surface thereof was compressed using a roll press machine to firmly attach and join the aluminum foil and the positive electrode active material layer. The obtained joined object was heated in a vacuum dryer for 6 hours at 120° C. and cut in a predetermined shape to obtain the positive electrode.

The above described electrolytic solution E8 was used as the electrolytic solution in Example B-1.

A half-cell was produced using the positive electrode (working electrode) and the electrolytic solution described above. The counter electrode was formed from metal lithium. The separator was formed from a glass nonwoven fabric filter.

### Example B-2

The above described electrolytic solution E4 was used as the electrolytic solution in Example B-2. The half-cell of Example B-2 was similar to those of Example B-1 regarding other aspects.

### Example B-3

The above described electrolytic solution E11 was used as the electrolytic solution in Example B-3. The half-cell of Example B-3 was similar to those of Example B-1 regarding other aspects.

### Comparative Example B-1

The above described electrolytic solution C5 was used as the electrolytic solution in Comparative Example B-1. The half-cell of Example B-3 was similar to those of Example B-1 regarding other aspects.

### Evaluation Example B-1

### CV Evaluation

Cyclic Voltammetry (CV) evaluation test was performed on the half-cell of Example B-1. The evaluation conditions were sweep rate of 0.1 mV/s and sweep range of 3.1 V to 4.6 V (vs Li), and charging and discharging were repeated for 2 cycles.

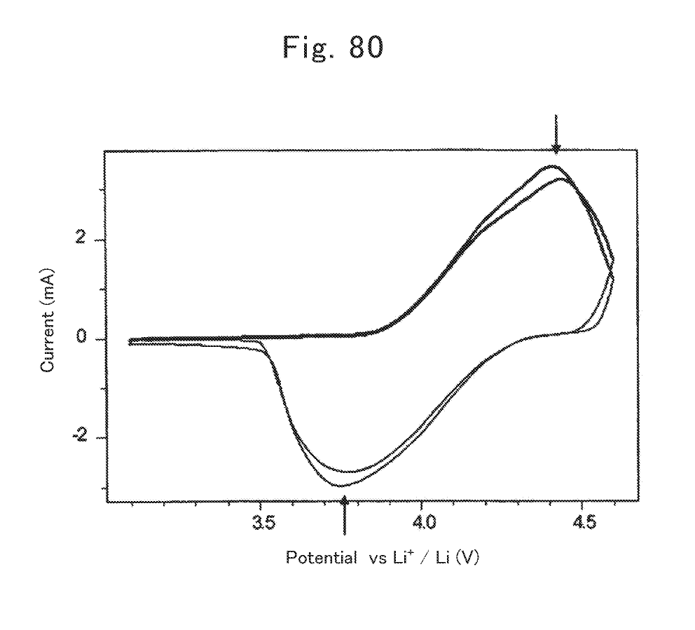

The results of CV measurement are shown in FIG. 80. The horizontal axis represents potential (vs. Li/Li⁺) of the working electrode, and the vertical axis represents current generated through redox. As shown in FIG. 80, an oxidation peak and a reduction peak were confirmed respectively at around 4.4 V and at around 3.8 V, revealing that a reversible electrochemical reaction had occurred. Based on this, in the nonaqueous secondary battery including the positive electrode and the electrolytic solution described above, a reversible electrochemical reaction was revealed to be occurring.

### Evaluation Example B-2

### Charging/Discharging Characteristics

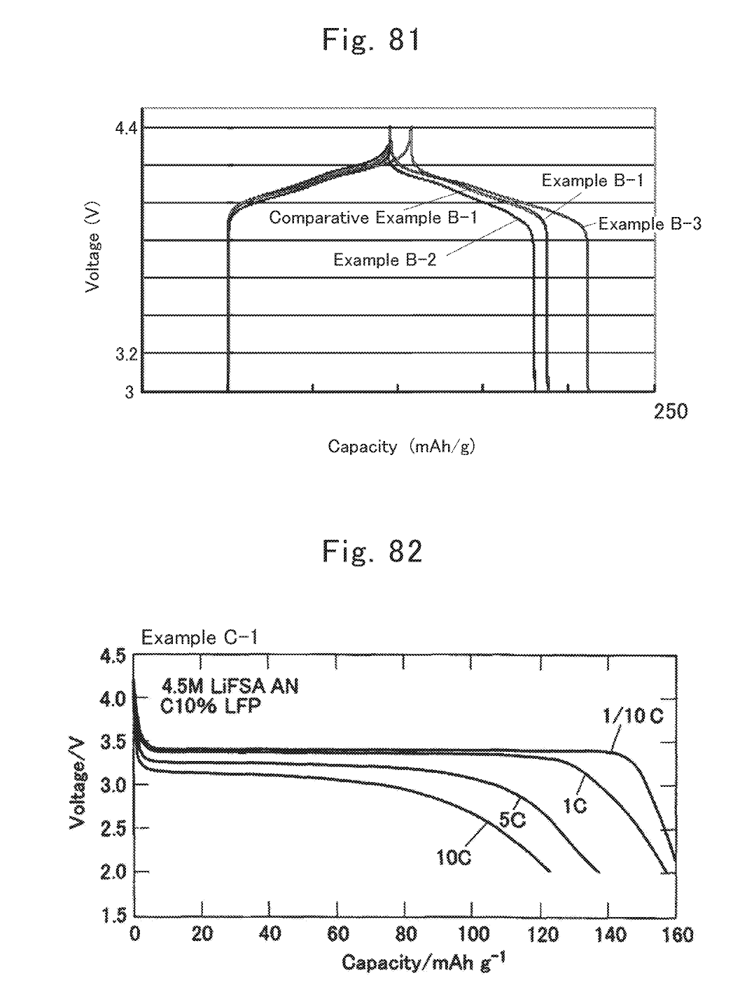

With respect to the half-cells of Examples B-1, B-2, and B-3 and Comparative Example B-1, CC charging and discharging was performed at 0.1 C (1 C represents a current value required for fully charging or discharging a battery in 1 hour under constant current) in a range of 3 V to 4.4 V, and charging/discharging curves were obtained. The measurement results are shown in FIG. 81.

Based on the results, the half-cells of Examples B-1 and B-2 using the electrolytic solution of the present invention were revealed to provide a charge/discharge capacity comparable to that of Comparative Example B-1 using a general electrolytic solution. Furthermore, Example B-3 had a charge capacity and a discharge capacity that were larger than those of Example B-1 and B-2 and Comparative Example B-1. Thus, the reversible capacity of Example B-3 increased. Although the reason for that is uncertain, in a linear carbonate based high-concentration electrolytic solution, the usable capacity is speculated to increase due to a decrease in an initial irreversible capacity.

### Example C-1

Example C-1 relates to a half-cell including a working electrode (positive electrode), a counter electrode (negative electrode), and an electrolytic solution.

The positive electrode that serves as the working electrode includes a positive electrode active material layer, and a current collector coated with the positive electrode active material layer. The positive electrode active material layer includes a positive electrode active material, a binding agent, and a conductive additive. The positive electrode active material includes a conductive carbon by 10%, and LiFePO₄ having an olivine structure. The binding agent is formed from polyvinylidene fluoride (PVDF). The conductive additive is formed from acetylene black (AB). The current collector is formed from an aluminum foil having a thickness of 20 μm. The contained mass ratio of the positive electrode active material, the binding agent, and the conductive additive is 90:5:5 when mass of the positive electrode active material layer is defined as 100 parts by mass.

In order to produce the positive electrode, LiFePO₄, PVDF, and AB were mixed in the above described mass ratio, and N-methyl-2-pyrrolidone (NMP) was added thereto as the solvent to obtain a positive electrode material in a paste form. The positive electrode material in the paste form was applied on the surface of the current collector using a doctor blade to form the positive electrode active material layer. The positive electrode active material layer was dried for 20 minutes at 80° C. to remove the NMP through volatilization. An aluminum foil having the positive electrode active material layer formed on the surface thereof was compressed using a roll press machine to firmly attach and join the aluminum foil and the positive electrode active material layer. The obtained joined object was heated in a vacuum dryer for 6 hours at 120° C. and cut in a predetermined shape to obtain the positive electrode.

The above described electrolytic solution E8 was used as the electrolytic solution in Example C-1.

A half-cell was produced using the positive electrode (working electrode) and the electrolytic solution described above. The counter electrode was formed from metal lithium. The separator was formed from a glass filter (GE Healthcare Japan Corp., thickness of 400 μm).

### Example C-2

A half-cell of Example C-2 used the above described electrolytic solution E11 as the electrolytic solution. The other configurations were similar to those of Example C-1.

### Example C-3

A half-cell of Example C-3 used the above described electrolytic solution E13 as the electrolytic solution. The other configurations were similar to those of Example C-1.

### Comparative Example C-1

A half-cell of Comparative Example C-1 used the above described electrolytic solution C5 as the electrolytic solution. The other configurations were similar to those of Example C-1.

### Comparative Example C-2

A half-cell of Comparative Example C-2 used the above described electrolytic solution C6 as the electrolytic solution. The other configurations were similar to those of Example C-1.

### Evaluation Example C-1

### Rate Capacity Evaluation 1

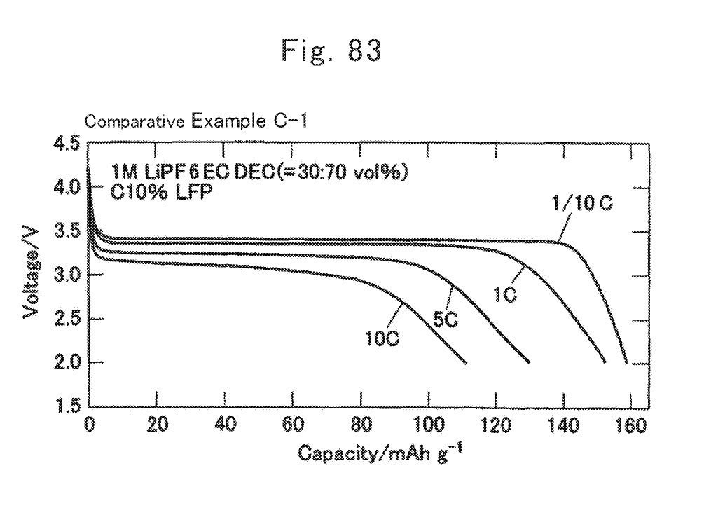

With respect to the half-cells of Example C-1 and Comparative Example C-1, constant current charging was performed at 0.1 C (1 C represents a current value required for full charging or discharging a battery in 1 hour under a constant current) rate up to 4.2 V (vs Li). Then, discharging was performed at 0.1 C, 1 C, 5 C, and 10 C rates down to 2 V, and the capacity (discharge capacity) at each of the rates was measured. Discharging curves at each of the rates are shown in FIGS. 82 and 83 for Example C-1 and Comparative Example C-1. Ratios (rate capacity characteristics) of discharge capacities at 5 C and 10 C with respect to 0.1 C-discharge capacity were calculated. The results are shown in Table 34.

TABLE 34

| | 0.1 C- | 5 C- | 10 C- | 5 C | 10 C |
|---|---|---|---|---|---|
| | discharge | discharge | discharge | capacity/ | capacity/ |
| | capacity | capacity | capacity | 0.1 C | 0.1 C |
| | mAh/g | mAh/g | mAh/g | capacity | capacity |
| Example C-1 | 160 | 137 | 123 | 0.86 | 0.77 |
| Comparative | 160 | 130 | 111 | 0.81 | 0.69 |
| Example C-1 | | | | | |

As shown in FIGS. 82 and 83 and Table 34, compared to the half-cell of Comparative Example C-1, the half-cell of Example C-1 of the present invention displayed suppression of decrease in capacity when the rate was increased, and showed excellent rate capacity characteristics. The secondary battery using the electrolytic solution of the present invention was revealed to show excellent rate capacity characteristics.

### Evaluation Example C-2

### Charging/Discharging Test

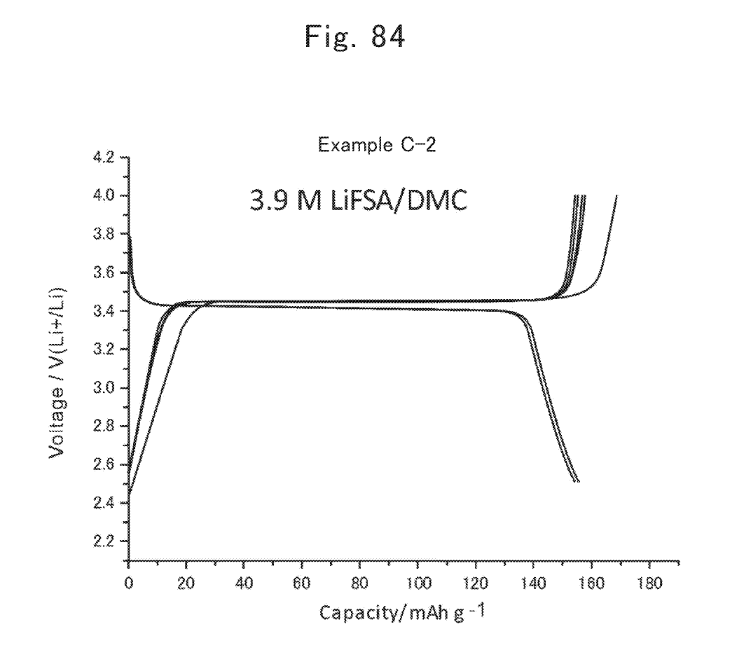

A charging/discharging test was performed on the half-cell of Example C-2. The charging/discharging conditions were 0.1 C, constant current, and a range of 2.5 V to 4.0 V (vs Li). Charging and discharging were each repeated for five times. Charging/discharging curves are shown in FIG. 84.

As shown in FIG. 84, the half-cell of Example C-2 was confirmed to undergo repeated charging and discharging reversibly.

### Evaluation Example C-3

### Rate Capacity Evaluation 2

With respect to the half-cell of Example C-2, charging and discharging were repeated at constant current in a range of 2.5 to 4.0V. A discharge capacity at each cycle of charging and discharging was measured. The rate of charging and discharging was changed every three cycles in the following manner.

3 cycles at 0.1 C→3 cycles at 0.2 C→3 cycles at 0.5 C→3 cycles at 1 C→3 cycles at 2 C→3 cycles at 5 C→3 cycles at 0.1 C

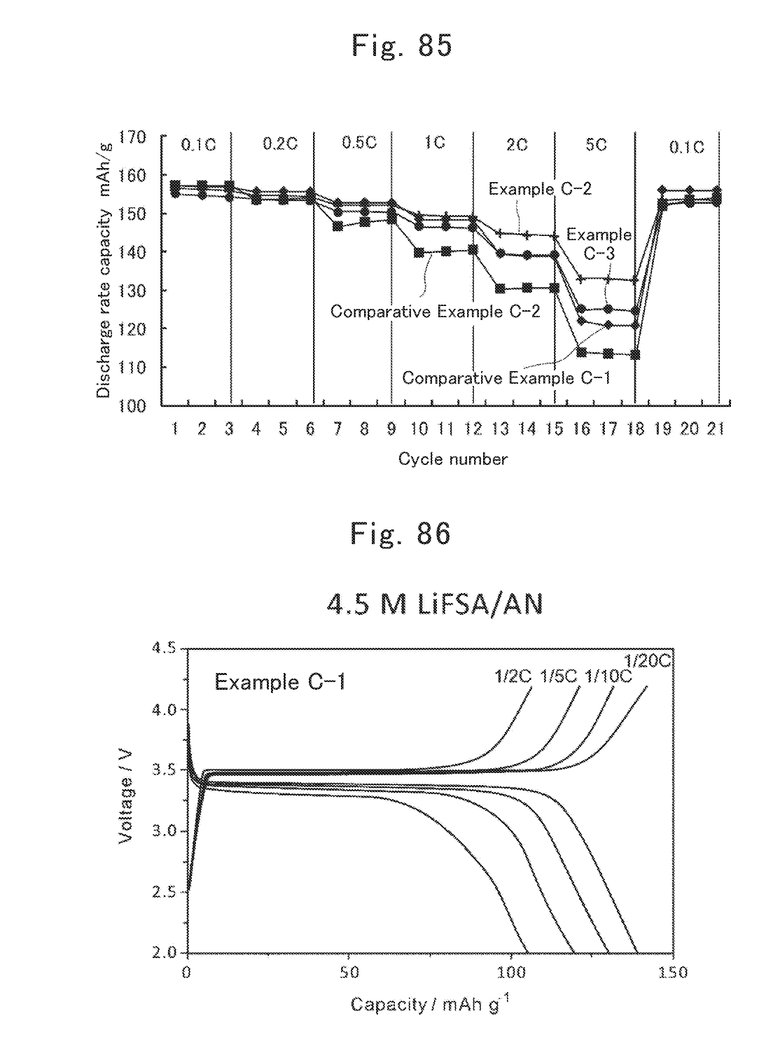

A discharge rate capacity was measured at each cycle, and the results are shown in FIG. 85. In addition, respective discharge capacities of the second cycle in the three cycles at 0.1 C and 5 C in the rate capacity test at room temperature are shown in Table 35.

TABLE 35

| | 0.1 C-discharge | 5 C-discharge | |
|---|---|---|---|
| | capacity | capacity | 5 C-discharge/0.1 C |
| | mAh/g | mAh/g | capacity |
| Example C-2 | 156 | 133 | 0.85 |
| Example C-3 | 156 | 124 | 0.80 |
| Comparative | 157 | 121 | 0.77 |
| Example C-1 | | | |
| Comparative | 157 | 113 | 0.72 |
| Example C-2 | | | |

As shown in FIG. 85 and Table 35, when compared to Comparative Examples C-1 and C-2, Examples C-2 and C-3 had higher discharge rate capacities. In particular, the discharge rate capacities at 0.5 C to 5 C rates of Examples C-2 and C-3 were significantly higher than those of Comparative Examples C-1 and C-2. Between Examples C-2 and C-3, the rate capacities of Example C-2 were higher than those of Example C-3.

### Evaluation Example C-4

### Rate Capacity Evaluation at Low Temperature

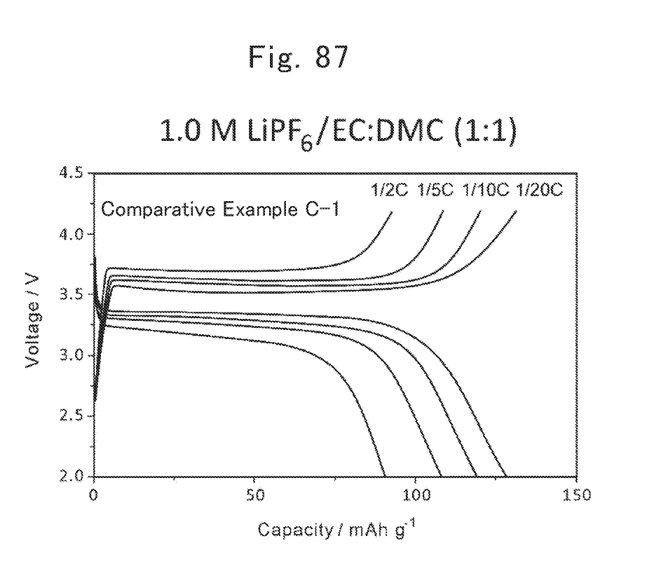

With respect to the half-cells of Example C-1 and Comparative Example C-1, in an environment of −20° C., constant current charging up to 4.2 V (vs Li) was performed at 0.1 C rate, then discharging was performed at 0.05 C and 0.5 C rates down to 2 V, and discharge capacity and charge capacity at each of the rates were measured. Charging/discharging curves of the half-cell of Example C-1 at each of the rates are shown in FIG. 86, and charging/discharging curves of the half-cell of Comparative Example C-1 are shown in FIG. 87. Discharge capacities of the half-cells of Example C-1 and Comparative Example C-1 at 0.05 C and 0.5 C rates, and the ratios (rate capacity characteristics) of the discharge capacity at 0.5 C with respect to the discharge capacity at 0.05 C are shown in Table 36. Charge capacities of the half-cells of Example C-1 and Comparative Example C-1 at 0.05 C and 0.5 C rates, and the ratios (rate capacity characteristic) of the charge capacity at 0.5 C with respect to the charge capacity at 0.05 C are shown in Table 37.

TABLE 36
Discharge capacity test (−20° C.)

| | 0.05 C-discharge | 0.5-discharge | |
|---|---|---|---|
| | capacity | capacity | 0.5 C capacity/0.05 C |
| | mAh/g | mAh/g | capacity |
| Example C-1 | 139 | 104 | 75 |
| Comparative | 128 | 91 | 71 |
| Example C-1 | | | |

TABLE 37
Charge capacity test (−20° C.)

| | 0.05 C-discharge | 0.5 C-discharge | |
|---|---|---|---|
| | capacity | capacity | 0.5 C capacity/ |
| | mAh/g | mAh/g | 0.05 C capacity |
| Example C-1 | 142 | 106 | 75 |
| Comparative | 131 | 92 | 70 |
| Example C-1 | | | |

As shown in Tables 36 and 37, when compared to Comparative Example C-1, Example C-1 displayedhigh rate capacity characteristics (0.5 C/0.05 C capacity) for both charging and discharging. As shown in FIGS. 86 and 87, when Example C-1 is compared to Comparative Example C-1, in Comparative Example C-1, for example the difference between the potential (closed circuit potential) in the charging curve and the potential (closed circuit potential) in the discharging curve at a point of 50 mAh/g is large, and this difference is particularly prominent during high rate testing such as at ½ C. On the other hand, when compared to Comparative Example C-1, the electric potential difference is extremely small in Example C-1. Thus, Example C-1 is considered to have smaller polarization than Comparative Example C-1.

(Battery D-1)

Platinum (Pt) was used as the working electrode, and lithium metal (Li) was used as the counter electrode. A glass nonwoven fabric filter was used as the separator.

By using electrolytic solution E1, the working electrode, and the electrolytic solution, and the separator described above, a half-cell of battery D-1 was produced.

(Battery D-2)

A half-cell of battery D-2 was produced with a method similar to that for battery D-1, except for using electrolytic solution E4 as the electrolytic solution.

(Battery D-3)

A half-cell of battery D-3 was produced with the following method.

The working electrode was produced in the following manner.

89 parts by mass of LiNi_{0.5}Mn_{1.5}O₄ which is an active material and 11 parts by mass of polyvinylidene fluoride which is a binding agent were mixed. The mixture was dispersed in a proper amount of N-methyl-2-pyrrolidone to create a slurry. As the current collector, a copper foil having a thickness of 20 μm was prepared. The slurry was applied in a film form on the surface of the copper foil by using a doctor blade. The copper foil on which the slurry was applied was dried to remove N-methyl-2-pyrrolidone, and then the copper foil was pressed to obtain a joined object. The obtained joined object was heated and dried in a vacuum dryer for 6 hours at 120° C. to obtain a copper foil having the active material layer formed thereon. This was used as the working electrode. The mass of the active material per 1 cm² of the copper foil was 6.3 mg.

The counter electrode was formed from lithium metal. The working electrode, the counter electrode, the separator formed from the glass nonwoven fabric filter, and electrolytic solution E4 were housed in a battery case (CR2032 type coin cell case manufactured by Hohsen Corp.) having a diameter of 13.82 mm to form a half-cell. This was used as a half-cell of battery D-3.

(Battery D-4)

A half-cell of battery D-4 was produced with a method similar to that for battery D-3, except for using electrolytic solution Ell.

(Battery D-C1)

A half-cell of battery D-C1 was produced with a method similar to that for battery D-1, except for using electrolytic solution Cl as the electrolytic solution.

(Battery D-C2)

A half-cell of battery D-C2 was produced similarly to battery D-1, except for using, as the electrolytic solution, electrolytic solution C9 whose organic solvent was DME and whose concentration of (CF₃SO₂)₂NLi was 0.1 mol/L. In electrolytic solution C9 in battery D-C2, 93 molecules of 1,2-dimethoxyethane were contained with respect to 1 molecule of (CF₃SO₂)₂NLi.

Table 38 shows a list of the electrolytic solutions used in respective batteries.

TABLE 38

| | | | | Organic solvent/ |
|---|---|---|---|---|
| | Lithium | Organic | Lithium salt | lithium salt |
| | salt | solvent | concentration (mol/L) | (mol ratio) |
| Battery | LiTFSA | DME | 3.2 | 1.6 |
| D-1 | | | | |
| Battery | LiTFSA | AN | 4.2 | 1.9 |
| D-2 | | | | |
| Battery | LiTFSA | AN | 4.2 | 1.9 |
| D-3 | | | | |
| Battery | LiFSA | DMC | 3.9 | 2 |
| D-4 | | | | |
| Battery | LiTFSA | DME | 1.0 | 8.3 |
| D-C1 | | | | |
| Battery | LiTFSA | DME | 0.1 | 93 |
| D-C2 | | | | |

LiTFSA: (CF₃SO₂)₂NLi,
LiFSA: (FSO₂)₂NLi,
AN: acetonitrile,
DME: 1,2-dimethoxyethane,
DMC: dimethyl carbonate

### Evaluation Example D-1

### LSV Measurement

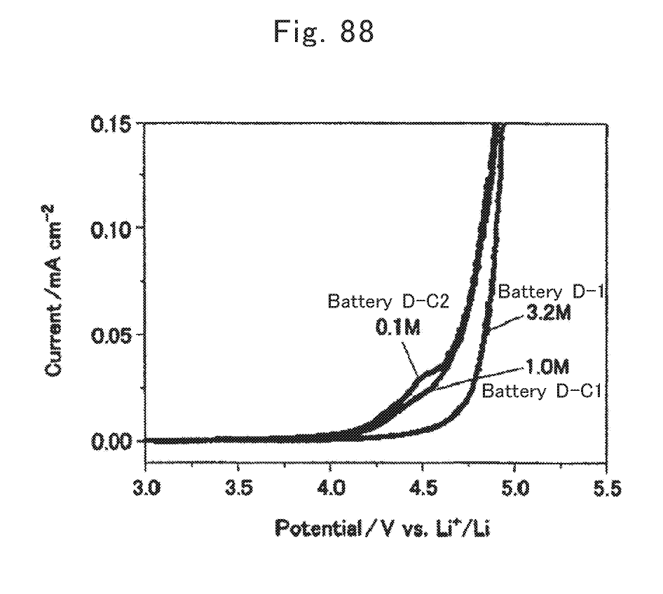

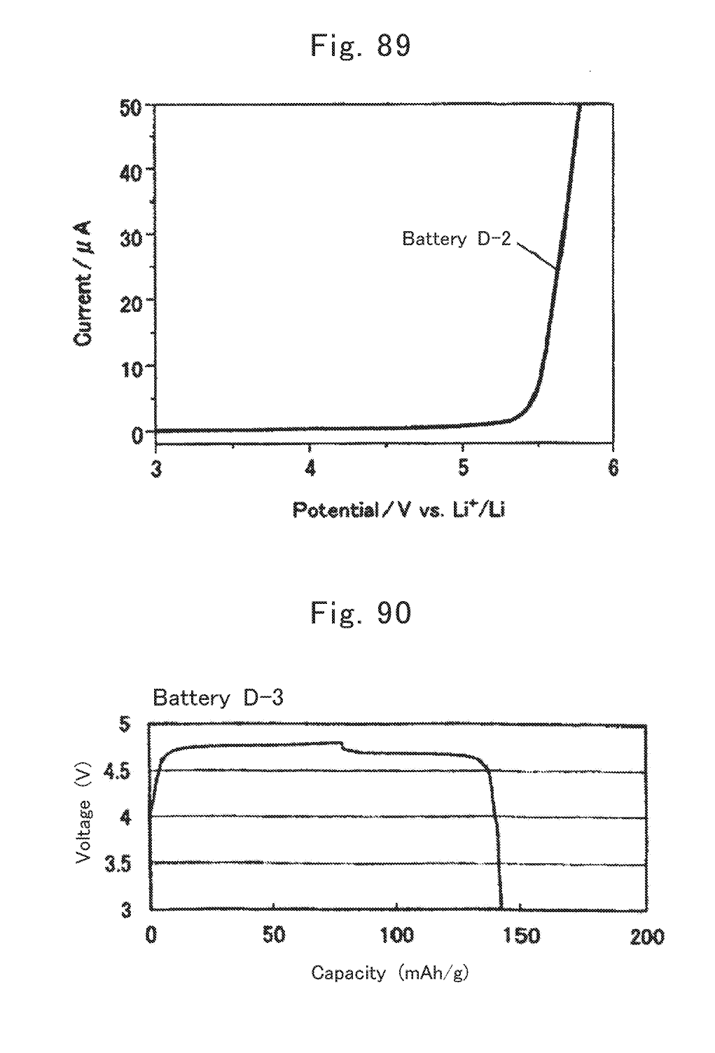

With respect to the half-cells of batteries D-1, D-2, D-C1, and D-C2, measurement of linear sweep voltammetry (LSV) was performed. The measuring conditions were sweep rate of 0.1 mV/s for batteries D-1, D-C1, and D-C2, and sweep rate of 1 mV/s for battery D-2. FIGS. 88 and 89 show potential-current curves formed from the LSV measurement. FIG. 88 shows potential-current curves of batteries D-1, D-C1, and D-C2, and FIG. 89 shows a potential-current curve of battery D-2. In FIG. 88, the horizontal axis represents potential (V) when a Li⁺/Li electrode was used for reference potential, and the vertical axis represents current value (mAcm⁻²). In FIG. 89, the horizontal axis represents potential (V) when a Li⁺/Li electrode was used for reference potential, and the vertical axis represents current value (μA).

As shown in FIG. 88, the rising part of the potential-current curve of battery D-1 is located toward the high potential side than the rising parts of Comparative Examples 1 and 2. With battery D-1, the starting point of the rising part was located at a potential of 4.7 V when the Li/Li⁺ electrode was used for reference potential, and the rising part showed a potential equal to or higher than the potential of 4.7 V which is the starting point.

With battery D-2, the starting point of the rising part was located at a potential of 5.7 V when the Li/Li⁺ electrode was used for reference potential, and the rising part showed a potential equal to or higher than the potential of 5.7 V which is the starting point . Based on above, oxidative degradation potential at which an oxidative reaction occurs was revealed to be equal to or higher than 4.5 V in the electrolytic solution of battery D-1, and equal to or higher than 5 V for battery D-2.

In batteries D-1, D-2, and D-C1, when a second derivative, obtained through twice differentiating increase level of current with respect to increase level of potential, was defined as “B,” a relationship of B≧0 was satisfied in a range from a point immediately after voltage application to the rising part in the current-potential curve.

The starting point of the rising part was 4.2 V in battery D-C1, and 4.2 V in battery D-C2. With battery D-C2, a relationship of B<0 was satisfied around a potential of 4.5 to 4.6 V (vs Li⁺/Li). An ordinary secondary battery includes detection means for detecting a rapid drop in voltage occurring when being fully charged, and termination means for shutting down charging when a rapid drop in voltage occurs. A lithium ion secondary battery produced by using electrolytic solution C9 of battery D-C2 may be mistakenly determined, during charging from the start of voltage application to the rising part, by the detection means as to be undergoing a rapid drop in voltage observed in excessive charging, and the charging may be shut down by the termination means.

### Evaluation Example D-2

### Charging/Discharging Characteristics

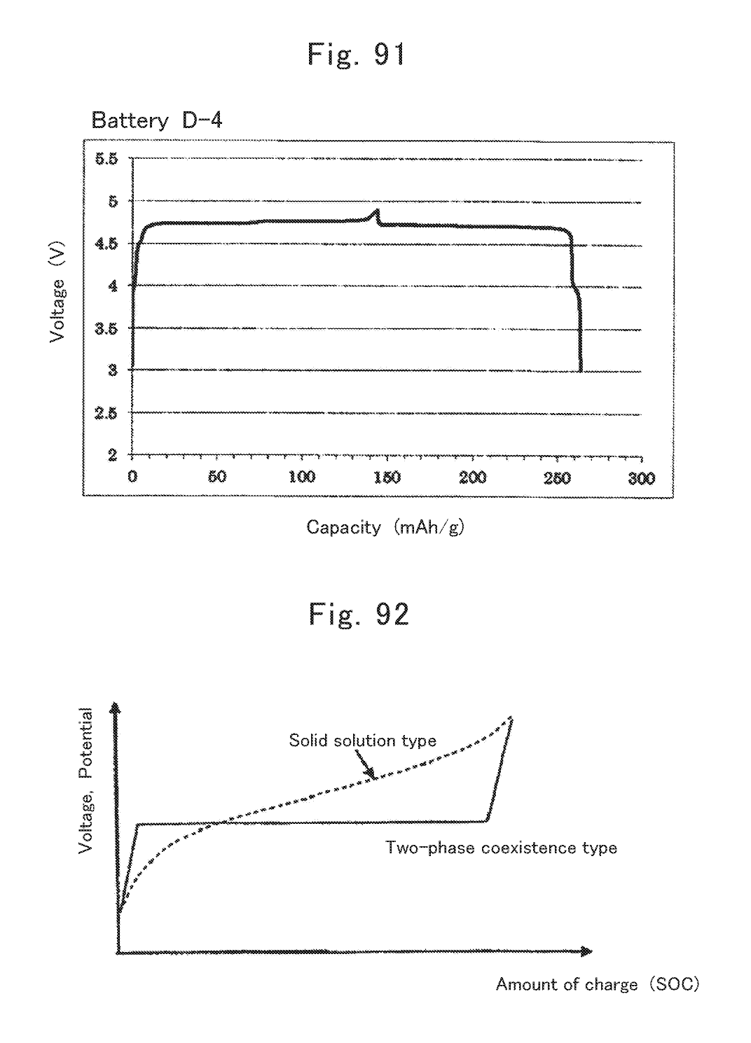

With respect to the half-cell of battery D-3, CC charging and discharging was performed in a range of 3 V to 4.8 V at 0.1 C (1 C represents a current value required for fully charging or discharging a battery in 1 hour under constant current), and a charging/discharging curve was obtained. The measurement result of battery D-3 is shown in FIG. 90. In addition, with respect to the half-cell of battery D-4, CC charging and discharging was performed in a range of 3.0 V to 4.9 V at 0.1 C, and a charging/discharging curve was obtained. The measurement result of battery D-4 is shown in FIG. 91.

As shown in FIG. 90, charging and discharging was successfully performed reversibly with the half-cell of battery D-3 at 4.8 V. In addition, as shown in FIG. 91, charging and discharging was successfully performed reversibly with the half-cell of battery D-4 at 4.9 V. The capacity of the half-cell of battery D-4 was approximately 120 mAh/g.

(Battery D-5)

A half-cell using electrolytic solution E8 was produced in the following manner.

90 parts by mass of graphite which is an active material and whose mean particle diameter is 10 μm was mixed with 10 parts by mass of polyvinylidene fluoride which is a binding agent. The mixture was dispersed in a proper amount of N-methyl-2-pyrrolidone to create a slurry. As the current collector, a copper foil having a thickness of 20 μm was prepared. The slurry was applied in a film form on the surface of the copper foil by using a doctor blade. The copper foil on which the slurry was applied was dried to remove N-methyl-2-pyrrolidone, and then the copper foil was pressed to obtain a joined object. The obtained joined object was heated and dried in a vacuum dryer for 6 hours at 120° C. to obtain a copper foil having the active material layer formed thereon . This was used as the working electrode. The mass of the active material per 1 cm² of the copper foil was 1.48 mg. In addition, the density of graphite and polyvinylidene fluoride before pressing was 0.68 g/cm³, whereas the density of the active material layer after pressing was 1.025 g/cm³.

Metal Li was used as the counter electrode.

The working electrode, the counter electrode, a Whatman glass fiber filter paper having a thickness of 400 μm interposed therebetween as the separator, and electrolytic solution E8 were housed in a battery case (CR2032 type coin cell case manufactured by Hohsen Corp.) having a diameter of 13.82 mm to form a half-cell. This was used as a half-cell of battery D-5.

(Battery D-6)

A half-cell of battery D-6 was produced with a method similar to that for battery D-5, except for using electrolytic solution E11.

(Battery D-7)

A half-cell of battery D-7 was produced with a method similar to that for battery D-5, except for using electrolytic solution E16.

(Battery D-8)

A half-cell of battery D-8 was produced with a method similar to that for battery D-5, except for using electrolytic solution E19.

(Battery D-C3)

A half-cell of battery D-C3 was produced with a method similar to that for battery D-5, except for using electrolytic solution as the electrolytic solution C5.

### Evaluation Example D-3

### Reversibility of Charging and Discharging

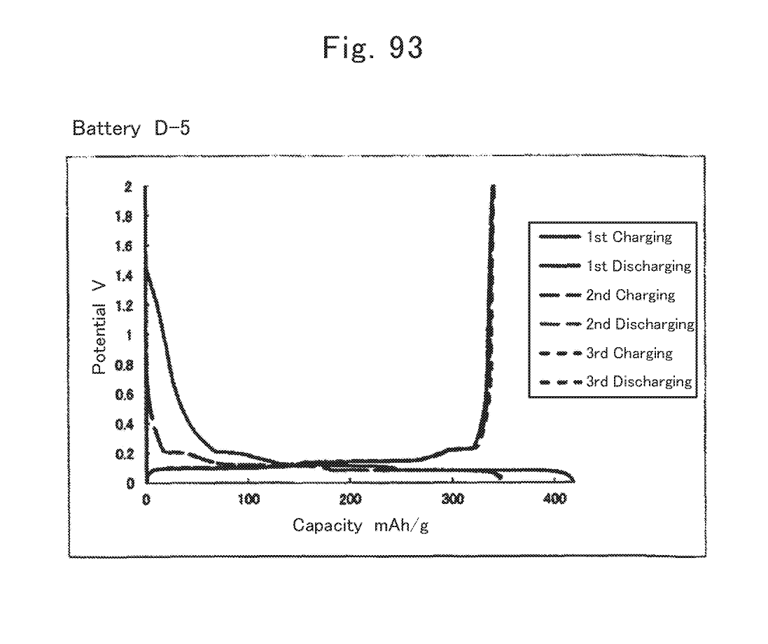

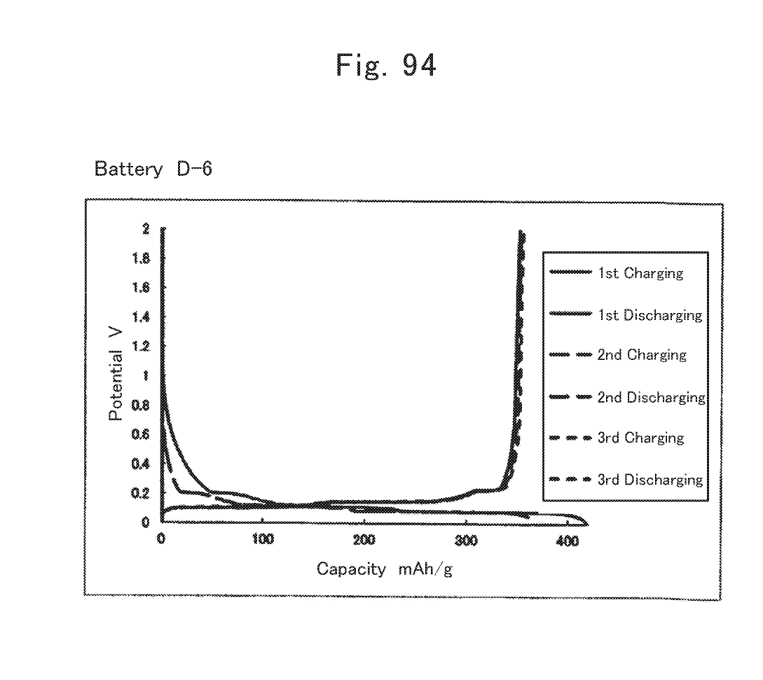

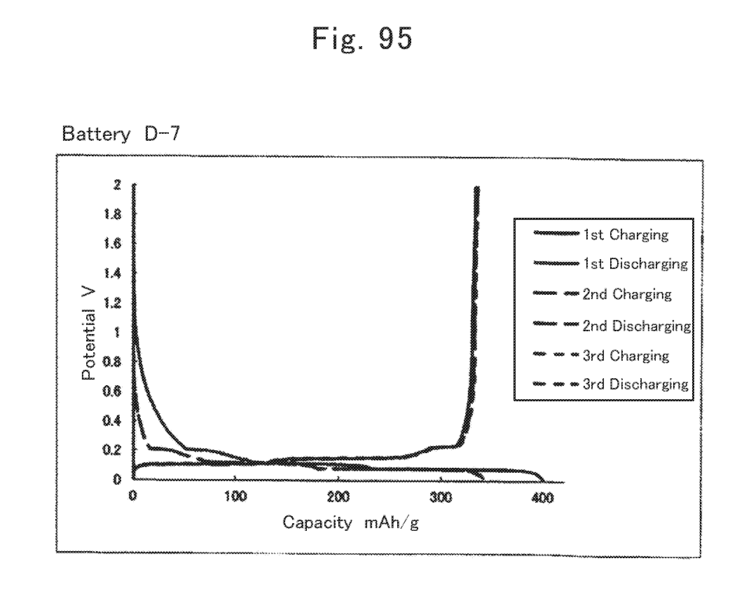

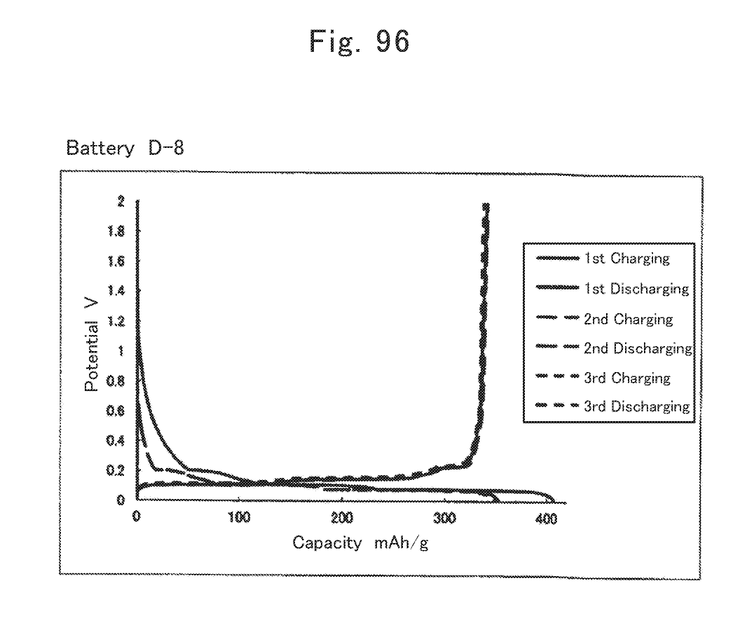

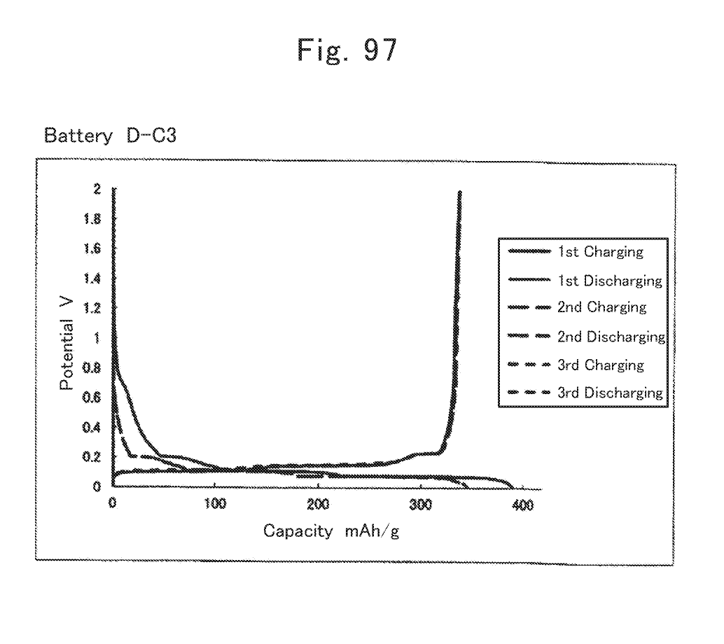

With respect to the half-cells of batteries D-5 to D-8 and D-C3, a charging/discharging cycle from 2.0 V to 0.01 V of CC charging (constant current charging) to a voltage of 2.0 V and CC discharging (constant current discharging) to a voltage of 0.01 V was performed at 25° C. for three cycles at a charging/discharging rate of 0.1 C. The charging/discharging curves of the respective half-cells are shown in FIGS. 93 to 97.

As shown in FIGS. 93 to 97, reversible charging/discharging reaction is performed successfully in the half-cells of batteries D-5 to D-8 in a manner similar to the half-cell of battery D-C3 using a general electrolytic solution.

1. A nonaqueous secondary battery comprising a positive electrode, a negative electrode, and an electrolytic solution, wherein:
the electrolytic solution contains a metal salt whose cation is an alkali metal, an alkaline earth metal, or aluminum, and an organic solvent having a heteroelement;
regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is, or
d/c obtained by dividing a density d (g/cm³) of the electrolytic solution by a concentration c (mol/L) of the electrolytic solution is within a range of 0.15≦d/c≦0.71; and
at least one of the following conditions 1 to 4 is satisfied.
Condition 1: The positive electrode has a positive electrode active material including a lithium metal complex oxide with a layered rock salt structure.
Condition 2: The positive electrode has a positive electrode active material including a lithium metal complex oxide with a spinel structure.
Condition 3: The positive electrode has a positive electrode active material including a polyanion based material.
Condition 4: A usage maximum potential of the positive electrode in the nonaqueous secondary battery is not lower than 4.5 V when Li/Li⁺ is used for reference potential.

2-4. (canceled)

5. The nonaqueous secondary battery according to claim 1, wherein the cation of the metal salt is lithium.

6. The nonaqueous secondary battery according to claim 1, wherein a chemical structure of an anion of the metal salt includes at least one element selected from a halogen, boron, nitrogen, oxygen, sulfur, or carbon.

7. The nonaqueous secondary battery according to claim 1, wherein a chemical structure of an anion of the metal salt is represented by general formula (1), general formula (2), or general formula (3) below:
(R¹X¹)(R²X²)N General Formula (1)
(R¹ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
R² is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
R¹ and R² optionally bind with each other to form a ring.
X¹ is selected from SO₂, C═O, C═S, R^{a}P═O, R^{b}P═S, S═O, or Si═O.
X² is selected from SO₂, C═O, C═S, R^{c}P═O, R^{d}P═S, S═O, or Si═O.
R^{a}, R^{b}, R^{c}, and R^{d} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{a}, R^{b}, R^{c}, and R^{d} each optionally bind with R¹ or R² to form a ring);
R³X³Y General Formula (2)
(R³ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
X³ is selected from SO₂, C═O, C═S, R^{e}P═O, R^{f}P═S, S═O, or Si═O.
R^{e} and R^{f} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{e} and R^{f} each optionally bind with R³ to form a ring.
Y is selected from O or S); and
(R⁴X⁴)(R⁵X⁵)(R⁶X⁶)C General Formula (3)
(R⁴ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
R⁵ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
R⁶ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
Any two or three of R⁴, R⁵, and R⁶ optionally bind with each other to form a ring.
X⁴ is selected from SO₂, C═O, C═S, R^{g}P═O, R^{h}P═S, S═O, or Si═O.
X⁵ is selected from SO₂, C═O, C═S, R¹P═O, R^{j}P═S, S═O, or Si═O.
X⁶ is selected from SO₂, C═O, C═S, R^{k}P═O, R¹P═S, S═O, or Si═O.
R^{g}, R^{h}, Rⁱ, R^{j}, R^{k}, and R^{l} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{g}, R^{h}, Rⁱ, R^{j}, R^{k}, and R^{l} each optionally bind with R⁴, R⁵, or R⁶ to form a ring.).

8. The nonaqueous secondary battery according to claim 1, wherein a chemical structure of an anion of the metal salt is represented by general formula (4), general formula (5), or general formula (6) below:
(R⁷X⁷)(R⁸X⁸)N General Formula (4)
(R⁷ and R⁸ are each independently CₙHₐF_{b}Cl_{c}Br_{d}Iₑ(CN)_{f}(SCN)_{g}(OCN)ₕ.
“n,” “a,” “b,” “c,” “d,” “e,” “f,” “g,” and “h” are each independently an integer not smaller than 0, and satisfy 2n+1=a+b+c+d+e+f+g+h.
R⁷ and R⁸ optionally bind with each other to form a ring, and, in that case, satisfy 2n=a+b+c+d+e+f+g+h.
X⁷ is selected from SO₂, C═O, C═S, R^{m}P═O, RⁿP═S, S═O, or Si═O.
X⁸ is selected from SO₂, C═O, C═S, R^{o}P═O, R^{p}P═S, S═O, or Si═O.
R^{m}, Rⁿ and R^{p} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{m}, Rⁿ, R^{o}, and R^{p} each optionally bind with R⁷ or R⁸ to form a ring);
R⁹X⁹Y General Formula (5)
(R⁹ is C_{N}HₐF_{b}Cl_{c}Br_{d}Iₑ(CN)_{f}(SCN)_{g}(OCN)ₕ.
“n,” “a,” “b,” “c,” “d,” “e,” “f,” “g,” and “h” are each independently an integer not smaller than 0, and satisfy 2n+1=a+b+c+d+e+f+g+h.
X⁹ is selected from SO₂, C═O, C═S, R^{q}P═O, R^{r}P═S, S═O, or Si═O.
R^{q} and R^{r} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{q} and R^{r} each optionally bind with R⁹ to form a ring.
Y is selected from O or S); and
(R¹⁰X¹⁰)(R¹¹X¹¹)(R¹²X¹²)C General Formula (6)
(R¹⁰, R¹¹, and R¹² are each independently CₙHₐF_{b}Cl_{c}Br_{d}Iₑ(CN)_{f}(SCN)_{g}(OCN)ₕ. “n,” “a,” “b,” “c,” “d,” “e,” “f,” “g,” and “h” are each independently an integer not smaller than 0, and satisfy 2n+1=a+b+c+d+e+f+g+h.
Any two of R¹⁰, R¹¹ and R¹² optionally bind with each other to form a ring, and, in that case, groups forming the ring satisfy 2n=a+b+c+d+e+f+g+h. Three of R¹⁰, R¹¹, and R¹² optionally bind with each other to form a ring, and, in that case, among the three, two groups satisfy 2n=a+b+c+d+e+f+g+h and one group satisfies 2n−1=a+b+c+d+e+f+g+h.
X¹⁰ is selected from SO₂, C═O, C═S, R^{s}P═O, R^{t}P═S, S═O, or Si═O.
X¹¹ is selected from SO₂, C═O, C═S, R^{u}P═O, R^{v}P═S, S═O, or Si═O.
X¹² is selected from SO₂, C═O, C═S, R^{w}P═O, R^{x}P═S, S═O, or Si═O.
R^{s}, R^{t}, R^{u}, R^{v}, R^{w}, and R^{x} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.
R^{s}, R^{t}, R^{u}, R^{v}, R^{w}, and R^{x} each optionally bind with R¹⁰, R¹¹, or R¹² to form a ring.).

9. The nonaqueous secondary battery according to claim 1, wherein a chemical structure of an anion of the metal salt is represented by general formula (7), general formula (8), or general formula (9) below:
(R¹³SO₂)(R¹⁴SO₂)N General Formula (7)
(R¹³ and R¹⁴ are each independently CₙHₐF_{b}Cl_{c}Br_{d}Iₑ.
“n,” “a,” “b,” “c,” “d,” and “e” are each independently an integer not smaller than 0, and satisfy 2n+1=a+b+c+d+e.
R¹³ and R¹⁴ optionally bind with each other to form a ring, and, in that case, satisfy 2n=a+b+c+d+e);
R¹⁵SO₃ General Formula (8)
(R¹⁵ is CₙHₐF_{b}Cl_{c}Br_{d}Iₑ.
“n,” “a,” “b,” “c,” “d,” and “e” are each independently an integer not smaller than 0, and satisfy 2n+1=a+b+c+d+e); and
(R¹⁶SO₂)(R¹⁷SO₂)(R¹⁸SO₂)C General Formula (9)
(R¹⁶, R¹⁷, and R¹⁸ are each independently CₙHₐF_{b}Cl_{c}Br_{d}lₑ.
“n,” “a,” “b,” “c,” “d,” and “e” are each independently an integer not smaller than 0, and satisfy 2n+1=a+b+c+d+e.
Any two of R¹⁶, R¹⁷, and R¹⁸ optionally bind with each other to form a ring, and, in that case, groups forming the ring satisfy 2n=a+b+c+d+e. Three of R¹⁶, R^{17,} and R¹⁸ optionally bind with each other to form a ring, and, in that case, among the three, two groups satisfy 2n=a+b+c+d+e and one group satisfies 2n−1=a+b+c+d+e).

10. The nonaqueous secondary battery according to claim 1, wherein the metal salt is (CF₃SO₂)₂NLi, (FSO₂)₂NLi, (C₂F₅SO₂)₂NLi, FSO₂(CF₃SO₂)NLi, (SO₂CF₂CF₂SO₂)NLi, (SO₂CF₂CF₂CF₂SO₂)NLi, FS O₂(CH₃SO₂)NLi, FSO₂(C₂F₅SO₂)NLi, or FSO₂(C₂H₅SO₂)NLi.

11. The nonaqueous secondary battery according to claim 1, wherein a heteroelement of the organic solvent is at least one selected from nitrogen, oxygen, sulfur, or a halogen.

12. The nonaqueous secondary battery according to claim 1, wherein the organic solvent is an aprotic solvent.

13. The nonaqueous secondary battery according to claim 1, wherein the organic solvent is selected from acetonitrile or 1,2-dimethoxyethane.

14. The nonaqueous secondary battery according to claim 1, wherein the organic solvent is selected from a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.).

15. The nonaqueous secondary battery according to claim 1, wherein the organic solvent is selected from dimethyl carbonate, ethyl methyl carbonate, or diethyl carbonate.

16. The nonaqueous secondary battery according to claim 1, wherein the lithium metal complex oxide according to the condition 1 consists of one selected from a group consisting of general formula: LiₐNi_{b}Co_{c}Mn_{d}DₑO_{f} (0.2≦a≦1.2; b+c+d+e=1; 0≦e<1; D is at least one element selected from Li, Fe, Cr, Cu, Zn, Ca, Mg, S, Si, Na, K, Al, Zr, Ti, P, Ga, Ge, V, Mo, Nb, W, or La; 1.7≦f≦2.1) and Li₂MnO₃.

17. The nonaqueous secondary battery according to claim 16, wherein a ratio of b:c:d in the general formula is at least one selected from 0.5:0.2:0.3, 1/3:1/3:1/3, 0.75:0.10:0.15, 0:0:1, 1:0:0, and 0:1:0.

18. The nonaqueous secondary battery according to claim 1, wherein the lithium metal complex oxide according to the condition 2 is represented by general formula: Liₓ(A_{y}Mn_{2-y})O₄ (“A” is at least one metal element selected from transition metal elements, Ca, Mg, S, Si, Na, K, Al, P, Ga, and Ge; 0<x≦1.2; 0<y≦1).

19. The nonaqueous secondary battery according to claim 1, wherein the polyanion based material according to the condition 3 is a polyanion based compound represented by LiMPO₄, LiMVO₄, or Li₂MSiO₄ (wherein, “M” is at least one selected from Co, Ni, Mn, and Fe).

20. The nonaqueous secondary battery according to claim 1, wherein, in the condition 4, an oxidative degradation potential of the electrolytic solution is not lower than 4.5 V when Li/Li⁺ is used for reference potential.

21. The nonaqueous secondary battery according to claim 1, wherein the positive electrodeincludes a positive electrode active material having a spinel structure including Li and Mn.

22. The nonaqueous secondary battery according to claim 1, excluding a nonaqueous secondary battery including an electrolytic solution containing LiN(SO₂CF₃)₂ as the metal salt and 1,2-dialkoxyethane as the organic solvent.

23. The nonaqueous secondary battery according to claim 1, wherein the organic solvent is selected from: ethers selected from tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, or a crown ether; nitriles; carbonates; amides; isocyanates; esters; epoxies; oxazoles; ketones; acid anhydrides; sulfones; sulfoxides; nitros; furans; cyclic esters; aromatic heterocycles; heterocycles; phosphoric acid esters; or a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.).

24. The nonaqueous secondary battery according to claim 1, wherein
the organic solvent is selected from acetonitrile, propionitrile, acrylonitrile, malononitrile, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, a crown ether, ethylene carbonate, propylene carbonate, formamide, N,N-dimethylformamide, N,N-dimethylacetamide, N-methylpyrrolidone, isopropyl isocyanate, n-propylisocyanate, chloromethyl isocyanate, methyl acetate, ethyl acetate, propyl acetate, methyl propionate, methyl formate, ethyl formate, vinyl acetate, methyl acrylate, methyl methacrylate, glycidyl methyl ether, epoxy butane, 2-ethyloxirane, oxazole, 2-ethyloxazole, oxazoline, 2-methyl-2-oxazoline, acetone, methyl ethyl ketone, methyl isobutyl ketone, acetic anhydride, propionic anhydride, dimethyl sulfone, sulfolane, dimethyl sulfoxide, 1-nitropropane, 2-nitropropane, furan, furfural, γ-butyrolactone, γ-valerolactone, δ-valerolactone, thiophene, pyridine, tetrahydro-4-pyrone, 1-methylpyrrolidine, N-methylmorpholine, trimethyl phosphate, triethyl phosphate, or a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.).

25. The nonaqueous secondary battery according to claim 1, wherein
the organic solvent is selected from nitriles, carbonates, amides, isocyanates, esters, epoxies, oxazoles, ketones, acid anhydrides, sulfones, sulfoxides, nitros, furans, cyclic esters, aromatic heterocycles, heterocycles, phosphoric acid esters, or a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.).

26. The nonaqueous secondary battery according to claim 1, wherein
the cation of the metal salt is lithium, and
a chemical structure of an anion of the metal salt is represented by general formula (7) below:
(R¹³SO₂)(R¹⁴SO₂)N General Formula (7)
(R¹³ and R¹⁴ are each independently CₙHₐF_{b}Cl_{c}Br_{d}Iₑ.
“n,” “a,” “b,” “c,” “d,” and “e” are each independently an integer not smaller than 0, and satisfy 2n+1=a+b+c+d+e.
R¹³ and R¹⁴ optionally bind with each other to form a ring, and, in that case, satisfy 2n=a+b+c+d+e.
“n” is an integer from 0 to 6. When R¹³ and R¹⁴ bind with each other to form a ring, “n” is an integer from 1 to 8.).

27. The nonaqueous electrolyte secondary battery according to claim 1, wherein a relationship between the Io and the Is is Is>2×Io.

28. The nonaqueous secondary battery according to claim 1, wherein the density d (g/cm³) of the electrolytic solution is 1.2≦d≦2.2.

29. The nonaqueous secondary battery according to claim 1, wherein
the metal salt is selected from (CF₃SO₂)₂NLi, (FSO₂)₂NLi, (C₂F₅SO₂)₂NLi, FSO₂(CF₃SO₂)NLi, (SO₂CF₂CF₂SO₂)NLi, (SO₂CF₂CF₂CF₂SO₂)NLi, FSO₂(CH₃SO₂)NLi, FSO₂(C₂F₅SO₂)NLi, or FSO₂(C₂H₅SO₂)NLi, and
the organic solvent is selected from acetonitrile, propionitrile, acrylonitrile, 1,2-dimethoxyethane, 1,2-diethoxyethane, tetrahydrofuran, 1,3-dioxane, 1,4-dioxane, 2-methyltetrahydrofuran, ethylene carbonate, propylene carbonate, formamide, N,N-dimethylformamide, N,N-dimethylacetamide, N-methylpyrrolidone, isopropyl isocyanate, n-propylisocyanate, methyl acetate, ethyl acetate, propyl acetate, methyl propionate, methyl formate, ethyl formate, vinyl acetate, methyl acrylate, methyl methacrylate, oxazole, acetone, methyl ethyl ketone, methyl isobutyl ketone, acetic anhydride, propionic anhydride, sulfolane, dimethyl sulfoxide, 1-nitropropane, 2-nitropropane, furan, furfural, γ-butyrolactone, γ-valerolactone, δ-valerolactone, thiophene, pyridine, 1-methylpyrrolidine, N-methylmorpholine, trimethyl phosphate, triethyl phosphate, or a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n” is an integer of 1 to 6, “m” is an integer of 3 to 8, and “a,” “b,” “c,” “d,” “e,” “f,” “g,” “h,” “i,” and “j” are each independently an integer not smaller than 0, and satisfy 2n+1=a+b+c+d+e and 2m=f+g+h+i+j.).

30. The nonaqueous secondary battery according to claim 1, wherein
the metal salt is selected from (CF₃SO₂)₂NLi, (FSO₂)₂NLi, (C₂F₅SO₂)₂NLi, FSO₂(CF₃SO₂)NLi, (SO₂CF₂CF₂SO₂)NLi, (SO₂CF₂CF₂CF₂SO₂)NLi, FSO₂(CH₃SO₂)NLi, FSO₂(C₂F₅SO₂)NLi, or FSO₂(C₂H₅SO₂)NLi, and
the organic solvent is selected from acetonitrile, propionitrile, acrylonitrile, tetrahydrofuran, 1,3-dioxane, 1,4-dioxane, 2-methyltetrahydrofuran, ethylene carbonate, propylene carbonate, formamide, N,N-dimethylformamide, N,N-dimethylacetamide, N-methylpyrrolidone, isopropyl isocyanate, n-propylisocyanate, methyl acetate, ethyl acetate, propyl acetate, methyl propionate, methyl formate, ethyl formate, vinyl acetate, methyl acrylate, methyl methacrylate, oxazole, acetone, methyl ethyl ketone, methyl isobutyl ketone, acetic anhydride, propionic anhydride, sulfolane, dimethyl sulfoxide, 1-nitropropane, 2-nitropropane, furan, furfural, γ-butyrolactone, γ-valerolactone, δ-valerolactone, thiophene, pyridine, 1-methylpyrrolidine, N-methylmorpholine, trimethyl phosphate, triethyl phosphate, or a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n” is an integer of 1 to 6, “m” is an integer of 3 to 8, and “a,” “b,” “c,” “d,” “e,” “f,” “g,” “h,” “i,” and “j” are each independently an integer not smaller than 0, and satisfy 2n+1=a+b+c+d+e and 2m=f+g+h+i+j.).

31. The nonaqueous secondary battery according to claim 1,
excluding a nonaqueous secondary battery including an electrolytic solution containing LiN(SO₂CF₃)₂ as the metal salt and 1,2-dialkoxyethane as the organic solvent, wherein
the cation of the metal salt is lithium,
a chemical structure of an anion of the metal salt is represented by general formula (7) below:
(R¹³SO₂)(R¹⁴SO₂)N General Formula (7)
(R¹³ and R¹⁴ are each independently CₙHₐF_{b}Cl_{c}Br_{d}Iₑ.
“n,” “a,” “b,” “c,” “d,” and “e” are each independently an integer not smaller than 0, and satisfy 2n+1=a+b+c+d+e.
R¹³ and R¹⁴ optionally bind with each other to form a ring, and, in that case, satisfy 2n=a+b+c+d+e.
“n” is an integer from 0 to 6. When R¹³ and R¹⁴ bind with each other to form a ring, “n” is an integer from 1 to 8.).

32. The nonaqueous secondary battery according to claim 1, wherein
the cation of the metal salt is lithium,
a chemical structure of an anion of the metal salt is represented by general formula (7) below:
(R¹³SO₂)(R¹⁴SO₂)N General Formula (7)
(R¹³ and R¹⁴ are each independently CₙHₐF_{b}Cl_{c}Br_{d}Iₑ.
“n,” “a,” “b,” “c,” “d,” and “e” are each independently an integer not smaller than 0, and satisfy 2n+1=a+b+c+d+e.
R¹³ and R¹⁴ optionally bind with each other to form a ring, and, in that case, satisfy 2n=a+b+c+d+e.
“n” is an integer from 0 to 6. When R¹³ and R¹⁴ bind with each other to form a ring, “n” is an integer from 1 to 8.), and
the organic solvent is selected from: ethers selected from tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, or a crown ether; nitriles; carbonates; amides; isocyanates; esters; epoxies; oxazoles; ketones; acid anhydrides; sulfones; sulfoxides; nitros; furans; cyclic esters; aromatic heterocycles; heterocycles; phosphoric acid esters; or a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.).

33. The nonaqueous secondary battery according to claim 1, wherein
the cation of the metal salt is lithium,
a chemical structure of an anion of the metal salt is represented by general formula (7) below:
(R¹³SO₂)(R¹⁴SO₂)N General Formula (7)
(R¹³ and R¹⁴ are each independently CₙHₐF_{b}Cl_{c}Br_{d}Iₑ. “n,” “a,” “b,” “c,” “d,” and “e” are each independently an integer not smaller than 0, and satisfy 2n+1=a+b+c+d+e.
R¹³ and R¹⁴ optionally bind with each other to form a ring, and, in that case, satisfy 2n=a+b+c+d+e.
“n” is an integer from 0 to 6. When R¹³ and R¹⁴ bind with each other to form a ring, “n” is an integer from 1 to 8), and
the organic solvent is selected from acetonitrile, propionitrile, acrylonitrile, malononitrile, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, a crown ether, ethylene carbonate, propylene carbonate, formamide, N,N-dimethylformamide, N,N-dimethylacetamide, N-methylpyrrolidone, isopropyl isocyanate, n-propylisocyanate, chloromethyl isocyanate, methyl acetate, ethyl acetate, propyl acetate, methyl propionate, methyl formate, ethyl formate, vinyl acetate, methyl acrylate, methyl methacrylate, glycidyl methyl ether, epoxy butane, 2-ethyloxirane, oxazole, 2-ethyloxazole, oxazoline, 2-methyl-2-oxazoline, acetone, methyl ethyl ketone, methyl isobutyl ketone, acetic anhydride, propionic anhydride, dimethyl sulfone, sulfolane, dimethyl sulfoxide, 1-nitropropane, 2-nitropropane, furan, furfural, γ-butyrolactone, γ-valerolactone, δ-valerolactone, thiophene, pyridine, tetrahydro-4-pyrone, 1-methylpyrrolidine, N-methylmorpholine, trimethyl phosphate, triethyl phosphate, or a linear carbonate represented by general formula (10) below:
R¹⁹OCOOR²⁰ General Formula (10)
(R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.).

34. The nonaqueous secondary battery according to claim 1, wherein
the cation of the metal salt is lithium,
a chemical structure of an anion of the metal salt is represented by general formula (7) below:
(R¹³SO₂)(R¹⁴SO₂)N General Formula (7)
(R¹³ and R¹⁴ are each independently CₙHₐF_{b}Cl_{c}Br_{d}Iₑ.
“n,” “a,” “b,” “c,” “d,” and “e” are each independently an integer not smaller than 0, and satisfy 2n+1=a+b+c+d+e.
R¹³ and R¹⁴ optionally bind with each other to form a ring, and, in that case, satisfy 2n=a+b+c+d+e.
“n” is an integer from 0 to 6. When R¹³ and R¹⁴ bind with each other to form a ring, “n” is an integer from 1 to 8), and
the organic solvent is selected from nitriles, carbonates, amides, isocyanates, esters, epoxies, oxazoles, ketones, acid anhydrides, sulfones, sulfoxides, nitros, furans, cyclic esters, aromatic heterocycles, heterocycles, or phosphoric acid esters.

35. The nonaqueous secondary battery according to claim 1, wherein
the cation of the metal salt is lithium,
a chemical structure of an anion of the metal salt is represented by general formula (7) below:
(R¹³SO₂)(R¹⁴SO₂)N General Formula (7)
(R¹³ and R¹⁴ are each independently CₙHₐF_{b}ClₑBr_{d}Iₑ.
“n,” “a,” “b,” “c,” “d,” and “e” are each independently an integer not smaller than 0, and satisfy 2n+1=a+b+c+d+e.
R¹³ and R¹⁴ optionally bind with each other to form a ring, and, in that case, satisfy 2n=a+b+c+d+e.
“n” is an integer from 0 to 6. When R¹³ and R¹⁴ bind with each other to form a ring, “n” is an integer from 1 to 8),
the organic solvent is selected from nitriles, carbonates, amides, isocyanates, esters, epoxies, oxazoles, ketones, acid anhydrides, sulfones, sulfoxides, nitros, furans, cyclic esters, aromatic heterocycles, heterocycles, or phosphoric acid esters,
the density d (g/cm³) of electrolytic solution is 1.2≦d≦2.2, and
“d/c” obtained by dividing the density d (g/cm³) of the electrolytic solution by a metal salt concentration c(mol/L) of the electrolytic solution is within a range of 0.15≦d/c≦0.71.
